(19) United States
(12) Patent Application Publication
(10) Pub. No.: US 2007/0067463 A1
(43) Pub. Date: Mar. 22, 2007

(54) Communications system, communications apparatus, method and program

(76) Inventors: Yoshihito Ishibashi, Tokyo (JP); Susumu Kusakabe, Tokyo (JP); Fumio Kubono, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/453,213

(22) Filed: Jun. 15, 2006

(30) Foreign Application Priority Data
Jun. 17, 2005 (JP) 2005-178426

(51) Int. Cl. G06F 15/16

(52) U.S. Cl. 709/227

(57) ABSTRACT

A communications system having a communications apparatus that performs communications with another communications apparatus via a communications medium; said communications apparatus includes: identification information request response means that performs a response process of transmitting identification information of said communications apparatus to said other communications apparatus in response to a request, which is transmitted from said other communications apparatus, for said identification information; application processing means that performs communications with said other communications apparatus to which said identification information is transmitted through said identification information request response means, and that performs a process related to a predetermined application; and studying means that studies, with respect to a predetermined condition, success/failure tendencies of said process related to said application performed by said application processing means; wherein said identification information request response means controls, based on a study result by said studying means, output of said identification information in response to said request.

### BACKGROUND OF THE INVENTION

1. Field of the Invention

The present invention relates to a communications system, a communications apparatus, method and program, and more particularly to a communications system, a communications apparatus, method and program that make it possible to suppress a decrease in speed by making communications processing more efficient.

2. Description of Related Art

In recent years, along with the development in information processing technology, communications systems that provide various services utilizing short range wireless communications are becoming popular and are used for various purposes such as the payment of fares for public transportation, purchases of merchandise and tickets at stores, ID verification such as employee cards and admission cards, security systems such as door locks, payment at employee cafeterias and the like.

In such systems, the user carries a portable device, such as an IC card, for example, that has a communications function for performing short range wireless communications, and that has a recording medium that stores personal information, cash information and the like. In order to use such services as paying the bill or ID verification, the user brings that portable device in contact with or in close proximity to a reader/writer of the service provider, makes it communicate with the reader/writer, and thereby uses the service.

As service systems using such a communications system have become popular and various services have become available at various places, it has become difficult to use all services with a single portable device due to differences in system configurations between service providers. As such, various kinds of portable devices that are similar in that they communicate with another device, such as a reader/writer, through the same transmission method, but support different services have come to exist.

Therefore, users now need to choose the portable device to use depending on the service they wish to use, as there exist, for example, IC cards that may be able to pay the fare for public transportation but not open or close the entrance to their office, or IC cards that may be used to pay for meals at employee cafeterias but not for purchases of merchandise at convenience stores.

However, in such cases, it is necessary for those users carrying a plurality of portable devices to choose the portable device that corresponds to a certain service each time they wish to use that service and make it communicate with a reader/writer, which is tedious.

As such, there exists a method of providing services where the reader/writer for a certain service searches for the corresponding portable device from a plurality of portable devices, performs communications with that portable device, and provides a service (see, for example, Patent Document 1). In other words, by having a plurality of portable devices a user carries communicate with a reader/writer by bringing them closer to the reader/writer, the reader/writer automatically finds the portable device corresponding to the service it provides. Thus, the user is able to use services without the tedious procedure described above.

[Patent Document 1] Japanese Published Unexamined

### SUMMARY OF THE INVENTION

However, in such cases as described above where the reader/writer finds the portable device corresponding to the service it provides, the reader/writer has to communicate each time with all portable devices that are presented, and then search therefrom for the portable device corresponding to the service it provides, and there is a risk in that the efficiency of the communications processing is compromised due to this searching process that is not directly related to the communications for the intended service, and in that the load and processing time thereof increases.

In particular, in cases where it is desirable that services be provided quickly as in automatic ticket gates, it is desirable that unnecessary search processes be omitted as much as possible.

The present invention takes into consideration the issues above, and seeks to suppress a decrease in speed by making communication processes more efficient.

A communications system of the present invention may include a communications system that includes a communications apparatus that performs communications with another communications apparatus via a communications medium. The communications apparatus may include identification information request response means that performs a response process that transmits identification information to the other communications apparatus in response to a request, which is transmitted from the other communications apparatus, for identification information of the communications apparatus, application processing means that performs communications with the other communications apparatus to which the identification information is transmitted by the identification information request response means and performs a process related to a predetermined application, and studying means that studies the success/failure tendencies of processes related to the application by the application processing means with respect to predetermined conditions. The identification information request response means controls, based on the study results by the studying means, the output of identification information in response to the request.

A communications apparatus of the present invention may be a communications apparatus that performs communications with another communications apparatus via a communications medium, and may include identification information request response means that performs a response process that transmits identification information to the other communications apparatus in response to a request for the identification information of the communications apparatus that is transmitted from the other communications apparatus, application processing means that performs communications with the other communications apparatus to which the identification information is transmitted by the identification information request response means and performs a process related to a predetermined application, and studying means that studies the success/failure tendencies of the process related to the application and performed by the application processing means with respect to predetermined conditions. The identification information request response means may control; based on the study result by the studying means, the output of identification information in response to the request.

The above-mentioned identification information request response means may include request acquisition means that acquires a request transmitted from the other communications apparatus, identification information supplying means that supplies the identification information to the other communications apparatus as a response to the request acquired by the request acquisition means, and output control means that controls, based on the study result, the timing in which the identification information is supplied by the identification information supplying means.

The above-mentioned studying means may study the success/failure tendencies of the process related to the application during predetermined time periods, and create, as the study result, time-sorted priority information addressing the tendencies and which indicates the priority of the identification information for each time period with respect to the other communications apparatus. Based on the time-sorted priority information created by the studying means as the study result, the output control means may control the timing in which the identification information is supplied.

The above-mentioned output control means is able to exercise control in such a manner that during time periods of high priority, the timing in which the identification information is supplied is made earlier, while the timing in which the identification information is supplied is made later during time periods of low priority.

The above-mentioned studying means may study the success/failure tendencies of the process related to the application with respect to each model of the other apparatus, and create, as the study result, model-sorted priority information addressing the tendencies and which indicates the priority of the identification information for the other communications apparatus with respect to each model of the other communications apparatus. Based on the model-sorted priority information created by the studying means as the study result, the output control means may control the timing in which the identification information is supplied.

The above-mentioned output control means is able to exercise control in such a manner that if the model of the other communications apparatus is of high priority, the timing in which the identification information is supplied is made earlier, while the timing in which the identification information is supplied is made later if the model is of low priority.

The above-mentioned communications apparatus may further include retaining means for temporarily retaining the study result of the above-mentioned studying means, and the output control means may control, based on the study result retained by the retaining means, the timing in which the identification information is supplied.

A communications method of the present invention may include an application processing step that performs communications with another communications apparatus and that performs a process related to a predetermined application, a studying step that studies, with respect to a predetermined condition, the success/failure tendencies of the process in the application processing step, and an identification information request response step that, based on a study result obtained by the studying step, performs a response process of transmitting identification information to the other communications apparatus in response to a request, which is transmitted from the other communications apparatus, for the identification information of a communications apparatus.

A program of the present invention may include an application processing step that performs communications with another communications apparatus and that performs a process related to a predetermined application, a studying step that studies, with respect to a predetermined condition, the success/failure tendencies of the process in the application processing step, and an identification information request response step that, based on a study result obtained by the studying step, performs a response process of transmitting identification information to the other communications apparatus in response to a request, which is transmitted from the other communications apparatus, for the identification information of a communications apparatus.

In a communications system of the present invention, there may be included a communications apparatus that performs communications with another communications apparatus via a communications medium. The communications apparatus may perform a response process of transmitting identification information to the other communications apparatus in response to a request, which is transmitted from the other communications apparatus, for the identification information of the communications apparatus, perform communications with the other communications apparatus to which the identification information is transmitted, perform a process related to a predetermined application, study the success/failure tendencies of the process related to the application with respect to a predetermined condition, and control the output of the identification information corresponding to the request based on a study result.

In a communications apparatus, method and program of the present invention, a response process of transmitting identification information to another communications apparatus in response to a request for the identification information of the communications apparatus that is transmitted from the other communications apparatus may be performed, communications with the other communications apparatus to which the identification information is transmitted may be performed, a process related to a predetermined application may be performed, the success/failure tendencies of the process related to the application with respect to a predetermined condition may be studied, and the output of the identification information in response to the request may be controlled based on a study result.

According to the present invention, it is possible to suppress a decrease in speed by making communications processing more efficient.

### BRIEF DESCRIPTION OF THE DRAWINGS

The present invention will become more readily appreciated and understood from the following detailed description of embodiments and examples of the present invention when taken in conjunction with the accompanying drawings, in which:

FIG. 1 is a block diagram showing a construction example of one embodiment of a communication system which underlies the present invention;

FIG. 2 is a diagram showing an example of an equivalent circuit of the communication system shown in FIG. 1;

FIG. 3 is a table showing an example of the calculation result of effective values of the voltage produced across a reception load resistor in the model shown in FIG. 2;

FIG. 4 is a diagram showing an example of a model of a physical construction of the communication system shown in FIG. 1;

FIG. 5 is a diagram showing an example of a calculation model of each parameter generated in the model shown in FIG. 4;

FIG. 6 is a schematic view showing an example of distribution of electric lines of force with respect to electrodes;

FIG. 7 is a schematic view showing another example of distribution of electric lines of force with respect to the electrodes;

FIG. 8 is a diagram aiding in explaining another example of the model of electrodes in a transmitter;

FIG. 9 is a diagram showing an example of an equivalent circuit of the model shown in FIG. 5;

FIG. 10 is a graph showing an example of a frequency characteristic of the communication system shown in FIG. 9;

FIG. 11 is a graph showing an example of a signal received by a receiver;

FIG. 12 is a schematic view showing an example of locations at which individual electrodes are disposed;

FIG. 13 is a schematic view showing another example of locations at which individual electrodes are disposed;

FIG. 14 is a schematic view showing another example of locations at which individual electrodes are disposed;

FIG. 15 is a schematic view showing another example of locations at which individual electrodes are disposed;

FIG. 16A is a schematic view showing another example of locations at which individual electrodes are disposed;

FIG. 16B is a schematic view showing another example of locations at which individual electrodes are disposed;

FIG. 17A is a schematic view showing another example of locations at which individual electrodes are disposed;

FIG. 17B is a schematic view showing another example of locations at which individual electrodes are disposed;

FIG. 18A is a schematic view showing another example of locations at which individual electrodes are disposed;

FIG. 18B is a schematic view showing another example of locations at which individual electrodes are disposed;

FIG. 19A is a schematic view showing another example of locations at which individual electrodes are disposed;

FIG. 19B is a schematic view showing another example of locations at which individual electrodes are disposed;

FIG. 20 is a schematic view showing another construction example of an electrode;

FIG. 21 is a diagram showing another example of an equivalent circuit of the model shown in FIG. 5;

FIG. 22 is a diagram showing an arrangement example of the communication system shown in FIG. 1;

FIG. 23 is a diagram showing another construction example of the communication system which underlies the present invention;

FIG. 24 is a schematic view showing an actual use example of the embodiment of the communication system which underlies the present invention;

FIG. 25 is a schematic view showing another use example of the embodiment of the communication system which underlies the present invention;

FIG. 26 is a schematic view showing another construction example of the communication system which underlies the present invention;

FIG. 27 is a graph showing an example of distribution of a frequency spectrum;

FIG. 28 is a schematic view showing another construction example of the communication system which underlies the present invention;

FIG. 29 is a graph showing an example of distribution of a frequency spectrum;

FIG. 30 is a diagram showing another construction example of the communication system which underlies the present invention;

FIG. 31 is a graph showing an example of temporal distribution of a signal;

FIG. 32 is a flowchart showing an example of a flow of communication processing;

FIG. 33 is a diagram showing another construction example of the communication system which underlies the present invention;

FIG. 34 is a diagram illustrating an actual use example of a communication system according to an embodiment adopting the present invention;

FIG. 35 is a block diagram illustrating a configuration example of the reader/writer in FIG. 34;

FIG. 36 is a block diagram illustrating a configuration example of the UD in FIG. 34;

FIG. 37 is a schematic diagram indicating a configuration example of time-sorted priority information;

FIG. 38 is a block diagram indicating a configuration example of the output TS control section in FIG. 36;

FIG. 39 is a block diagram indicating a configuration example of the studying section in FIG. 36;

FIG. 40 is a timing chart illustrating an example of the flow of communications processing by the communications system in FIG. 34 up to the point where the application process is terminated;

FIG. 41 is a timing chart that follows from FIG. 40 and illustrates an example of the flow of communications processing by the communications system in FIG. 34 up to the point where the application process is terminated;

FIG. 42 is a timing chart illustrating an example of the flow of an ID request process;

FIG. 43 is a timing chart illustrating an example of the flow of an ID verification process;

FIG. 44 is a timing chart that follows from FIG. 43 and illustrates an example of the flow of an ID verification process;

FIG. 45 is a flow chart illustrating an example of a study process;

FIG. 46 is a flow chart illustrating an example of an ID request response process;

FIG. 47 is a flow chart illustrating an example of an output TS control process;

FIG. 48 is a block diagram illustrating another configuration example of the reader/writer in FIG. 34;

FIG. 49 is a timing chart illustrating another example of the flow of an ID request process;

FIG. 50 is a block diagram illustrating another configuration example of the UD in FIG. 34;

FIG. 51 is a schematic diagram indicating a configuration example of model-sorted priority information;

FIG. 52 is a block diagram indicating a configuration example of the studying section in FIG. 50;

FIG. 53 is a block diagram indicating a configuration example of the output TS control section in FIG. 50;

FIG. 54 is a flow chart illustrating another example of a study process;

FIG. 55 is a flow chart illustrating another example of an output TS control process;

FIG. 56 is a diagram indicating yet another configuration example of a communications system to which the present invention is applied; and

FIG. 57 is a diagram indicating a configuration example of a personal computer to which the present invention is applied.

### DETAILED DESCRIPTION OF EMBODIMENTS

In the following description of the embodiments of the present invention, the correspondence between the disclosed inventions and the embodiments is as follows. The description is used for confirming that the embodiments supporting the inventions described in this specification are described in the specification. Therefore, the embodiment described in this specification as not corresponding to some invention is not intended to mean that the embodiment does not correspond to the invention. Conversely, the embodiment described in this specification as corresponding to some invention is not intended to mean that the embodiment does not correspond to the invention other than some invention.

Further, the description is not intended to cover all the inventions described in the specification. In other words, it is not intended to deny the presence of the invention described in this specification but not claimed in this application, i.e., to deny the presence of the invention which may be divisionally submitted in the future and the invention emerging through corrections and additionally submitted in the future.

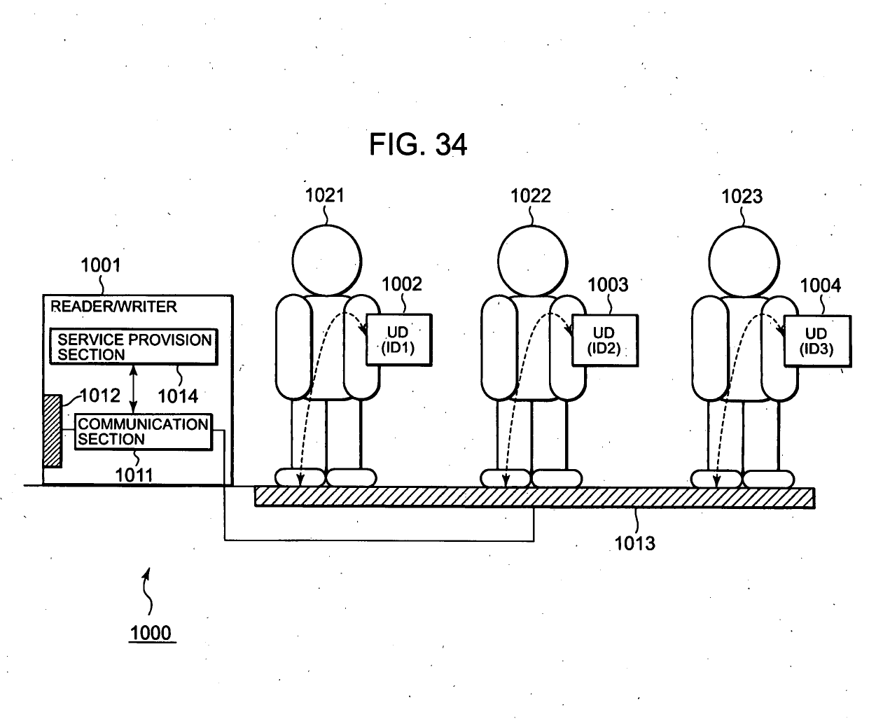

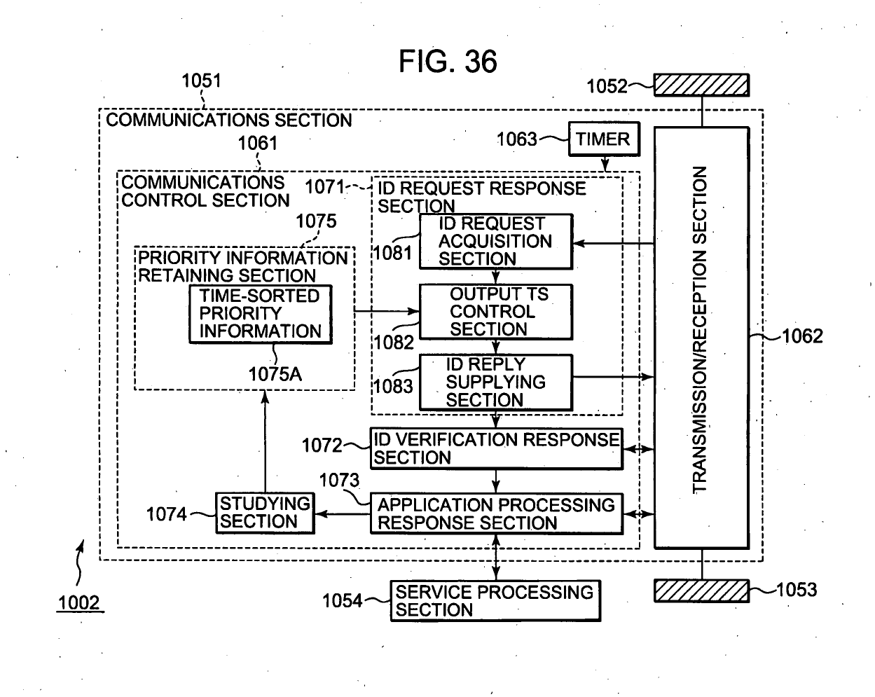

In the present invention, a communications system (for example, the communications system in FIG. 34) which may include a communications apparatus (for example, the UD in FIG. 34) that performs communications with another communications apparatus (for example, the reader/writer in FIG. 34) via a communications medium (for example, the user in FIG. 34) is provided. In this communications system, the communications apparatus may include identification information request response means (for example, the ID request response section in FIG. 36) that performs a response process that transmits identification information to the other communications apparatus in response to a request, which is transmitted from the other communications apparatus, for the identification information of the communications apparatus, application processing means (for example the application processing response section in FIG. 36) that performs communications with the other communications apparatus to which the identification information is transmitted by the identification information request response means and performs a process related to a predetermined application, and studying means (for example, the studying section in FIG. 36) that studies the success/failure tendencies of the process related to the application performed by the application processing means with respect to a predetermined condition, and the identification information request response means may control, based on a study result by the studying means, the output of the identification information in response to the request

The above-mentioned identification information request response means may include request acquisition means (for example, the ID request acquisition section in FIG. 36) that acquires a request that is transmitted from the other communications apparatus, identification information supplying means (for example, the ID reply supplying section in FIG. 36) that supplies the identification information to the other communications apparatus as a response to the request acquired by the request acquisition means, and output control means (for example, the output TS control section in FIG. 36) that controls, based on the study result, the timing in which the identification information is supplied by the identification information supplying means.

The above-mentioned studying means may study the success/failure tendencies of the process related to the application during predetermined time periods, and create, as the study result, time-sorted priority information (for example, the time-sorted priority information in FIG. 36) which addresses the tendencies and which indicates the priority of the identification information for the other communications apparatus during each time period. The output control means may control, based on the time-sorted priority information that is created as the study result by the studying means, the timing in which the identification information is supplied.

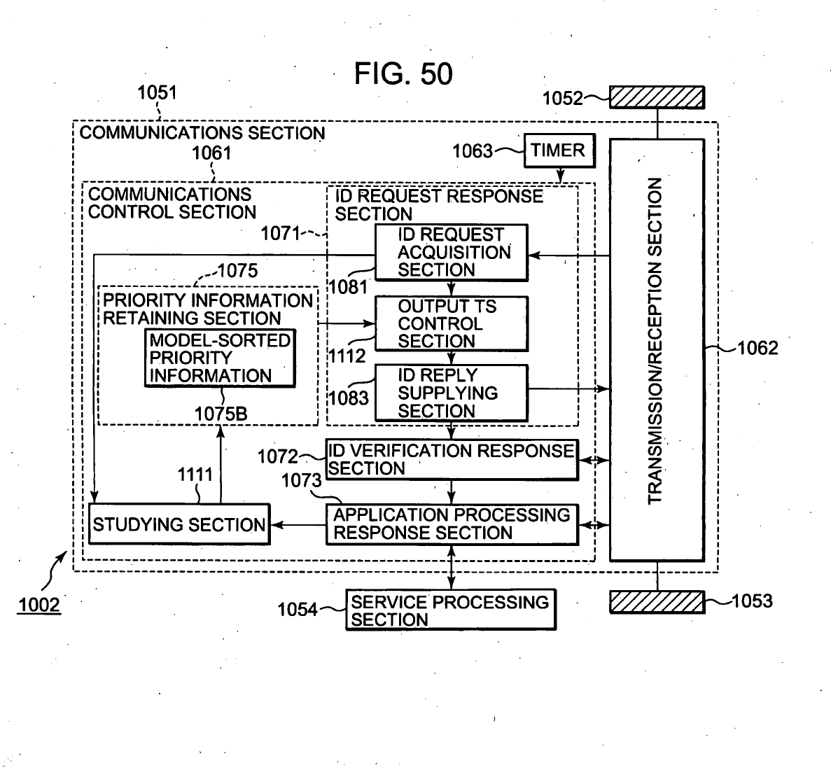

The above-mentioned studying means may study the success/failure tendencies of the process related to the application for each model of the other communications apparatus, and create, as the study result, model-sorted priority information (for example, the model-sorted priority information in FIG. 50) which addresses the tendencies and which indicates the priority of the identification information for the other communications apparatus for each model of the other communications apparatus. The output control means may control, based on the model-sorted priority information that is created as the study result by the studying means, the timing in which the identification information is supplied.

The communications apparatus may further include retaining means (for example, the priority information retaining section in FIG. 36) that temporarily retains the study result by the above-mentioned studying means, and the output control means may control the timing in which the identification information is supplied based on the study result that is retained by the retaining means.

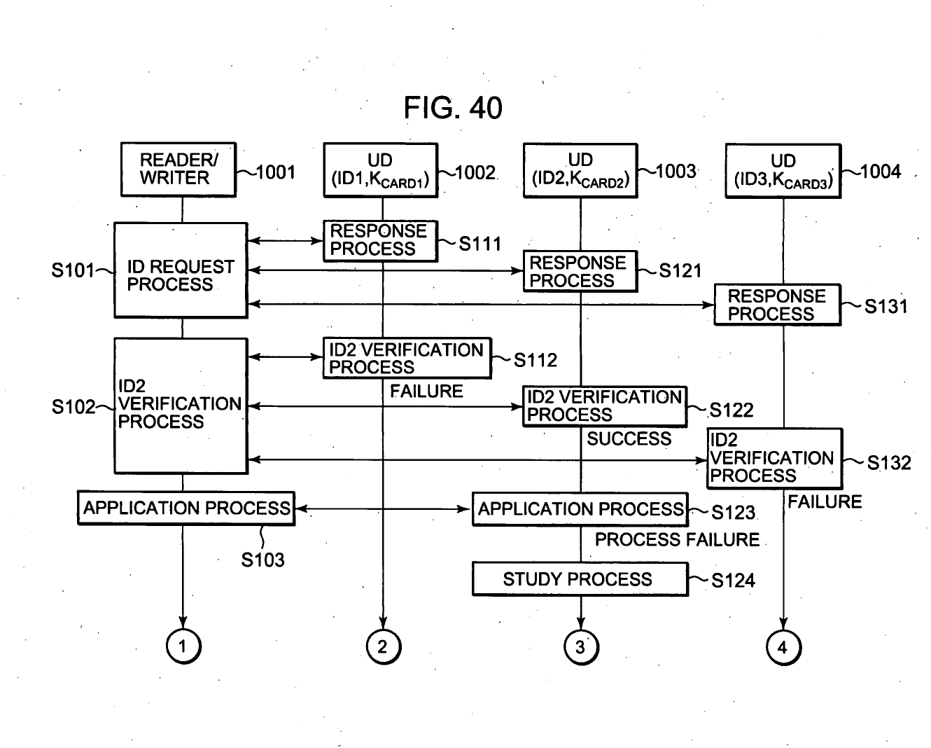

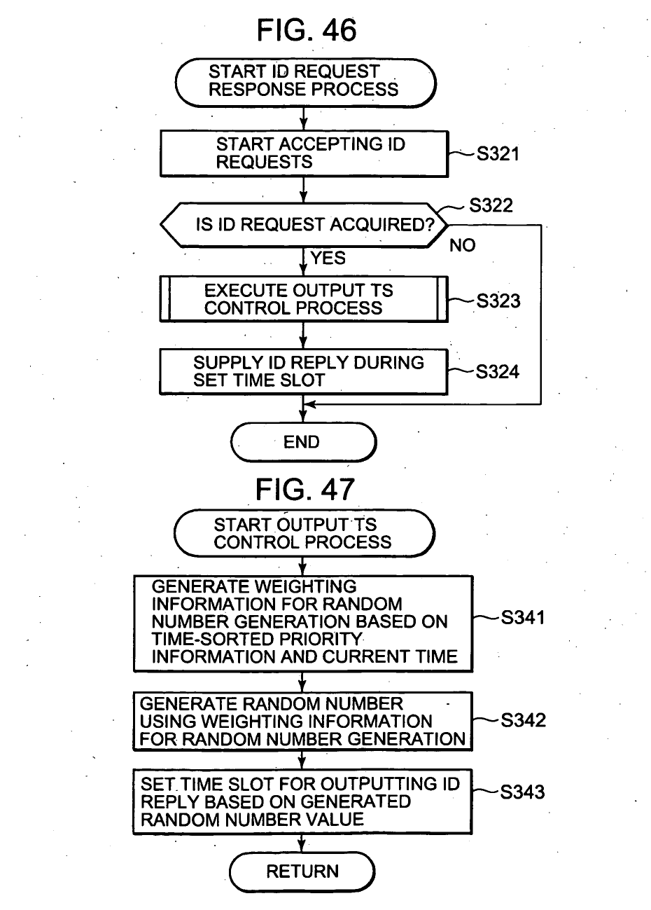

In the present invention, a communications method of a communications apparatus (for example, the UD in FIG. 34) that performs communications with another communications apparatus (for example, the reader/writer in FIG. 34) via a communications medium (for example, the user in FIG. 34) is provided. This communications method may include an application processing step (for example, step S123 in FIG. 40) that performs communications with the other communications apparatus and that performs a process related to a predetermined application, a studying step (for example, step S124 in FIG. 40) that studies, with respect to a predetermined condition, the success/failure tendencies of the process related to the application in the application processing step, and an identification information request response step (for example, step S324 in FIG. 46) that, based on a study result obtained by the studying step, performs a response process of transmitting identification information to the other communications apparatus in response to a request, which is transmitted from the other communications apparatus, for the identification information of the communications apparatus.

Also in the program of the present invention, an embodiment (one example, however) corresponding to each step is similar to the communication method of the present invention.

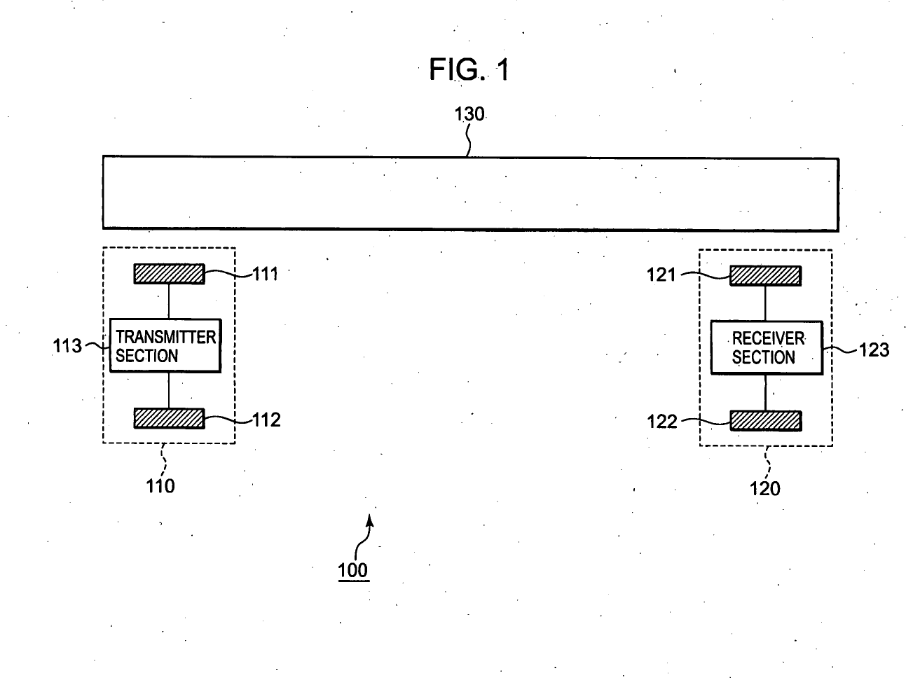

Embodiments of the present invention will be described with reference to the accompanying drawings. First, with reference to FIGS. 1 to 33, description will be made on a communication system as an example of a communication system adopting the present invention, the communication system realizing communications only by a communication signal transmission path without a necessity of a physical reference point route and without restrictions of use environments.

FIG. 1 is a diagram showing an example of the structure of a communication system realizing communications only by a communication signal transmission path without a necessity of a physical reference point route

Referring to FIG. 1, a communication system 100 is a system which includes a transmitter 110, a receiver 120, and a communication medium 130, and causes the transmitter 110 and the receiver 120 to transmit and receive signals therebetween via the communication medium 130. Namely, in the communication system 100, a signal transmitted from the transmitter 110 is transmitted via the communication medium 130 and is received by the receiver 120.

The transmitter 110 has a transmission signal electrode 111, a transmission reference electrode 112, and a transmitter section 113. The transmission signal electrode 111 is an electrode for transmitting a signal to be transmitted via the communication medium 130, and is provided to have a stronger capacitive coupling to the communication medium 130 than to the transmission reference electrode 112 which is an electrode for obtaining a reference point for making a decision as to the difference in level between signals. The transmitter section 113 is provided between the transmission signal electrode 111 and the transmission reference electrode 112, and applies an electrical signal (potential difference) to be transmitted to the receiver 120, between the transmission signal electrode 111 and the transmission reference electrode 112.

The receiver 120 has a reception signal electrode 121, a reception reference electrode 122, and a receiver section 123. The reception signal electrode 121 is an electrode for receiving a signal transmitted via the communication medium 130, and is provided to have a stronger capacitive coupling to the communication medium 130 than to the reception reference electrode 122 which is an electrode for obtaining a reference point for making a decision as to the difference in level between signals. The receiver section 123 is provided between the reception signal electrode 121 and the reception reference electrode 122, and converts an electrical signal (potential difference) produced between the reception signal electrode 121 and the reception reference electrode 122 into a desired electrical signal to restore the electrical signal generated by the transmitter section 113 of the transmitter 110.

The communication medium 130 is made of a substance having a physical characteristic capable of transmitting electrical signals, for example, an electrically conductive material or a dielectric material. The communication medium 130 is made of, for example, an electrically conductive material (such as copper, iron or aluminum). Otherwise, the communication medium 130 is made of pure water, rubber, glass or an electrolytic solution such as a saline solution, or a dielectric material such as a human body which is a complex of these materials. The communication medium 130 may have any shape, for example, a linear shape, a planar shape, a spherical shape, a prismatic shape, a cylindrical shape or another arbitrary shape.

First of all, the relationship between each of the electrodes and spaces neighboring the communication medium or the devices in the communication system 100 will be described below. In the following description, for convenience of explanation, it is assumed that the communication medium 130 is a perfect conductor. In addition, it is assumed that spaces exist between the transmission signal electrode 111 and the communication medium 130 and between the reception signal electrode 121 and the communication medium 130, respectively, so that there is no electrical coupling between the transmission signal electrode 111 and the communication medium 130 nor between the reception signal electrode 121 and the communication medium 130. Namely, a capacitance is formed between the communication medium 130 and each of the transmission signal electrode 111 and the reception signal electrode 121.

The transmission reference electrode 112 is provided to face a space neighboring the transmitter 110, while the reception reference electrode 122 is provided to face a space neighboring the receiver 120. In general, if a conductor exists in a space, a capacitance is formed in a space neighboring the surface of the conductor. For example, if the shape of the conductor is a sphere of radius r [m], a capacitance C is found from the following formula (1):

[Formula 1]
C=4×π×∈×r (1)

In formula (1), π denotes the circular constant of the conductor and denotes the dielectric constant of the space surrounding the conductor. The dielectric constant ∈ is found from the following formula (2):

[Formula 2]
∈=∈ᵣ×∈₀ (2)

In formula (2), ∈0 denotes a vacuum dielectric constant which is 8.854×10⁻¹² [F/m], and ∈r denotes a specific dielectric constant which represents the ratio of the dielectric constant ∈ to the vacuum dielectric constant ∈0.

As shown by the above-mentioned formula (1), the larger the radius r, the larger the capacitance C. In addition, the magnitude of the capacitance C of a conductor having a complex shape other than a sphere may not be easily expressed in a simple form such as the above-mentioned formula (1), but it is apparent that the magnitude of the capacitance C varies according to the magnitude of the surface area of the conductor.

As mentioned above, the transmission reference electrode 112 forms the capacitance with respect to the space neighboring the transmitter 110, while the reception reference electrode 122 forms the capacitance with respect to the space neighboring the receiver 120. Namely, as viewed from an imaginary infinity point outside each of the transmitter 110 and the receiver 120, the potential at the corresponding one of the transmission reference electrode 112 and the reception reference electrode 122 is fixed and does not easily vary.

The principle of communication in the communication system 100 will be described below. In the following description, for convenience of explanation, the term “capacitor” will be expressed simply as “capacitance” according to context, but these terms have the same meaning.

In the following description, it is assumed that the transmitter 110 and the receiver 120 shown in FIG. 1 are arranged to maintain a sufficient distance therebetween so that their mutual influence can be neglected. In the transmitter 110, it is assumed that the transmission signal electrode 111 is capacitively coupled to only the communication medium 130 and the transmission reference electrode 112 is spaced a sufficient distance apart from the transmission signal electrode 111 so that their mutual influence can be neglected (the electrodes 112 and 111 are not capacitively coupled). Similarly, in the receiver 120, it is assumed that the reception signal electrode 121 is capacitively coupled to only the communication medium 130 and the reception reference electrode 122 is spaced a sufficient distance apart from the reception signal electrode 121 so that their mutual influence can be neglected (the electrodes 122 and 121 are not capacitively coupled). Furthermore, since the transmission signal electrode 111, the reception signal electrode 121 and the communication medium 130 are actually arranged in a space, each of them has a capacitance relative to the space, but the capacitance is assumed to be herein negligible for convenience of explanation.

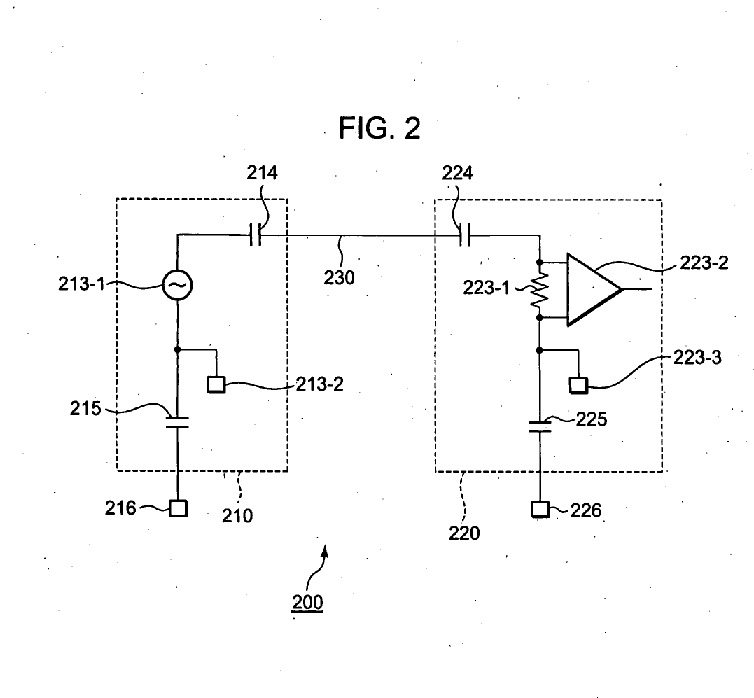

FIG. 2 is a diagram showing an equivalent circuit of the communication system 100 shown in FIG. 1. A communication system 200 is the equivalent circuit of the communication system 100 and is substantially equivalent to the communication system 100.

Namely, the communication system 200 has a transmitter 210, a receiver 220, and a connection line 230, and the transmitter 210 corresponds to the transmitter 110 of the communication system 100 shown in FIG. 1, the receiver 220 corresponds to the receiver 120 of the communication system 100 shown in FIG. 1, and the connection line 230 corresponds to the communication medium 130 of the communication system 100 shown in FIG. 1.

In the transmitter 210 shown in FIG. 2, a signal source 213-1 and a ground point 213-2 correspond to the transmitter section 113 shown in FIG. 1. The signal source 213-1 generates a sine wave of particular frequency ω×t [rad] as a transmit signal. If t [s] denotes time and ω [rad/s] denotes angular frequency, formula (3) can be expressed as follows:

[Formula 3]
ω=2×π×f (3)

In formula (3), π denotes a circular constant and f [Hz] denotes the frequency of the signal generated by the signal source 213-1. The ground point 213-2 is a point connected to the ground of the circuit inside the transmitter 210. Namely, one of the terminals of the signal source 213-1 is connected to a predetermined reference potential of the circuit inside the transmitter 210.

Cte 214 is a capacitor, and denotes the capacitance between the transmission signal electrode 111 and the communication medium 130 shown in FIG. 1. Namely, Cte 214 is provided between the terminal of the signal source 213-1 opposite to the ground point 213-2 and the connection line 230. Ctg 215 is a capacitor, and denotes the capacitance of the transmission signal electrode 112 shown in FIG. 1 with respect to the space. Namely, Ctg 215 is provided between the terminal of the signal source 213-1 on the side of the ground point 213-2 and a ground point 216 indicative of the infinity point (imaginary point) based on the transmitter 110 in the space.

In the receiver 220 shown in FIG. 2, Rr 223-1, a detector 223-2, and a ground point 223-3 correspond to the receiver section 123 shown in FIG. 1. Rr 223-1 is a load resistor (receive load) for extracting a received signal, and the detector 223-2 made of an amplifier detects and amplifies the potential difference between the opposite terminals of this Rr 223-1. The ground point 223-3 is a point connected to the ground of the circuit inside the receiver 220. Namely, one of the terminals of Rr 223-1 (one of the input terminals of the detector 223-2) is set to a predetermined reference potential of the circuit inside the receiver 220.

The detector 223-2 may also be adapted to be further provided with other functions, for example, the function of demodulating a detected modulated signal or decoding encoded information contained in the detected signal.

Cre 224 is a capacitor, and denotes the capacitance between the reception signal electrode 121 and the communication medium 130 shown in FIG. 1. Namely, Cre 224 is provided between the terminal of Rr 223-1 opposite to the ground point 223-3 and the connection line 230. Crg 225 is a capacitor, and denotes the capacitance of the reception reference electrode 122 shown in FIG. 1 with respect to the space. Namely, Crg 225 is provided between the terminal of Rr 223-1 on the side of the ground point 223-3 and a ground point 226 indicative of the infinity point (imaginary point) based on the receiver 120 in the space.

The connection line 230 denotes the communication medium 130 which is a perfect conductor. In the receiver 220 shown in FIG. 2, Ctg 215 and Crg 225 are shown to be electrically connected to each other via the ground point 216 and the ground point 226 on the equivalent circuit, but in practice, Ctg 215 and Crg 225 need not be electrically connected to each other and each of Ctg 215 and Crg 225 may form a capacitance with respect to the space neighboring the corresponding one of the transmitter 210 and the receiver 220. Namely, the ground point 216 and the ground point 226 need not be electrically connected and may also be independent of each other.

Incidentally, if a conductor exists in a space, a capacitance proportional to the surface area of the conductor is necessarily formed. Namely, for example, the transmitter 210 and the receiver 220 may be spaced as far apart as desired from each other. For example, if the communication medium 130 shown in FIG. 1 is a perfect conductor, the conductivity of the connection line 230 can be regarded as infinite, so that the length of the connection line 230 does not influence communication. In addition, if the communication medium 130 is a conductor of sufficient conductivity, the distance between the transmitter 210 and the receiver 220 does not influence the stability of communication in practical terms.

In the communication system 200, a circuit is formed by the signal source 213-1, Rr 223-1, Cte 214, Ctg 215, Cre 224 and Crg 225. The combined capacitance Cx of the four series-connected capacitors (Cte 214, Ctg 215, Cre 224 and Crg 225) can be expressed by the following formula (4):

$$\begin{matrix}[ Formula 4 ] & \\ {C}_{x} = \frac{1}{\frac{1}{Cte} + \frac{1}{Ctg} + \frac{1}{Cre} + \frac{1}{Crg}} [ F ] & ( 4 )\end{matrix}$$

The sine wave vf(t) generated by the signal source 213-1 can be expressed by the following formula (5):

[Formula 5]
Vₜ(t)=Vₘ×(ωt+θ)[V] (5)

In formula (5), Vm [V] denotes the maximum amplitude voltage of the signal source voltage and θ [rad] denotes the initial phase angle of the same. Namely, the effective value Vtrms [V] of the voltage generated by the signal source 213-1 can be found from the following formula (6):

$$\begin{matrix}[ Formula 6 ] & \\ {V}_{trms} = \frac{{V}_{m}}{\sqrt{2}} [ V ] & ( 6 )\end{matrix}$$

The complex impedance Z of the entire circuit can be found from the following formula (7):

$$\begin{matrix}[ Formula 7 ] & \\ \begin{matrix}Z = \sqrt{{Rr}^{2} + \frac{1}{{( ω {C}_{x} )}^{2}}} \\ = \sqrt{{Rr}^{2} + \frac{1}{{( 2 π {fC}_{x} )}^{2}}} [ Ω ]\end{matrix} & ( 7 )\end{matrix}$$

Namely, the effective value Vrrms of the voltage provided across both ends of Rr 223-1 can be found from the following formula (8):

$$\begin{matrix}[ Formula 8 ] & \\ \begin{matrix}{V}_{rrms} = \frac{Rr}{Z} \times {V}_{trms} \\ = \frac{Rr}{\sqrt{{Rr}^{2} + \frac{1}{{( 2 π {fC}_{x} )}^{2}}}} \times {V}_{trms} [ V ]\end{matrix} & ( 8 )\end{matrix}$$

Accordingly, as shown in formula (8), the larger the resistance value of Rr 223-1, the larger the capacitance Cx, and the higher the frequency f [Hz] of the signal source 213-1, the smaller the term of 1/((2×π×f×Cx)2), so that a larger signal can be generated across Rr 223-1.

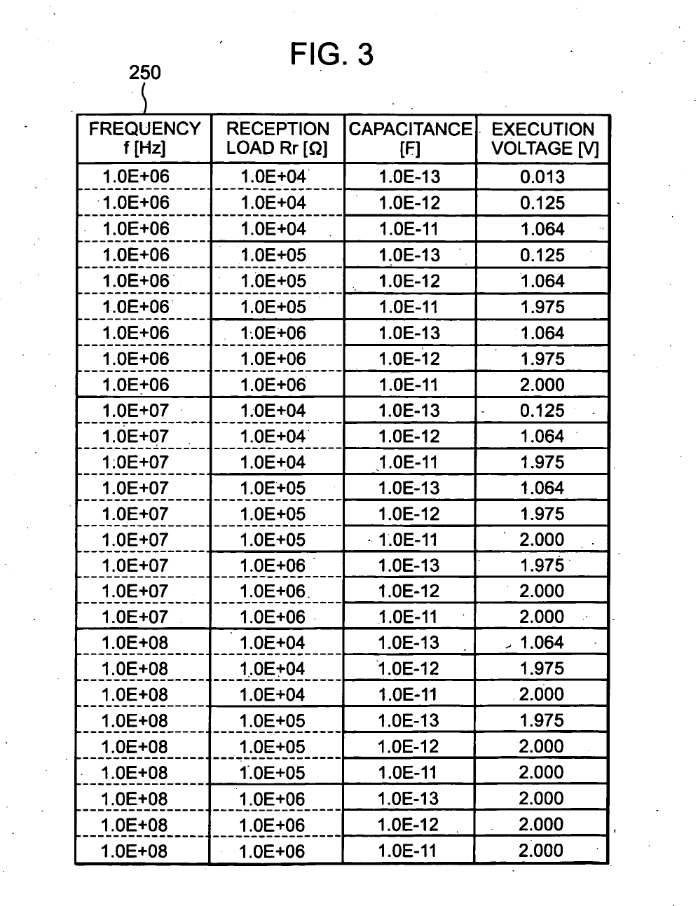

When it is assumed, for example, that: the effective value Vtrms of the voltage generated by the signal source 213-1 of the transmitter 210 is fixed to 2 [V]; the frequency f of the signal generated by the signal source 213-1 is set to 1 [MHz], 10 [MHz] or 100 [MHz]; the resistance value of Rr 223-1 is set to 10 K [Ω], 100 K [Ω] or 1 M [Ω]; and the capacitance Cx of the entire circuit is set to 0.1 [pF], 1 [pF] or 10 [pF], the calculated result of the effective value Vrrms of the voltage generated across Rr 223-1 is as listed in Table 250 shown in FIG. 3.

As shown in Table 250, the calculated result of the effective value Vrrms takes on a larger value when the frequency f is 10 [MHz] than when the frequency f is 1 [MHz], when the resistance value of the receive load Rr 223-1 is 1 M [Ω] than when the resistance value is 10 K [Ω], or when the capacitance Cx is 10 [pF] than when the capacitance Cx is 0.1 [pF], as long as the other conditions are the same. Namely, as the value of the frequency f, the resistance value of Rr 223-1 or the capacitance Cx is made larger, a larger effective value Vrrms can be obtained.

It can also be seen from Table 250 that an electrical signal is generated across Rr 223-1 even in the case of a capacitance of a picofarad or less. Namely, even if the signal level of a signal to be transmitted is small, it is possible to effect communication as by amplifying a signal detected by the detector 223-2 of the receiver 220.

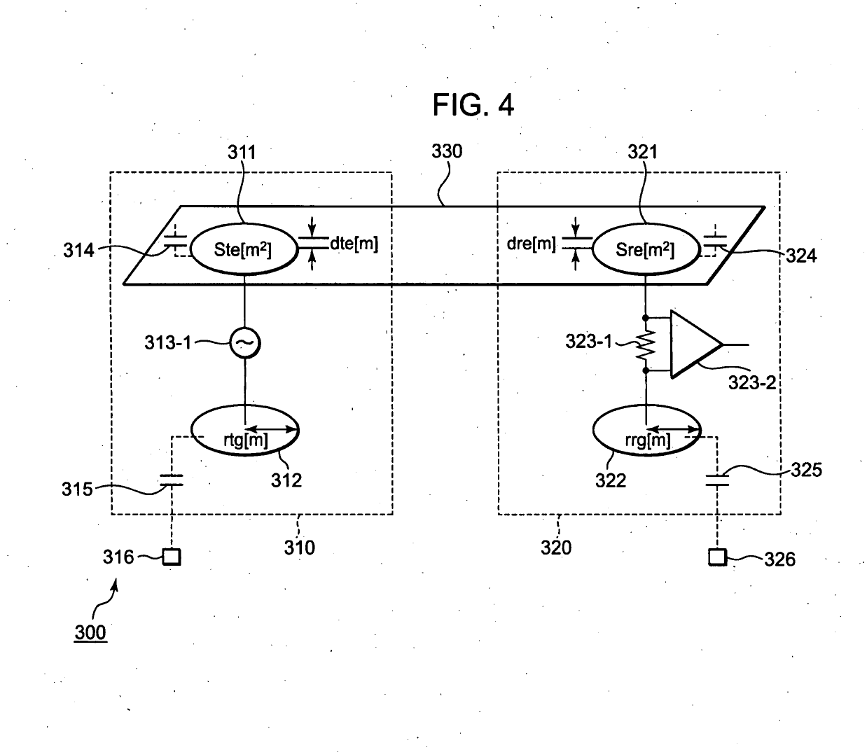

A calculation example of each parameter of the communication system 200 which has been mentioned above as an equivalent circuit will be specifically described below with reference to FIG. 4. FIG. 4 is a diagram aiding in explaining calculation examples inclusive of the influence of the physical construction of the communication system 100.

A communication system 300 shown in FIG. 4 is a system corresponding to the communication system 100 shown in FIG. 1, and information about the physical construction of the communication system 100 is added to the communication system 200 shown in FIG. 2. Namely, the communication system 300 has a transmitter 310, a receiver 320, and a communication medium 330. As compared with the communication system 100 shown in FIG. 1, the transmitter 310 corresponds to the transmitter 110, the receiver 320 corresponds to the receiver 120, and the communication medium 330 corresponds to the communication medium 130.

The transmitter 310 has a transmission signal electrode 311 corresponding to the transmission signal electrode 111, a transmission reference electrode 312 corresponding to the transmission reference electrode 112, and a signal source 313-1 corresponding to the transmitter section 113. Namely, the transmission signal electrode 311 is connected to one of both terminals of the signal source 313-1, and the transmission reference electrode 312 is connected to the other. The transmission signal electrode 311 is provided in close proximity to the communication medium 330. The transmission reference electrode 312 is provided to be spaced from the communication medium 330 to such an extent that the transmission reference electrode 312 is not influenced by the communication medium 330, and is constructed to have a capacitance with respect to a space outside the transmitter 310. Although the signal source 213-1 and the ground point 213-2 have been described as corresponding to the transmitter section 113 with reference to FIG. 2, such ground point is omitted in FIG. 4 for convenience of explanation.

Similarly to the transmitter 310, the receiver 320 has a reception signal electrode 321 corresponding to the reception signal electrode 121, a reception reference electrode 322 corresponding to the reception reference electrode 122, and Rr 323-1 and a detector 323-2 corresponding to the receiver section 123. Namely, the reception signal electrode 321 is connected to one of both terminals of Rr 323-1, and the reception reference electrode 322 is connected to the other. The reception signal electrode 321 is provided in close proximity to the communication medium 330. The reception reference electrode 322 is provided to be spaced from the communication medium 330 to such an extent that the transmission reference electrode 312 is not influenced by the communication medium 330, and is constructed to have a capacitance with respect to a space outside the receiver 320. Although Rr 223-1, the detector 223-2 and the ground point 223-3 have been described as corresponding to the receiver section 123 with reference to FIG. 2, such ground point is omitted in FIG. 4 for convenience of explanation.

In addition, it is assumed that the communication medium 330 is a perfect conductor as in the cases shown in FIGS. 1 and 2. It is also assumed that the transmitter 310 and the receiver 320 are arranged to maintain a sufficient distance therebetween so that their mutual influence can be neglected. It is further assumed that the transmission signal electrode 311 is capacitively coupled to only the communication medium 330 and the transmission reference electrode 312 is spaced a sufficient distance apart from the transmission signal electrode 311 so that their mutual influence can be neglected. Similarly, it is assumed that the reception signal electrode 321 is capacitively coupled to only the communication medium 330 and the reception reference electrode 322 is spaced a sufficient distance apart from the reception signal electrode 321 so that their mutual influence can be neglected. Strictly, each of the transmission signal electrode 311, the reception signal electrode 321 and the communication medium 330 has a capacitance relative to the space, but the capacitance is assumed to be herein negligible for convenience of explanation.

As shown in FIG. 4, in the communication system 300, the transmitter 310 is arranged at one end of the communication medium 330, and the receiver 320 is arranged at the other end.

It is assumed that a space of distance dte [m] is formed between the transmission signal electrode 311 and the communication medium 330. If the transmission signal electrode 311 is assumed to be a conductive disk having a surface area Ste [m2] on one side, a capacitance Cte 314 formed between the transmission signal electrode 311 and the communication medium 330 can be found from the following formula (9):

$$\begin{matrix}[ Formula 9 ] & \\ Cte = ɛ \times \frac{Ste}{dte} [ F ] & ( 9 )\end{matrix}$$

Formula (9) is a generally known mathematical formula for the capacitance of a parallel plate. Formula (9) is a mathematical formula to be applied to the case where parallel plates have the same area, but since formula (9) does not provide a seriously impaired result even when applied to the case where parallel plates have different areas, formula (9) is used herein. In formula (9), ∈ denotes a dielectric constant, and if the communication system 300 is assumed to be placed in the air, the specific dielectric constant ∈r can be regarded as approximately 1, so that the dielectric constant ∈ can be regarded as equivalent to the vacuum dielectric constant ∈0. If it is assumed that the surface area Ste of the transmission signal electrode 311 is 2×10⁻³ [m2] (approximately 5 [cm] in diameter) and the distance dte is 5×10⁻³ [m] (5 [mm]), the capacitance Cte 314 can be found from the following formula (10):

$$\begin{matrix}[ Formula 10 ] & \\ \begin{matrix}Cte = ( 8.854 \times {10}^{- 12} ) \times \frac{2 \times {10}^{- 3}}{5 \times {10}^{- 3}} \\ \approx 3.5 [ pF ]\end{matrix} & ( 10 )\end{matrix}$$

Incidentally, in terms of physical phenomena, the above-mentioned formula (9) is strictly applicable to the case where the relationship of Ste>>dte is satisfied, but it is assumed herein that the capacitance Cte 314 can be approximated by formula (9).

A capacitance Cte 315 formed by the transmission reference electrode 312 and a space will be described below. In general, if a disk of radius r [m] is placed in a space, a capacitance C [F] which is formed between the disk and the space can be found from the following formula (11):

[Formula 11]
C=8×∈×r [F] (11)

If the transmission reference electrode 312 is a conductive disk of radius rtg=2.5×10⁻² [m] (radius of 2.5 [cm]), the capacitance Cte 315 formed by the transmission reference electrode 312 and the space can be found by using the above-mentioned formula (11), as shown in the following formula (12). It is assumed here that the communication system 300 is placed in the air, the dielectric constant of the space can be approximated by the vacuum dielectric constant ∈0.

$$\begin{matrix}[ Formula 12 ] & \\ \begin{matrix}Ctg = 8 \times 8.854 \times {10}^{- 12} \times 2.5 \times {10}^{- 2} \\ \approx 1.8 [ pF ]\end{matrix} & ( 12 )\end{matrix}$$

If the reception signal electrode 321 is the same in size as the transmission signal electrode 311 and the space between the reception signal electrode 321 and the communication medium 330 is the same as the space between the transmission signal electrode 311 and the communication medium-330, a capacitance Cre 324 which is formed by the reception signal electrode 321 and the communication medium 330 is 3.5 [pF] as in the case of the transmission side. If the reception reference electrode 322 is the same in size as the transmission reference electrode 312, a capacitance Crg 325 which is formed by the reception reference electrode 322 and a space is 1.8 [pF] as in the case of the transmission side. Accordingly, the combined capacitance Cx of the four electrostatic capacities Cte 314, Ctg 315, Cre 324 and Crg 325 can be expressed by using the above-mentioned formula (4), as shown in the following formula (13):

$$\begin{matrix}[ Formula 13 ] & \\ \begin{matrix}{C}_{x} = \frac{1}{\frac{1}{Cte} + \frac{1}{Ctg} + \frac{1}{Cre} + \frac{1}{Crg}} \\ = \frac{1}{\frac{1}{3.5 \times {10}^{- 12}} + \frac{1}{1.8 \times {10}^{- 12}} + \frac{1}{3.5 \times {10}^{- 12}} + \frac{1}{1.8 \times {10}^{- 12}}} \\ \approx 0.6 [ pF ]\end{matrix} & ( 13 )\end{matrix}$$

If it is assumed that: the frequency f of the signal source 313-1 is 1 [MHz]; the effective value Vtrms of the voltage generated by the signal source 313-1 is 2 [V]; and the resistance value of Rr 323-1 is set to 100 K [Ω], the voltage Vrrms generated across Rr 323-1 can be found from the following formula (14):

$$\begin{matrix}[ Formula 14 ] & \\ \begin{matrix}{V}_{rrms} = \frac{Rr}{\sqrt{{Rr}^{2} + \frac{1}{{( 2 π {fC}_{x} )}^{2}}}} \times {V}_{trms} \\ = \frac{1 \times {10}^{5}}{\sqrt{{( 1 \times {10}^{5} )}^{2} + \frac{1}{{( 2 \times π \times ( 1 \times {10}^{6} ) \times ( 0.6 \times {10}^{- 12} ) )}^{2}}}} \\ \approx 0.71 [ V ]\end{matrix} & ( 14 )\end{matrix}$$

As is apparent from the above-mentioned result, it is possible to transmit signals from a transmitter to a receiver as a basic principle by using electrostatic capacities formed by spaces.

The above-mentioned electrostatic capacities of the transmission reference electrode and the reception reference electrode with respect to the respective spaces can be formed only if a space exits at the location of each of the electrodes. Accordingly, only if the transmission signal electrode and the reception signal electrode are coupled via the communication medium, the transmitter and the receiver can achieve stability of communication irrespective of their mutual distance.

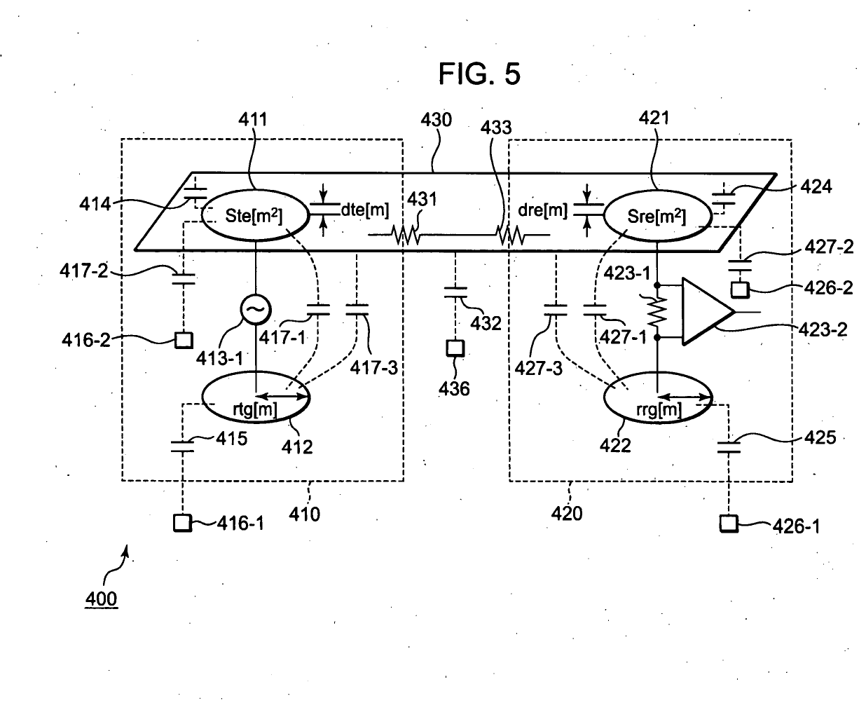

The case where the present inventive communication system is actually physically constructed will be described below. FIG. 5 is a diagram showing an example of a calculation model for parameters generated in a case where any of the above-mentioned communication systems is actually physically constructed.

Namely, a communication system 400 has a transmitter 410, a receiver 420, and a communication medium 430, and is a system which corresponds to the above-mentioned communication system 100 (the communication system 200 or the communication system 300) and is basically the same in construction as any of the communication systems 100 to 300 except that parameters to be evaluated differ.

As compared with the communication system 300, the transmitter 410 corresponds to the transmitter 310, a transmission signal electrode 411 of the transmitter 410 corresponds to the transmission signal electrode 311, a transmission reference electrode 412 corresponds to the transmission reference electrode 312, and a signal source 413-1 corresponds to the signal source 313-1. The receiver 420 corresponding to the receiver 320, a reception signal electrode 421 of the receiver 420 corresponds to the reception signal electrode 321, a reception reference electrode 422 corresponds to the reception reference electrode 322, Rr423-1 corresponds to Rr323-1, and a detector 423-2 corresponds to the detector 323-2. In addition, the communication medium 430 corresponds to the communication medium 330.

Referring to the parameters, a capacitance Cte 414 between the transmission signal electrode 411 and the communication medium 430 corresponds to Cte 314 of the communication system 300, a capacitance Ctg 415 of the transmission reference electrode 412 with respect to a space corresponds to Ctg 315 of the communication system 300, and a ground point 416-1 indicative of an imaginary infinity point in a space outside the transmitter 410 corresponds to the ground point 316 of the communication system 300. The transmission signal electrode 411 is a disk-shaped electrode of area Ste [m2] and is provided at a location away from the communication medium 430 by a small distance dte [m]. The transmission reference electrode 412 is also a disk-shaped electrode and has a radius rtg [m].

In the receiver 420, a capacitance Cre 424 between the reception signal electrode 421 and the communication medium 430 corresponds to Cre 324 of the communication system 300, a capacitance Crg 425 of the reception reference electrode 422 with respect to a space corresponds to Crg 325 of the communication system 300, and a ground point 426-1 indicative of an imaginary infinity point in a space outside the receiver 420 corresponds to the ground point 326 of the communication system 300. The reception signal electrode 421 is a disk-shaped electrode of area Sre [m2] and is provided at a location away from the communication medium 430 by a small distance dre [m]. The reception reference electrode 422 is also a disk-shaped electrode and has a radius rrg [m].

The communication system 400 shown in FIG. 5 is a model in which the following new parameters are added to the above-mentioned parameters.

For example, regarding the transmitter 410, the following parameters are added as new parameters: a capacitance Ctb 417-1 formed between the transmission signal electrode 411 and the transmission reference electrode 412, a capacitance Cth 417-2 formed between the transmission signal electrode 411 and a space, and a capacitance Cti 417-3 formed between the transmission reference electrode 412 and the communication medium 430.

Regarding the receiver 420, the following parameters are added as new parameters: a capacitance Crb 427-1 formed between the reception signal electrode 421 and the reception reference electrode 422, a capacitance Crh 427-2 formed between the reception signal electrode reception signal electrode 421 and a space, and a capacitance Cri 427-3 formed between the reception reference electrode 422 and the communication medium 430.

Furthermore, regarding the communication medium 430, a capacitance Cm 432 formed between the communication medium 430 and a space is added as a new parameter. In addition, since the communication medium 430 actually has an electrical resistance based on its size, its material and the like, resistance values Rm 431 and Rm 433 are added as new parameters corresponding to the resistance component.

Although illustration is omitted in the communication system 400 shown in FIG. 5, if the communication medium 430 has not only conductivity but also dielectricity, a capacitance according to the dielectric constant is also formed. In addition, if the communication medium 430 does not have conductivity and a capacitance is formed by only dielectricity, the capacitance, which is determined by the dielectric constant, the distance, the size and the arrangement of the dielectric material of the communication medium 430, is formed between the transmission signal electrode 411 and the reception signal electrode 421.

In addition, in the communication system 400 shown in FIG. 5, it is assumed that the distance between the transmitter 410 and the receiver 420 is apart to such an extent that a factor such as their mutual capacitive coupling can be neglected (the influence of the capacitive coupling between the transmitter 410 and the receiver 420 can be neglected). If the distance is short, there may be a need for taking account of a capacitance between the electrodes in the transmitter 410 and a capacitance between the electrodes in the receiver 420 in accordance with the above-mentioned approach, depending on the positional relationship between the electrodes in the transmitter 410 and that between the electrodes in the receiver 420.

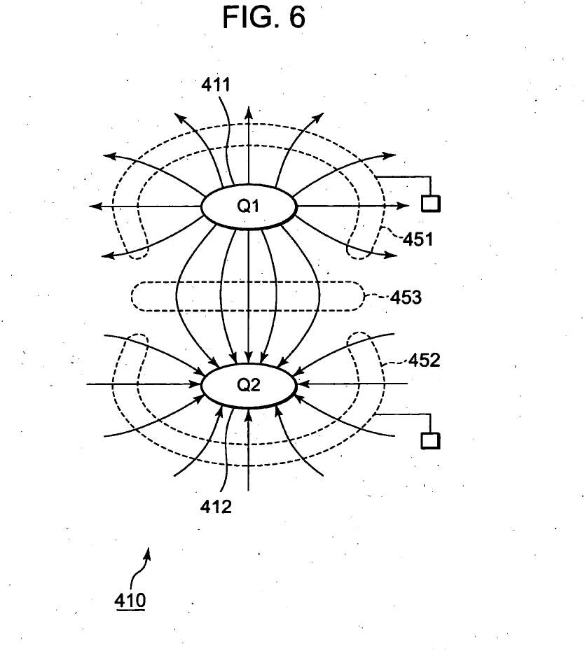

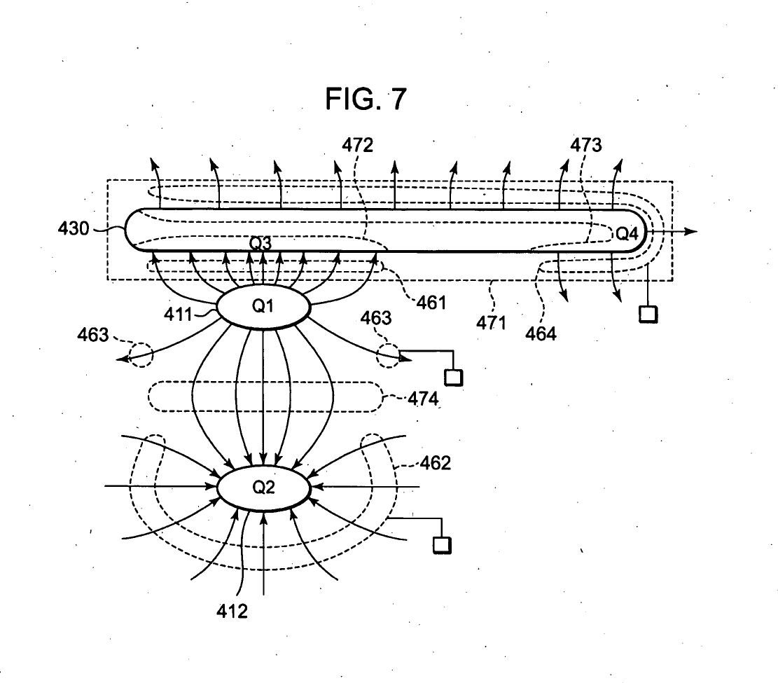

The operation of the communication system 400 shown in FIG. 5 will be described below by using electric lines of force. FIG. 6 is a schematic view in which the relationship between the electrodes in the transmitter 410 of the communication system 400 is represented by electric lines of force, and FIG. 7 is a schematic view in which the relationship between the electrodes in the transmitter 410 of the communication system 400 and the communication medium 430 is represented by electric lines of force.

FIG. 6 is a schematic view showing an example of distribution of electric lines of force in a case where the communication medium 430 does not exist. It is assumed that the transmission signal electrode 411 has positive charge (positively charged) and the transmission reference electrode 412 has negative charge (negatively charged). The arrows shown in FIG. 6 denote the electric lines of force, and the directions of the respective arrows are from positive charge to negative charge. The electric lines of force do not suddenly disappear halfway and have the nature of arriving at either an object having charge of a different sign or the imaginary infinity point.

In FIG. 6, from among the electric lines of force emitted from the transmission signal electrode 411, electric lines of force 451 denote electric lines of force arriving at the infinity point, while from among the electric lines of force turning toward the transmission reference electrode 412, electric lines of force 452 denote electric lines of force arriving from the imaginary infinity point. Electric lines of force 453 denote electric lines of force produced between the transmission signal electrode 411 and the transmission reference electrode 412. As shown in FIG. 6, electric lines of force move from the positively charged electrode 411 of the transmitter 410, while electric lines of force move toward the negatively charged transmission reference electrode 412 of the transmitter 410. The distribution of the electric lines of force is influenced by the size of each of the electrodes and the positional relationship therebetween.

FIG. 7 is a schematic view showing an example of electric lines of force in a case where the communication medium 430 is brought closer to the transmitter 410. As the communication medium 430 is brought closer to the transmission signal electrode 411, the coupling therebetween becomes stronger and most of the electric lines of force 451 arriving at the infinity point in FIG. 6 become electric lines of force 461 arriving at the communication medium 430, so that the number of electric lines of force 463 moving toward the infinity point (the electric lines of force 451 shown in FIG. 6) is decreased. Accordingly, the capacitance relative to the infinity point as viewed from the transmission signal electrode 411 (Cth 417-2 in FIG. 5) decreases, and the capacitance between the transmission signal electrode 411 and the communication medium 430 (Cth 417-2 in FIG. 5) increases. A capacitance (Cti 417-3 in FIG. 5) between the transmission reference electrode 412 and the communication medium 430 actually exists as well, but in FIG. 7, it is assumed that the capacitance is negligible.

According to Gauss's law, the number N of electric lines of force moving through an arbitrary closed surface S is equal to the charge enclosed in the closed surface S which is divided by the dielectric constant ∈, and is not influenced by charge outside the closed surface S. When it is assumed that n-number of charges exist in the closed surface S, the following formula is obtained:

$$\begin{matrix}[ Formula 15 ] & \\ N = \frac{1}{ɛ} \times {\sum }_{i = 1}^{n} {q}_{i} pieces & ( 15 )\end{matrix}$$

In formula (15), i denotes an integer, and a variable qi denotes the amount of charge accumulated in each of the electrodes. Formula (15) represents that electric lines of force emerging from the closed surface S of the transmission signal electrode 411 are determined by only electric lines of force emanated from the charges existing in the closed surface S, and all electric lines of force entering from the outside of the transmission reference electrode 412 leave from other locations.

According to this law, in FIG. 7, if it is assumed that the communication medium 430 is not grounded, a generation source of charge does not exist in a closed surface 471 near the communication medium 430, charge Q3 is induced by electrostatic induction in an area 472 of the communication medium 430 near the electric lines of force 461. Since the communication medium 430 is not grounded and the total amount of charge of the communication medium 430 does not change, charge Q4 which is equivalent in amount to but different in sign from the charge Q3 is induced in an area 743 outside the area 472 in which the charge Q3 is induced, so that electric lines of force 464 produced by the charge Q4 move out of the closed surface 471. The larger the size of the communication medium 430 becomes, the more the charge Q4 diffuses and the lower the charge density becomes, so that the number of electric lines of force per section area decreases.

If the communication medium 430 is a perfect conductor, the communication medium 430 has the nature of becoming approximately equal in charge density irrespective of its sites, because the communication medium 430 has the characteristic that its potential becomes the same irrespective of the sites as the result of the nature of the perfect conductor. If the communication medium 430 is a conductor having a resistance component, the number of electric lines of force decreases according to the distance between the communication medium 430 and the transmission signal electrode 411 in accordance with the resistance component. If the communication medium 430 is a dielectric having no conductivity, electric lines of force are diffused and propagated by its polarization action. If n-number of conductors exist in a space, the charge Qi of each of the conductors can be found from the following formula:

$$\begin{matrix}[ Formula 16 ] & \\ {Q}_{i} = {\sum }_{j = 1}^{n} {C}_{ij} \times {V}_{j} ) & ( 16 )\end{matrix}$$

In formula (16), i and j denote integers, and Cij denotes a capacitance coefficient formed by the conductor i and the conductor j and may be considered to have the same nature as capacitance. The capacitance coefficient is determined by only the shapes of the respective conductors and the positional relationship therebetween. The capacitance coefficient Cii becomes a capacitance that the conductor i itself forms with respect to a space. In addition, Cij=Cii. Formula (16) represents that a system formed by a plurality of conductors operates on the basis of the superposition theorem and that the charge of each of the conductors is determined by the sum of the products of the capacitance between the conductors and the potentials of the respective conductors.

It is assumed here that the mutually associated parameters shown in FIG. 7 and formula (16) are determined as follows. For example, Q1 denotes charge induced in the transmission signal electrode 411, Q2 denotes charge induced in the transmission reference electrode 412, Q3 denotes charge in the communication medium 430 by the transmission signal electrode 411, and Q4 denotes charge equivalent in amount to and different in sign to the charge Q3 in the communication medium 430.

V1 denotes the potential of the transmission signal electrode 411 with respect to the infinity point, V2 denotes the potential of the transmission reference electrode 412 with respect to the infinity point, V3 denotes the potential of the communication medium 430 with respect to the infinity point, C12 denotes the capacitance coefficient between the transmission signal electrode 411 and the transmission reference electrode 412, C13 denotes the capacitance coefficient between the transmission signal electrode 411 and the communication medium 430, C15 denotes the capacitance coefficient between the transmission signal electrode 411 and the space, C25 denotes the capacitance coefficient between the transmission reference electrode 412 and the space, and C35 denotes the capacitance coefficient between the communication medium 430 and the space.

At this time, the charge Q3 can be found from the following formula:

[Formula 17]
Q₃=C13×V1 (17)

If far more electric fields are to be injected into the communication medium 430, the charge Q3 may be increased. For this purpose, the capacitance coefficient C13 between the transmission signal electrode 411 and the communication medium 430 may be increased and a sufficient voltage V1 may be applied. The capacitance coefficient C13 is determined by only the shapes of the shapes of the transmission signal electrode 411 and the communication medium 430 and the positional relationship therebetween, and the closer the distance therebetween and the larger the areas of facing surfaces, the higher the capacitance therebetween. As to the potential V1, a sufficient voltage need be produced as viewed from the infinity point. In the transmitter 410, a potential difference is applied between the transmission signal electrode 411 and the transmission reference electrode 412 by the signal source 413-1, and the behavior of the transmission reference electrode 412 is important so that the potential can be produced as a sufficient potential as viewed from the infinity point as well.

If the transmission reference electrode 412 is small in size and the transmission signal electrode 411 has a sufficiently large size, the capacitance coefficients C12 and C25 become small, whereas the capacitance coefficients C13, C15 and C45 become electrically less variable because each of them has a large capacitance. Accordingly, most of the potential differences generated by the signal source appear as the potential V2 of the transmission reference electrode 412, so that the potential V1 of the transmission signal electrode 411 becomes small.

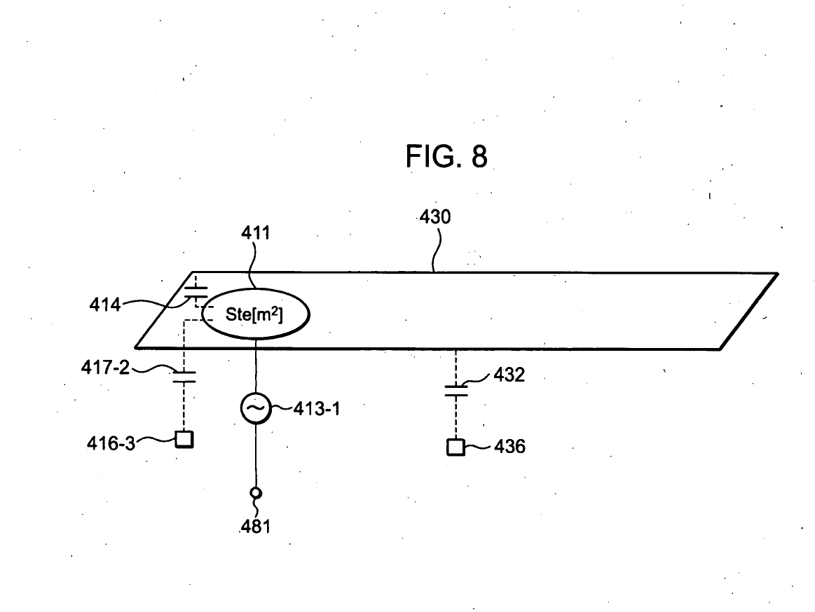

FIG. 8 shows the above-mentioned status. A transmission reference electrode 481 is small in size and is not coupled to any of the conductors or the infinity point. The transmission signal electrode 411 forms the capacitance Cte 414 between itself and the communication medium 430, and forms the capacitance Cth 417-2 with respect to the space. The communication medium 430 forms a capacitance Cm 432 with respect to the space. Even if potentials are produced at the transmission signal electrode 411 and the transmission reference electrode 412, large energy is needed to vary these potentials, because the electrostatic capacities Cte 414, Cth 417-2 and Cm 432 associated with the transmission signal electrode 411 are overwhelmingly large. However, since the capacitance of the transmission reference electrode 481 on the opposite side of the signal source 413-1 is small, the potential of the transmission signal electrode 411 hardly varies, and most potential variations in the signal source 413-1 appear at the transmission reference electrode 481.

Contrarily, if the transmission signal electrode 411 is small in size and the transmission reference electrode 481 has a sufficiently large size, the capacitance of the transmission reference electrode 481 relative to the space increases and becomes to produce electrically less variation. Although a sufficient voltage V1 is produced at the transmission signal electrode 411, the capacitive coupling between the transmission signal electrode 411 and the communication medium 430 is decreased so that sufficient electric fields may not be injected.

Accordingly, on the basis of the balance of the entire system, it is necessary to provide a transmission reference electrode capable of giving a sufficient potential while enabling the electric fields necessary for communication to be injected from a transmission signal electrode to a communication medium. Although the above description has referred to only the transmission side, the relationship between the electrodes of the receiver 420 and the communication medium 430 can also be considered in the same manner.

The infinity point need not be at a physically long distance, and may be set in a space neighboring the device in practical terms. More ideally, it is desirable that the infinity point is more stable and does not show large potential variations in the entire system. In actual use environments, there is noise which is generated from AC power lines, illuminators and other electrical appliances, but such noise may be neglected if the noise does not overlap a frequency bandwidth to be used by at least a signal source or is of negligible level.

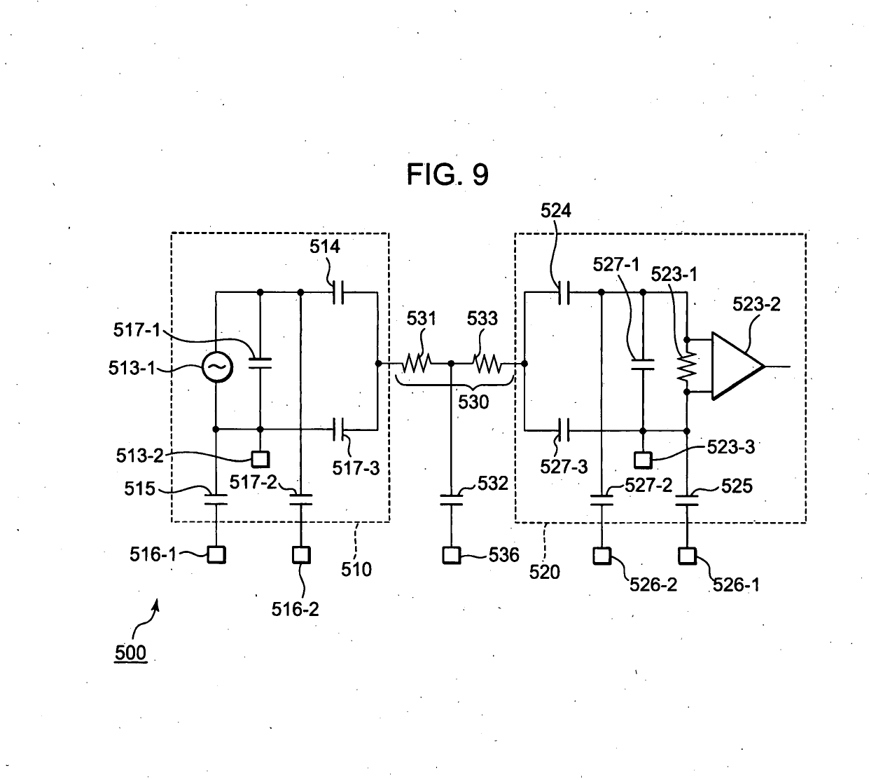

FIG. 9 is a diagram showing an equivalent circuit of the model (the communication system 400) shown in FIG. 5.

As in the relationship between FIGS. 2 and 4, a communication system 500 shown in FIG. 9 corresponds to the communication system 400 shown in FIG. 5, a transmitter 510 of the communication system 500 corresponds to the transmitter 410 of the communication system 400, a receiver 520 of the communication system 500 corresponds to the receiver 420 of the communication system 400, and a connection line 530 of the communication system 500 corresponds to the communication medium 430 of the communication system 400.

Similarly, in the transmitter 510 shown in FIG. 9, a signal source 513-1 corresponds to the signal source 413-1. In the transmitter 510 shown in FIG. 9, there is shown a ground point 513-2 which is omitted in FIG. 5, corresponds to the ground point 213-2 in FIG. 2, and indicates ground in the circuit inside the transmitter section 113 shown in FIG. 1.

Cte 514 in FIG. 9 is a capacitance corresponding to Cte 414 in FIG. 5, Ctg 515 is a capacitance corresponding to Ctg 415 in FIG. 5, and ground points 516-1 and 516-2 respectively correspond to the ground points 416-1 and 416-2. In addition, Ctb 517-1, Cth 517-2 and Cti 517-3 are capacitances corresponding to Ctb 417-1, Cth 417-2 and Cti 417-3, respectively.

Similarly, in the receiver 520, Rr 523-1 and a detector 523-2 respectively correspond to Rr 423-1 and the detector 423-2 shown in FIG. 5. In addition, in the receiver 520 shown in FIG. 9, there is shown a ground point 523-3 which is omitted in FIG. 5, corresponds to the ground point 223-2 in FIG. 2, and indicates ground in the circuit inside the receiver section 123 shown in FIG. 1.

Cre 524 in FIG. 9 is a capacitance corresponding to Cre 424 in FIG. 5, Crg 525 is a capacitance corresponding to Crg 425 in FIG. 5, and ground points 526-1 and 526-2 respectively correspond to the ground points 426-1 and 426-2. In addition, Crb 527-1, Crh 527-2 and Cri 527-3 are capacitances corresponding to Crb 427-1, Crh 427-2 and Cri 427-3, respectively.

Similarly, as to elements connected to the connection line 530, Rm 531 and Rm 533 which are resistance components of the connection line 530 correspond to Rm 431 and Rm 433, respectively, Cm 532 corresponds to Cm 432, and a ground point 536 corresponds to the ground point 436.

The communication system 500 has the following nature.

For example, the larger the value of Cte 514 (the higher the capacitance), the larger signal the transmitter 510 can apply to the connection line 530 corresponding to the communication medium 430. In addition, the larger the value of Ctg 512 (the higher the capacitance), the larger signal the transmitter 510 can apply to the connection line 530. Furthermore, the smaller the value of Ctb 517-1 (the lower the capacitance), the larger signal the transmitter 510 can apply to the connection line 530. In addition, the smaller the value of Cth 512-2 (the lower the capacitance), the larger signal the transmitter 510 can apply to the connection line 530. Furthermore, the smaller the value of Cti 517-3 (the lower the capacitance), the larger signal the transmitter 510 can apply to the connection line 530.

The larger the value of Cre 524 (the higher the capacitance), the larger signal the receiver 520 can extract from the connection line 530 corresponding to the communication medium 430. In addition, the larger the value of Crg 525 (the higher the capacitance), the larger signal the receiver 520 can extract from the connection line 530. Furthermore, the smaller the value of Crb 527-1 (the lower the capacitance), the larger signal the receiver 520 can extract from the connection line 530. In addition, the smaller the value of Cth 527-2 (the lower the capacitance), the larger signal the transmitter 530 can extract from the connection line 530. Furthermore, the smaller the value of Cri 527-3 (the lower the capacitance), the larger signal the receiver 520 can extract from the connection line 530. In addition, the lower the value of Rr 523 (the lower the resistance), the larger signal the receiver 520 can extract from the connection line 530.

The lower the values of Rm 531 and Rm 533 which are the resistance components of the connection line 530 (the lower the resistances), the larger signal the transmitter 510 can apply to the connection line 530. The smaller the value of Cm 532 which is the capacitance of the connection line 530 with respect to the space (the lower the capacitance), the larger signal the transmitter 510 can apply to the connection line 530.

The capacitance of a capacitor is approximately proportional to the surface area of each of its electrodes, and in general, it is more desirable that each of the electrodes have a larger size. However, if the sizes of the respective electrodes are simply increased, there is a risk that the capacitance between the electrodes also increase. In addition, if the ratio of the sizes of the respective is extreme, there is a risk that the efficiency of the capacitor lowers. Accordingly, the sizes and the arrangement locations of the respective electrodes need be determined on the basis of the balance of the entire system.

In addition, the above-mentioned nature of the communication system 500 makes it possible to realize efficient communication in a high frequency bandwidth of the signal source 513-1 by determining the parameters of the present equivalent circuit by an impedance-matching approach. By increasing the frequency, it is possible to ensure reactance even with a small capacitance, so that it is possible to easily miniaturize each of the devices.

In general, the reactance of a capacitor increases with a decrease in frequency. On the other hands since the communication system 500 operates on the basis of capacitive coupling, the lower limit of the frequency of a signal generated by the signal source 513-1 is determined by the capacitive coupling. In addition, since Rm 531, Rm 532 and Rm 533 form a low-pass filter through their arrangement, the upper limit of the frequency is determined by the characteristic of the low-pass filter.

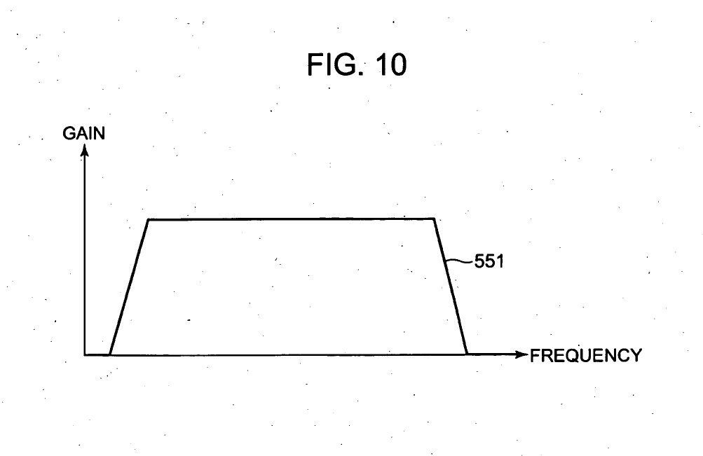

Specifically, the frequency characteristic of the communication system 500 is as indicated by a curve 551 in the graph shown in FIG. 10. In FIG. 10, the horizontal axis represents frequency, and the vertical axis represents the gain of the entire system.

Specific values of the respective parameters of each of the communication system 400 shown in FIG. 5 and the communication system 500 shown in FIG. 9 will be considered below. In the following description, for convenience of explanation, it is assumed that the communication system 400 (the communication system 500) is placed in the air. Each of the transmission signal electrode 411, the transmission reference electrode 412, the reception signal electrode 421 and the reception reference electrode 422 of the communication system 400 is assumed to be a conductive disk of diameter 5 cm.

In the communication system 400 shown in FIG. 5, if the distance d between the transmission signal electrode 411 and the communication medium 430 is 5 mm, the value of the capacitance Cte 414 formed by the transmission signal electrode 411 and the communication medium 430 can be found by using the above-mentioned formula (9), as shown in the following formula (18):

$$\begin{matrix}[ Formula 18 ] & \\ \begin{matrix}Cte = \frac{( 8.854 \times {10}^{- 12} ) \times ( 2 \times {10}^{- 3} )}{5 \times {10}^{- 3}} \\ \approx 3.5 [ pF ]\end{matrix} & ( 18 )\end{matrix}$$

It is assumed herein that Formula (9) can be adapted to Ctb 417-1 which is the capacitance between the electrodes (Ctg 517-1 in FIG. 259). As mentioned above, formula (9) is to be originally applied to the case where the surface area of the electrodes is sufficiently large compared to the distance therebetween. However, in the case of the communication system 400, the value of Ctb 417-1 is assumed to be able to be found by using formula (9), because the value of the capacitance Ctb 417-1 between the transmission signal electrode 411 and the transmission reference electrode 412, which is found by using formula (9), sufficiently approximates its original correct value so that a problem does not arise in the explanation of principles. If the distance between the electrodes is assumed to be 5 cm, Ctb 417-1 (Ctb 517-1 in FIG. 9] is as expressed by the following formula (19):

$$\begin{matrix}[ Formula 19 ] & \\ \begin{matrix}Ctb = \frac{( 8.854 \times {10}^{- 12} ) \times ( 2 \times {10}^{- 3} )}{5 \times {10}^{- 2}} \\ \approx 0.35 [ pF ]\end{matrix} & ( 19 )\end{matrix}$$

If it is assumed that the distance between the transmission signal electrode 411 and the communication medium 430 is narrow, the coupling of the transmission signal electrode 411 to the space is weak and the value of Cth 417-2 (Cth 517-2 in FIG. 9) is sufficiently smaller than the value of Cte 414 (Cte 514). Accordingly, the value of Cth 417-2 (Cth 517-2) is set to one-tenth of the value of Cte 414 (Cte 514) as expressed by formula (20):

$$\begin{matrix}[ Formula 20 ] & \\ Cth = \frac{Cte}{10} = 0.35 [ pF ] & ( 20 )\end{matrix}$$

Cteg 415 (Ctg 515 in FIG. 9) which denotes a capacitance formed by the transmission reference electrode 412 and the space can be found from the following formula (21), as in the case of FIG. 4 (formula (12)):

[Formula 21]
Ctg=8×8.854×10⁻¹²×2.5×10⁻²≈1.8 [pF] (21)

The value of Cti 417-3 (the value of Cti 517-3 in FIG. 9) is considered equivalent to the value of Ctb 417-1 (Ctb 517-1 in FIG. 9) as follows:
Cti=Ctb=0.35 [pF]

If the constructions of the respective electrodes (the sizes and the installation locations of the respective electrodes) are set as in the case of the transmitter 410, the parameters of the receiver 420 (the receiver 520 shown in FIG. 9) can be set similarly to the parameters of the transmitter 410 as follows:

Cre=Cte=3.5 [pF]

Crb=Ctb=0.35 [pF]

Crh=Cth=0.35 [pF]

Crg=Ctg=1.8 [pF]

Cri=Cti=0.35 [pF]

In the following description, for convenience of explanation, it is assumed that the communication medium 430 (the connection line 530 shown in FIG. 9) is an object having characteristics close to a living body having approximately the same size as a human body. It is assumed that the electrical resistance from the location of the transmission signal electrode 411 of the communication medium 430 to the location of the reception signal electrode 421 (from the location of a transmission signal electrode 511 to the location of a reception signal electrode 521 in FIG. 9) is 1 M [Ω], and that the value of each of Rm 431 and the Rm 433 (Rm 531 and Rm 533 in FIG. 9) is 500 K [Ω]. In addition, it is assumed that the value of the capacitance Cm 432 (Cm 532 in FIG. 9] formed between the communication medium 430 and the space is 100 [pF].

Furthermore, it is assumed that the signal source 413-1 (the signal source 513-1 in FIG. 9) outputs a sine wave having a maximum value of 1 [V] and a frequency of 10 M [Hz].

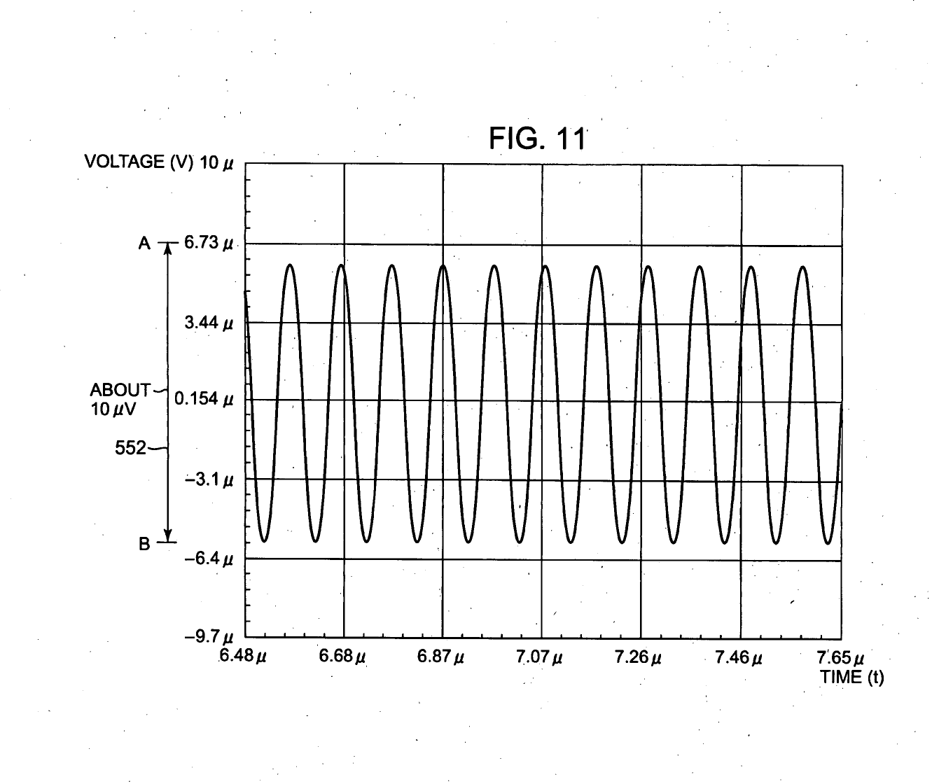

When a simulation is performed by using the above-mentioned parameters, a received signal having the waveform shown in FIG. 11 is obtained as the result of the simulation. In the graph shown in FIG. 11, the vertical axis represents the voltage across Rr 423-1 (Rr 523-1) which is a reception load of the receiver 420 (the receiver 520 shown in FIG. 9), while the horizontal axis represents time. As indicated by an double-headed arrow 525 in FIG. 11, the difference between a maximum value A and a minimum value B (the difference between peak values) of the waveform of the received signal is observed as approximately 10 [μF]. Accordingly, since this difference is amplified by an amplifier having sufficient gain (the detector 423-2), the signal on the transmission side (the signal generated by the signal source 413-1) can be restored on the reception side.

Accordingly, the above-mentioned communication system does not need a physical reference point path and can realize communication based on only a communication signal transmission path, so that it is possible to easily provide communication environments not restricted by use environments.

The arrangement of the electrodes in each of the transmission and receivers will be described below. As mentioned above, the respective electrodes have mutually different functions, and form capacitances with respect to the communication medium, the spaces and the like. Namely, the respective electrodes are capacitively coupled to different objects, and operate by using different capacitive couplings. Accordingly, a method of arranging the electrodes is a very important factor in effectively capacitively coupling the respective electrodes to the desired objects.

For example, in the communication system 400 shown in FIG. 5, if communication is to be efficiently performed between the transmitter 410 and the receiver 420, the individual electrodes need be arranged on the following conditions; that is to say, the devices 410 and 420 need satisfy, for example, the conditions that both the capacitance between the transmission signal electrode 411 and the communication medium 430 and the capacitance between the reception signal electrode 421 and the communication medium 430 are sufficient, that both the capacitance between the transmission reference electrode 412 and the space and the capacitance between the reception reference electrode 422 and the space are sufficient, that the capacitance between the transmission signal electrode 411- and the transmission reference electrode 412 and the capacitance between the reception signal electrode 421 and the reception reference electrode 422 are respectively smaller than the capacitance between the transmission signal electrode 411 and the communication medium 430 and the capacitance between the reception signal electrode 421 and the communication medium 430, and that the capacitance between the transmission signal electrode 411 and the space and the capacitance between the reception signal electrode 421 and the space are respectively smaller than the capacitance between the transmission reference electrode 412 and the space and the capacitance between the reception reference electrode 422 and the space.

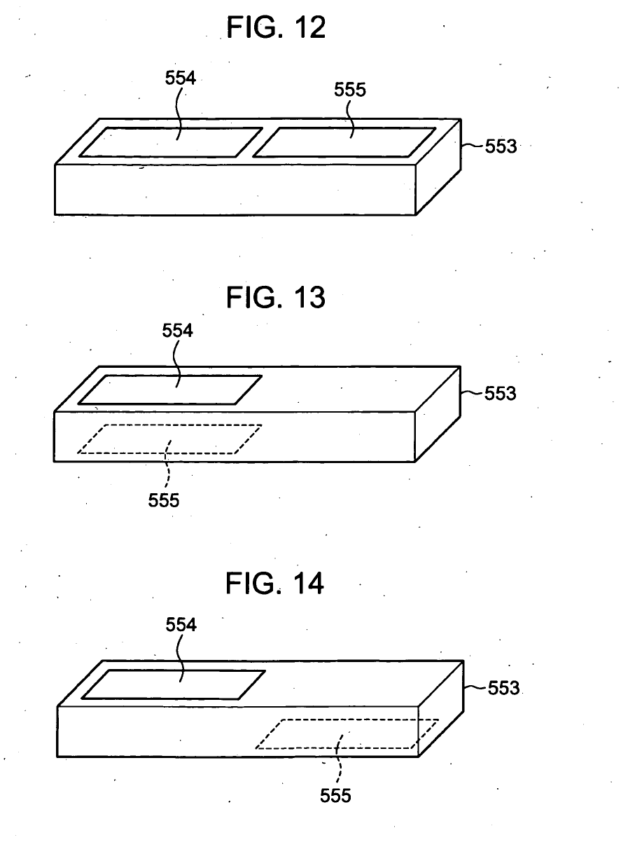

Arrangement examples of electrodes are shown in FIGS. 12 to 18. These examples described below can be applied either to a transmitter or a receiver. In the following description, reference will be made only to a transmitter, and that to a receiver is omitted. If the following examples are applied to a receiver, a transmission electrode should correspond to a reception electrode, and a transmission reference electrode to a reception reference electrode.

Referring to FIG. 12, two electrodes, i.e., a transmission signal electrode 554 and a transmission reference electrode 555, are arranged on the same plane of a casing 553. According to this construction, it is possible to decrease the capacitance between the two electrodes (the transmission signal electrode 554 and the transmission reference electrode 555), as compared with the case where the two electrodes are arranged to oppose each other. If the transmitter constructed in this manner is used, only one of the two electrodes is arranged close to a communication medium. For example, a folding mobile telephone has the casing 553 made of two units and a hinge section, and is constructed so that the two units are joined by the hinge section with the relative angle between the two units being variable and so that the casing 553 is foldable on the hinge section in the vicinity of its lengthwise center. If the electrode arrangement shown in FIG. 12 is applied to the folding mobile telephone, one of the electrodes can be arranged on the back side of a section provided with operating buttons, while the other electrode is arranged on the back side of a section provided with a display section. According to this arrangement, the electrode arranged in the section provided with operating buttons is covered with a hand of a user, and the electrode provided on the back side of the display section is arranged to face space; that is to say, it is possible to arrange the two electrodes so as to satisfy the above-mentioned conditions.

FIG. 13 is a schematic view showing the casing 553 in which the two electrodes (the transmission signal electrode 554 and the transmission reference electrode 555) are arranged to oppose each other. As compared with the arrangement shown in FIG. 12, the arrangement shown in FIG. 13 is suitable for the case where the casing 553 is comparatively small in size, although the capacitive coupling between the two electrodes is strong. In this case, it is desirable to arrange the respective two electrodes in directions spaced apart from each other by as much distance as possible in the casing 553.

FIG. 14 is a schematic view showing the casing 553 in which the two electrodes (the transmission signal electrode 554 and the transmission reference electrode 555) are respectively arranged on mutually opposite faces so as not to directly oppose each other. In the case of this arrangement, the capacitive coupling between the two electrodes is smaller than that between the two electrodes shown in FIG. 13.

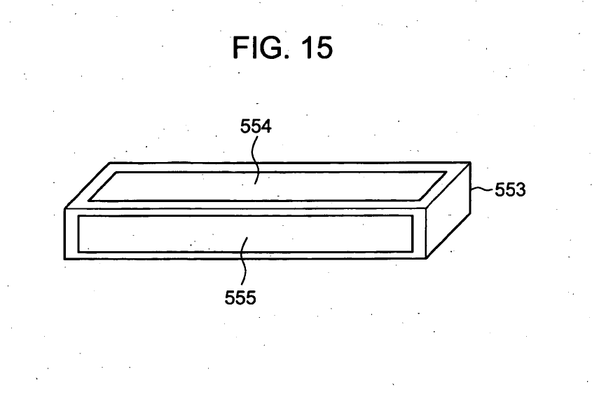

FIG. 15 is a schematic view showing the casing 553 in which the two electrodes (the transmission signal electrode 554 and the transmission reference electrode 555) are arranged perpendicular to each other. According to this arrangement, in uses where the transmission signal electrode 554 and the side of the casing 553 opposed thereto are placed near a communication medium, a lateral side of the casing 553 (a side on which the transmission reference electrode 555 is arranged) remains capacitively coupled to space, so that communication can be performed.

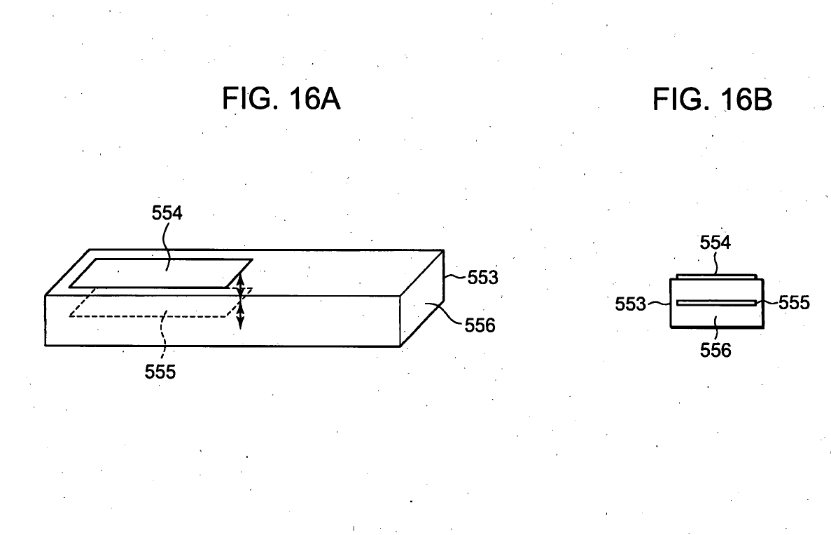

FIGS. 16A and 16B are schematic views showing that the transmission reference electrode 555 which is either one of the two electrodes in the arrangement shown in FIG. 13 is arranged inside the casing 553. Specifically, as shown in FIG. 16A, only the transmission reference electrode 555 is provided inside the casing 553. FIG. 16B is a schematic view showing an example of an electrode position as viewed from a side 556 of FIG. 16A. As shown in FIG. 16B, the transmission signal electrode 554 is arranged on a surface of the casing 553, and only the transmission reference electrode 555 is arranged inside the casing 553. According to this arrangement, even if the casing 553 is widely covered with a communication medium, communication can be performed, because the space inside the casing 553 exists around either one of the electrodes.

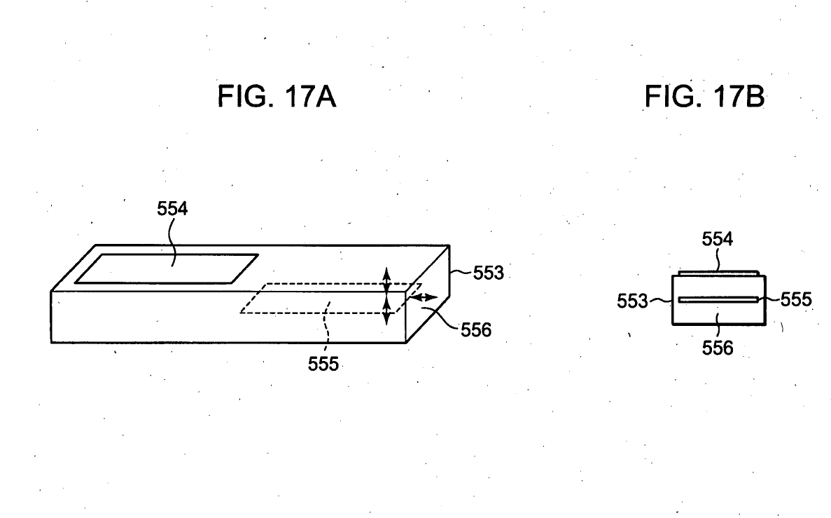

FIGS. 17A and 17B are schematic views showing that the transmission reference electrode 555 which is either one of the two electrodes in the arrangement shown in each of FIGS. 12 and 14 is arranged inside the casing 553. Specifically, as shown in FIG. 17A, only the transmission reference electrode 555 is provided inside the casing 553. FIG. 17B is a schematic view showing an example of an electrode position as viewed from the side 556 of FIG. 17A. As shown in FIG. 17B, the transmission signal electrode 554 is arranged on a surface of the casing 553, and only the transmission reference electrode 555 is arranged inside the casing 553. According to this arrangement, even if the casing 553 is widely covered with a communication medium, communication can be performed, because a space margin inside the casing 553 exists around either one of the electrodes.

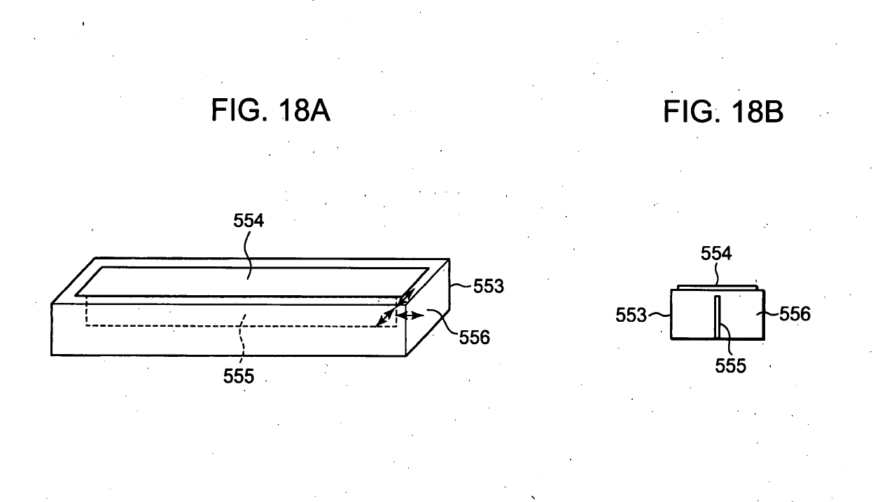

FIGS. 18A and 18B are schematic views showing that either one of the two electrodes in the arrangement shown in FIG. 15 is arranged inside the casing. Specifically, as shown in FIG. 18A, only the transmission reference electrode 555 is provided inside the casing 553. FIG. 18B is a schematic view showing an example of an electrode position as viewed from the side 556 of FIG. 18A. As shown in FIG. 18B, the transmission signal electrode 554 is arranged on a surface of the casing 553, and only the transmission reference electrode 555 is arranged inside the casing 553. According to this arrangement, even if the casing 553 is widely covered with a communication medium, communication can be performed, because a space margin inside the casing 553 exists around either one of the electrodes.

In any of the above-mentioned electrode arrangements, one of the two electrodes is arranged closer to a communication medium than the other is, and the one is arranged to have a stronger capacitive coupling to space. In addition, in each of the electrode arrangements, the two electrodes are desirably arranged so that the capacitive coupling therebetween is weaker than the other capacitive couplings.

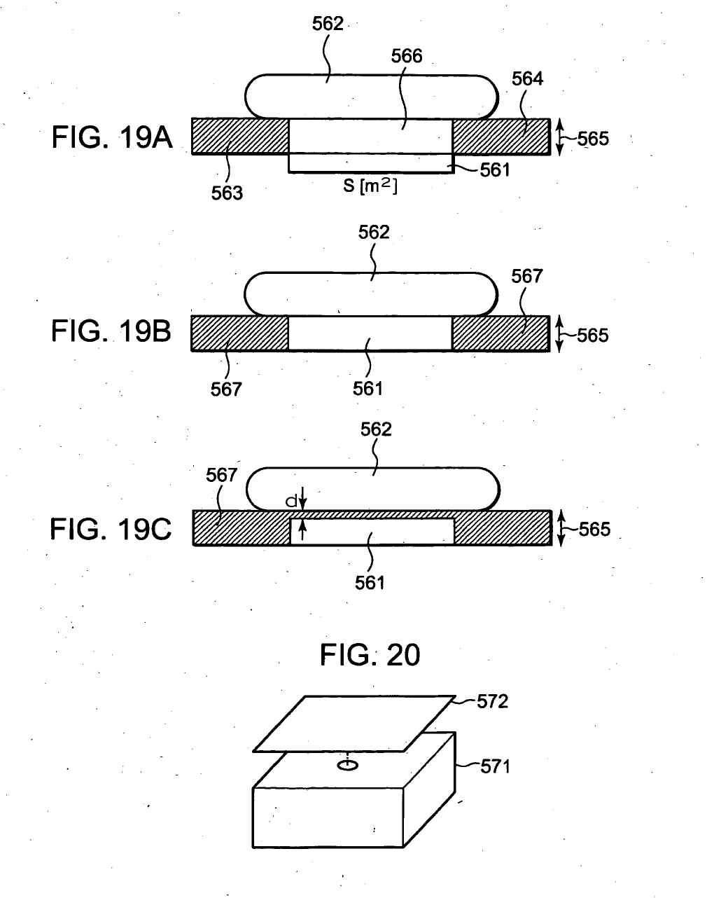

The transmitter or the receiver may also be incorporated in an arbitrary casing. In each of the devices according to the embodiment of the present invention, there are at least two electrodes which are electrically isolated from each other, so that a casing in which to incorporate the electrodes is also made of an insulator having a certain thickness. FIGS. 19A to 19B are cross-sectional views of a transmission signal electrode and neighboring sections. A transmission reference electrode, a reception signal electrode and a reception reference electrode have a similar construction to the transmission signal electrode, and the above description can be applied to any of those electrodes. Accordingly, the description of those electrodes is omitted herein.

FIG. 19A shows a cross-sectional view around the electrodes. As casings 563 and 564 have a physical thickness d [m] as indicated by a double-headed arrow 565, a space equal to the thickness is at least maintained between the electrodes and the communication medium (for example, between the transmission signal electrode 561 and the communication medium 562) or between the electrodes and the space. As is clear from the above-described, it is generally preferable to increase the capacitance between the electrodes and the communication medium, or between the electrodes and the space.

An example is considered in which the casings 563 and 564 are brought into contact with the communication medium 562. The capacitive coupling C between the transmission signal electrode 561 and the communication medium 562 in this case can be found from formula (9), and can therefore be expressed by the following formula (22).

$$\begin{matrix}[ Formula 22 ] & \\ C = ( {ɛ}_{r} \times {ɛ}_{0} ) \times \frac{S}{d} [ F ] & ( 22 )\end{matrix}$$

In formula (22), ∈0 denotes a vacuum dielectric constant having a fixed value of 8.854×10⁻¹² [F/m], ∈r denotes a specific dielectric constant at that location, and S denotes a surface area of the transmission signal electrode 561. If a dielectric having a high specific dielectric constant is arranged in the space 566 formed above the transmission signal electrode 561, the capacitive coupling C can be increased to improve the performance of the device.

In a similar manner, it is possible to increase the capacitance between the transmission signal electrode 561 and the neighboring space. In the example of FIG. 19A, dielectric materials are inserted into the portion corresponding to the thickness of the casing (the double-headed arrow 565). However, the dielectric materials may be positioned any portion, not restricted to that portion.

FIG. 19B shows an example in which the electrode is embedded in a casing. In FIG. 19B, the transmission signal electrode 561 is configured to be embedded in the casing 567 (as is made a portion of the casing 567). Thus, the communication medium 562 is brought into contact with the casing 567, and simultaneously with the transmission signal electrode 561. In addition, an insulation layer may also be formed on the surface of the transmission signal electrode 561 so that the communication medium 562 and the transmission signal electrode 561 can be held in non-contact with each other.

FIG. 19C is similar to FIG. 19B but shows an example in which a hollow having an opening area equivalent to the surface area of the transmission signal electrode 561 is formed in the casing 567 with a thickness d′ being left, and the transmission signal electrode. 561 is embedded in the hollow. If the casing 567 is formed by solid casting, manufacturing costs and component costs can be reduced and capacitive coupling can be easily increased by the present method.

According to the above-described explanation, when a plurality of electrodes is arrange in the same plane as shown FIG. 12, it is possible to make a communication by inserting dielectric materials at the side of the transmission signal electrode 554 (or inserting much higher dielectric materials at the side of transmission signal electrode 554 than that at the side of the transmission reference electrode 555) so that the transmission signal electrode 554 has a stronger capacitive coupling with the communication medium to have a potential difference between the electrodes, even if both of the transmission signal electrode 554 and the transmission reference electrode 555 couple with the communication medium.

The sizes of individual electrodes will be described below. At least a transmission reference electrode and a reception reference electrode need to form a capacitance relative to a sufficient space so that a communication medium can obtained a sufficient potential, but a transmission signal electrode and a reception signal electrode may be designed to have optimum sizes on the basis of a capacitance relative to the communication medium and the nature of signals to flow in the communication medium. Accordingly, generally, the transmission reference electrode is made larger in size than the transmission signal electrode, and the reception reference electrode is made larger in size than the reception signal electrode. However, it is of course possible to adopt other relationships as long as sufficient signals for communication can be obtained.

Specifically, if the size of the transmission reference electrode is made coincident with the size of the transmission signal electrode and the size of the reception reference electrode is made coincident with the size of the reception signal electrode, these electrodes appear to have mutually equivalent characteristics, as viewed from a reference point which is an infinite point. Accordingly, there is the advantage that whichever electrode may be used as a reference electrode (or a signal electrode) (even if a reference electrode and a signal electrode are arranged to be able to be switched therebetween), it is possible to obtain equivalent communication performance.

In other words, there is the advantage that if the signal electrode and the reference electrode are designed to have mutually different sizes, communication can be performed only when one of the electrodes (an electrode which is set as a signal electrode) is moved close to the communication medium.

Shields of circuits will be described below. In the above description, a transmitter section and a receiver section other than electrodes have been regarded as transparent in the consideration of the physical construction of a communication system, but it is actually general that the communication system is constructed by using electronic parts and the like. Electronic parts are made of materials having some electrical nature such as conductivity or dielectricity, and such electronic parts exist near the electrodes and influence the operation of the electrodes. In the embodiment of the present invention, since capacitive couplings and the like in space have various influences, an electronic circuit itself mounted on a circuit board is exposed to such influences. Accordingly, if a far more stable operation is needed, it is desirable to shield the entire circuit with a conductor.

A shielding conductor is generally considered to be connected to a transmission reference electrode or a reception reference electrode which also serves as a reference potential for a transmission or receiver, but if there is no problem in operation, the shielded conductor may be connected to a transmission signal electrode or a reception signal electrode. Since the shielding conductor itself has a physical size, it is necessary to take account of the fact that the shielding conductor operates in mutual relationships to other electrodes, communication media and spaces in accordance with the above-mentioned principles.

FIG. 20 shows an embodiment of a shielding construction. In this embodiment, the device is assumed to operate on a battery, and electronic parts inclusive of the battery are housed in a shield case 571 which also serves as a reference electrode. An electrode 572 is a signal electrode.

Transmission media will be described below. In the above description of the embodiments, reference has been made to conductors as a main example of a communication medium, but a dielectric having no conductivity also enables communication. This is because electric fields injected into the communication medium from a transmission signal electrode are propagated by the polarizing action of the dielectric.

Specifically, a metal such as electric wire is available as a conductor and pure water or the like is available as a dielectric, but a living body, a physiological saline solution or the like having both natures also enable communication. In addition, vacuum and air also have dielectricity and are communicable to serve as a communication medium.

Noise will be described below. In space, potential varies due to various factors such as noise from an AC power-source, noise from a fluorescent lamp, various consumer electrical appliances and electrical equipment, and the influence of charged corpuscles in the air. In the above description, potential variations have been neglected, but these noises penetrate each section of the transmitter, the communication medium and the receiver.

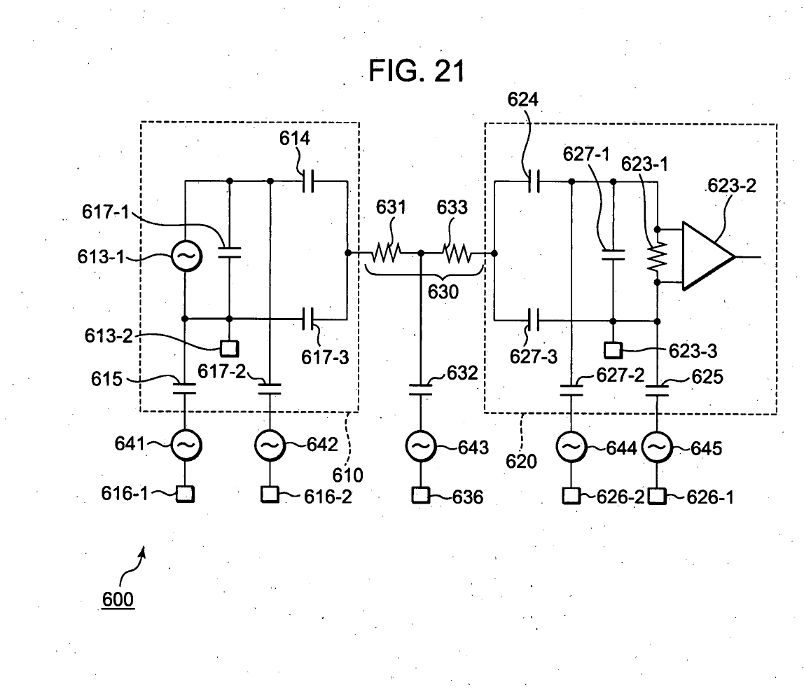

FIG. 21 is a diagram showing an equivalent circuit of the communication system 100 shown in FIG. 1, inclusive of noise components. A communication system 600 shown in FIG. 21 corresponds to the communication system 500 shown in FIG. 9, a transmitter 610 of the communication system 600 corresponds to the transmitter 510 of the communication system 500, a receiver 620 corresponds to the receiver 520, and a connection line 630 corresponds to the connection line 530.

In the transmitter 610, a signal source 613-1, a ground point 613-2, Cte 614, Ctg 615, a ground point 616-1, a ground point 616-2, Ctb 617-1, Cth 617-2 and Cti 617-3 respectively correspond to the signal source 513-1, the ground point 513-2, Cte 514, Ctg 515, the ground point 516-1, the ground point 516-2, Ctb 517-1, Cth 517-2, and Cti 517-3 in the transmitter 510. Unlike the case shown in FIG. 9, in the transmitter 610, two signal sources, i.e., a noise 641 and a noise 642, are respectively provided between Ctg 615 and a ground point 616-1 and between Cth 617-2 and a ground point 616-2.

In the receiver 620, Rr 623-1, a detector 623-2, a ground point 623-3, Cre 624, Crg 625, a ground point 626-1, a ground point 626-2, Crb 627-1, Crh 627-2 and Cri 627-3 respectively correspond to Rr 523-1, the detector 523-2, the ground point 523-3, Cre 524, Crg 525, the ground point 526-1, the ground point 526-2, Crb 527-1, Crh 527-2, and Cri 527-3 in the receiver 520. Unlike the case shown in FIG. 9, in the receiver 620, two signal sources, i.e., a noise 644 and a noise 645, are respectively provided between Crh 627-2 and a ground point 626-2 and between Crg 625 and a ground point 626-1.

Rm 631, Cm 632, Rm 633 and a ground point 636 in the connection line 630 respectively correspond to Rm 531, Cm 532, Rm 533 and the ground point 536 in the connection line 530. Unlike the case shown in FIG. 9, in the connection line 630, a signal source which serves as a noise 643 is provided between Cm 632 and the ground point 636.

Each of the devices operates on the basis of the ground point 613-2 or 623-3 which is the ground potential of itself, so that if noises penetrating the devices have relatively the same components relative to the transmitter, the communication medium and the receiver, such noises have no influence in operation. On the other hand, particularly in a case where the distance between the devices is apart or in an environment where there is an amount of noise, there is a high possibility that a relative difference in noise occurs between the devices; that is to say, the motions of the noises 641 to 645 differ from one another. This difference has no problem if it is not accompanied by a temporal variation, because the relative difference between signal levels to be used need only be transmitted. However, in a case where the variation cycles of the respective noises overlap a frequency band to be used, a frequency and signal levels to be used need be determined to take the characteristics of the noises into account. In other words, if a frequency and signal levels to be used are only determined while taking noise characteristics into account, the communication system 600 can realize communication which has resistance to noise components and is based on only a communication signal transmission path without the need for a physical reference point path. Accordingly, it is possible to provide a communication environment which is not easily restricted by use environments.

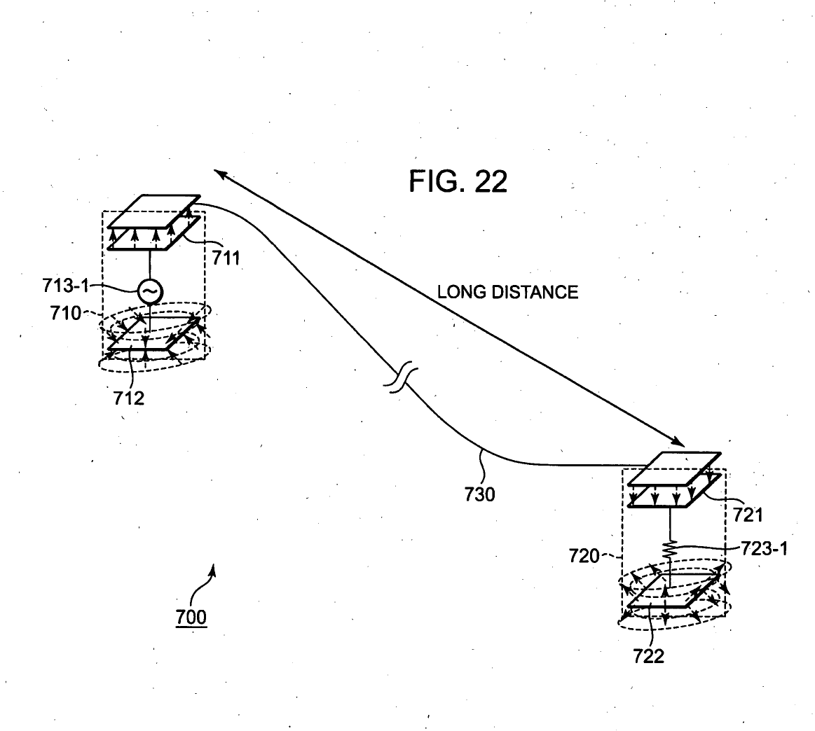

The influence of the magnitude of distance between the transmitter and the receiver on communication will be described below. As mentioned previously, according to the principles of the present invention, if a sufficient capacitance is formed in the space between the transmission reference electrode and the reception reference electrode, communication does not need a path due to the ground near the transmission and receivers or other electrical paths, and does not depend on the distance between the transmission signal electrode and the reception signal electrode. Accordingly, for example, in a communication system 700 shown in FIG. 22, if a transmitter 710 and a receiver 720 are spaced a long distance apart from each other, it is possible to perform communication by capacitively coupling a transmission signal electrode 711 and a reception signal electrode 721 by a communication medium 730 having a sufficient conductivity or dielectricity. At this time, a transmission reference electrode 712 is capacitively coupled to a space outside the transmitter 710, and a reception reference electrode 722 is capacitively coupled to a space outside the receiver 720. Accordingly, the transmission reference electrode 712 and the reception reference electrode 722 need not be capacitively coupled to each other. However, as the communication medium 730 becomes longer or larger, the capacitance of the communication medium 730 to space increases, so that it is necessary to take the capacitance into account when each parameter is to be determined.

The communication system 700 shown in FIG. 22 is a system corresponding to the communication system 100 shown in FIG. 1, and the transmitter 710 corresponds to the transmitter 110, the receiver 720 corresponds to the receiver 120, and the communication medium 730 corresponds to the communication medium 130.

In the transmitter 710, the transmission signal electrode 711, the transmission reference electrode 712 and a signal source 713-1 respectively correspond to the transmission signal electrode 111, the transmission reference electrode 112 and (part of) the transmitter section 113. Similarly, in the transmission reference electrode 712, the reception signal electrode 721, the reception reference electrode 722 and the Rr 723-1 respectively correspond to the reception signal electrode 121, the reception reference electrode 122 and (part of) the receiver section 123.

The description of each of the above-mentioned sections is, therefore, omitted herein.

As mentioned above, the communication system 700 can realize communication which has resistance to noise components and is based on only a communication signal transmission path without the need for a physical reference point path. Accordingly, it is possible to provide a communication environment not restricted by use environments.

In the above description, the transmission signal electrode and the reception signal electrode have been mentioned as being in non-contact with the communication medium, but this construction is not limitative, and as long as a sufficient capacitance can be obtained between each of the transmission reference electrode and the reception reference electrode and the space neighboring the corresponding one of the transmission and receivers, the transmission signal electrode and the reception signal electrode may also be connected to each other by a communication medium having conductivity.

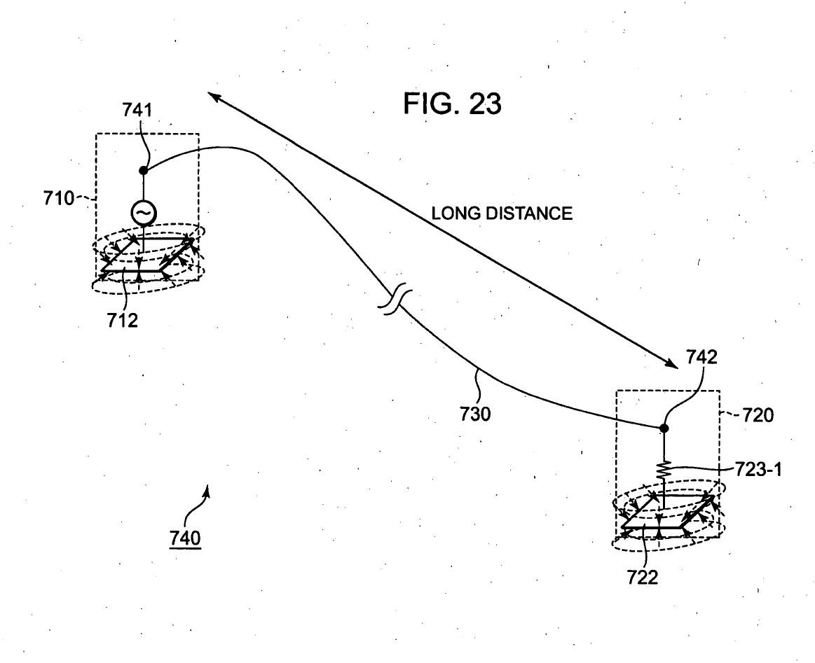

FIG. 23 is a diagram aiding in explaining an example of a communication system in which a transmission reference electrode and a reception reference electrode are connected to each other via a communication medium.

In FIG. 23, a communication system 740 is a system corresponding to the communication system 700 shown in FIG. 22. In the case of the communication system 740, the transmission signal electrode 711 does not exist in the transmitter 710, and the transmitter 710 and the communication medium 730 are connected to each other at a contact 741. Similarly, in the receiver 720 in the communication system 740, the reception signal electrode 721 does not exist, and the receiver 720 and the communication medium 730 are connected to each other at a contact 742.

A general wired communication system includes at least two signal lines and is constructed to perform communication by using the relative difference in level between the signals. On the other hand, in accordance with the present invention, communication can be performed through one signal line.

Namely, the communication system 740 can also realize communication which is based on only a communication signal transmission path without the need for a physical reference point path. Accordingly, it is possible to provide a communication environment which is free from possible limitations of use environments.

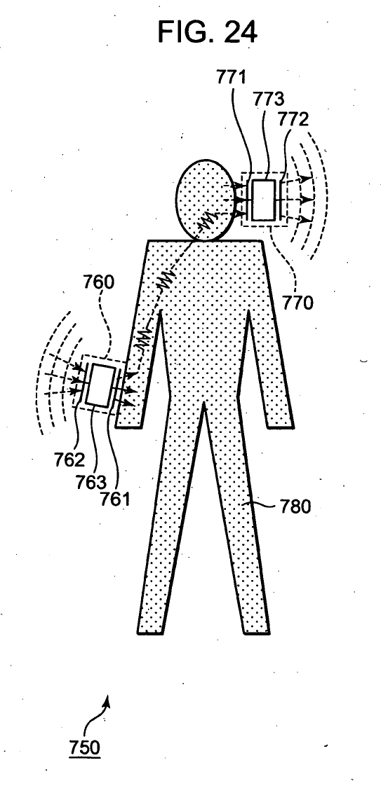

Specific applied examples of the above-mentioned communication system will be described below. The communication system can use, for example, a living body as a communication medium. FIG. 24 is a schematic view showing an example of a communication system which performs communication via a living body. In FIG. 24, a communication system 750 is a system in which music data is transmitted from a transmitter 760 fitted to an arm of the body of a user and the music data is received and converted into sound by a receiver 770 fitted to the head of the body, and the sound is outputted so that the user can listen to the sound. The communication system 750 is a system corresponding to any of the above-mentioned communication systems (for example, the communication system 100), and the transmitter 760 and the receiver 770 correspond to the transmitter 110 and the receiver 120, respectively. In the communication system 750, a body 780 is a communication medium corresponding to the communication medium 130 shown in FIG. 1.

Namely, the transmitter 760 has a transmission signal electrode 761, a transmission reference electrode 762, and a transmitter section 763 which respectively correspond to the transmission signal electrode 111, the transmission reference electrode 112 and the transmitter section 113 shown in FIG. 1. The receiver 770 has a reception signal electrode 771, a reception reference electrode 772, and a receiver section 773 which respectively correspond to the reception signal electrode 121, the reception reference electrode 122 and the receiver section 123 shown in FIG. 1.

Accordingly, the transmitter 760 and the receiver 770 are arranged so that the transmission signal electrode 761 and the reception signal electrode 771 are brought into contact with or into close proximity to the body 780 which is a communication medium. Since the transmission reference electrode 762 and the reception reference electrode 772 may be in contact with space, there is no need for coupling to the ground around the devices nor for mutual coupling of the transmission and receivers (or electrodes).

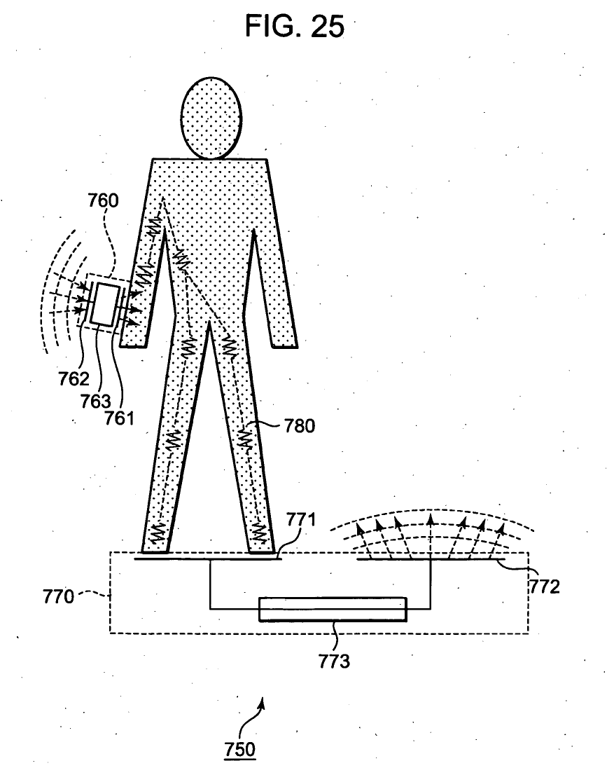

FIG. 25 is a schematic view aiding in explaining another example which realizes the communication system 750. In FIG. 25, the receiver 770 is brought into contact with (or close proximity to) the soles of the body 780 and performs communication with the transmitter 760 fitted to an arm of the body 780. In this case well, the transmission signal electrode 761 and the reception signal electrode 771 are provided so as to be brought into contact with (or into close proximity to) the body 780 which is a communication medium, and the transmission reference electrode 762 and the reception reference electrode 772 are provided to face space. The example shown in FIG. 25 is particularly an applied example which could not have been realized by a prior art using the ground as one of communication media.

Namely, the above-mentioned communication system 750 can realize communication which is based on only a communication signal transmission path without the need for a physical reference point path. Accordingly, it is possible to provide a communication environment which is not restricted by use environments.

In each of the above-mentioned communication systems, the method of modulating signals to be transmitted through the communication medium is not limited to a particular method, and it is possible to select any optimum method on the basis of the characteristics of the entire communication system as long as the method can cope with both the transmitter section and the receiver. Specifically, as a modulation method, it is possible use any one of a baseband analog signal, an amplitude-modulated analog signal, a frequency-modulated analog signal and a baseband digital signal, or any one of an amplitude-modulated digital signal, a frequency-modulated digital sound and a phase-modulated digital signal, or a combination of a plurality of signals selected from among those signals.

In addition, each of the above-mentioned communication systems may be constructed to use one communication medium to establish a plurality of communications so that the communication system can execute communications such as full-duplex communication and communication between a plurality of devices through a single communication medium.

Examples of techniques for realizing such multiplex communications will be described below. The first technique is a technique using spread spectrum communication. In this case, a frequency bandwidth and a particular time series code are decided on between a transmitter and a receiver in advance. The transmitter varies the frequency of an original signal and spreads the original signal within the frequency bandwidth on the basis of the time series code, and transmits spread components. After having received the spread components, the receiver decodes the received signal by integrating the received signal.

Advantages obtainable by frequency spread will be described below. According to the Shannon-Hartley channel capacity theorem, the following formula is established:

$$\begin{matrix}[ Formula 23 ] & \\ C = B \times {log}_{2} ( 1 + \frac{S}{N} ) [ bps ] & ( 23 )\end{matrix}$$

In formula (23), C [bps] denotes a channel capacity which indicates a theoretically maximum data rate which can be transmitted in a communication path. B [Hz] denotes a channel bandwidth. S/N denotes a signal-to-noise-power ratio (SN ratio). In addition, if the above formula (23) is Maclaurin-expanded to decrease the S/N ratio, the above formula (23) can be approximated by the following formula (24):

$$\begin{matrix}[ Formula 24 ] & \\ C \approx \frac{S}{N} \times B [ bps ] & ( 24 )\end{matrix}$$

Accordingly, if S/N is not higher than, for example, a noise floor level, S/N<<1 is obtained, but the channel capacity C can be raised to a desired level by widening the channel bandwidth B.

If different time series codes are prepared for different communication paths so that frequency spreading is performed on the communication paths in different manners, their frequencies are spread without mutual interference, so that mutual interference can be suppressed to effect a plurality of communications at the same time.

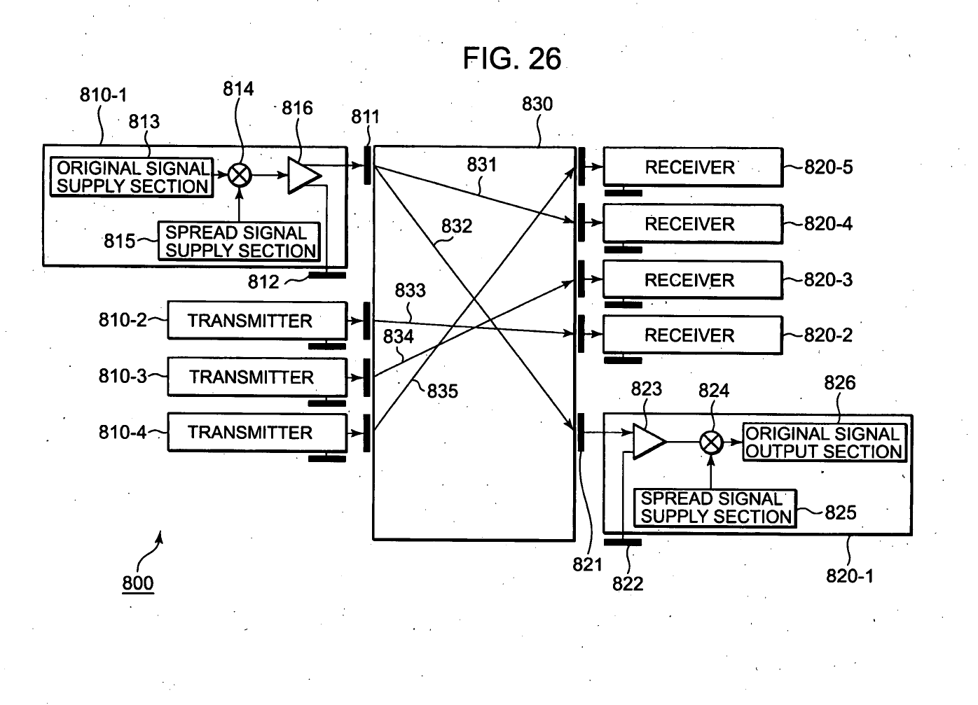

FIG. 26 is a diagram showing another construction example of the communication system which underlies the present invention. In a communication system 800 shown in FIG. 26, four transmitters 810-1 to 810-4 and five receivers 820-1 to 820-5 perform multiplex communications via a communication medium 830 by using a spread spectrum technique.

The transmitter 810-1 corresponds to the transmitter 110 shown in FIG. 1 and has a transmission signal electrode 811 and a transmission reference electrode 812, and further has, as a construction corresponding to the transmitter section 113, an original signal supply section 813, a multiplier 814, a spread signal supply section 815, and an amplifier 816.

The original signal supply section 813 generates an original signal which is a signal before the frequencies are spread, and supplies the signal to the multiplier 814. The spread signal supply section 815 generates a spread signal which spreads the frequencies, and supplies the spread signal to the multiplier 814. There are two representative spread techniques using spread signals, a direct sequence technique (hereinafter referred to as the DS technique) and a frequency hopping technique (hereinafter referred to as the FH technique). The DS technique is a technique which causes the multiplier 814 to perform multiplication on the time series code having a frequency component higher than at least the original signal. The result of the multiplication is carried on a predetermined carrier, and is outputted from the amplifier 816 after having been amplified by the same.

The FH technique is a technique which varies the frequency of a carrier by the time series code and generates a spread signal. The spread signal is multiplied by an original signal by the multiplier 814, and the multiplication result is outputted from the amplifier 816 after having been amplified by the same. One of the outputs of the amplifier 816 is connected to the transmission signal electrode 811, while the other is connected to the transmission reference electrode 812.

Each of the transmitters 810-2 to 810-4 is similar in construction to the transmitter 810-1, and since the description of the transmitter 810-1 is applicable, the repetition of the same description will be omitted.

The receiver 820-1 corresponds to the receiver 120 shown in FIG. 1, and has a reception signal electrode 821 and a reception reference electrode 822 and further has, as a construction corresponding to the receiver section 123, an amplifier 823, a multiplier 824, a spread signal supply section 825 and an original signal output section 826.

After the receiver 820-1 has first restored an electrical signal on the basis of the method according to the present invention, the receiver 820-1 restores the original signal (a signal supplied from the original signal supply section 813) by the signal processing opposite to that of the transmitter 810-1.

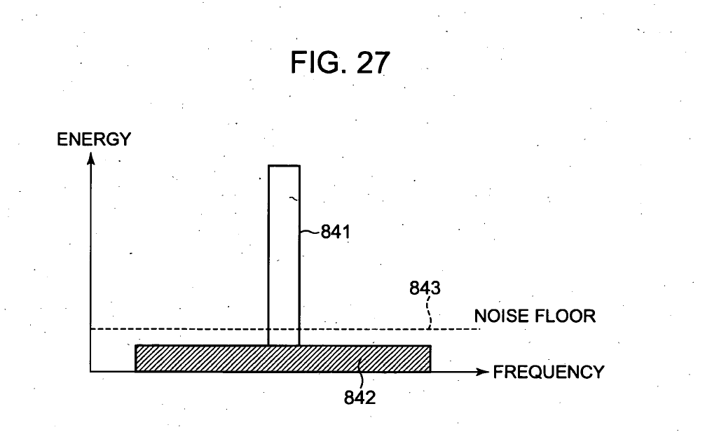

FIG. 27 shows a frequency spectrum due to such technique. The horizontal axis represents frequency, while the vertical axis represents energy. A spectrum 841 is a spectrum due to a technique based on a fixed frequency, and energy is concentrated at a particular frequency. This technique may not restore the signal if energy falls below a noise floor 843. On the other hand, a spectrum 842 is a spectrum based on a spread spectrum technique, and energy is spread over a wide frequency bandwidth. Since the area of the shown rectangle of the spectrum 842 can be regarded as denoting the total energy, the signal of the spectrum 842, although each frequency component thereof is below the noise floor 843, can be restored into the original signal by energy being integrated over the entire frequency bandwidth, so that communication can be performed.

By performing communication using the above-mentioned spread spectrum technique, the communication system 800 can perform simultaneous communications by using the same communication medium 830, as shown in FIG. 26. In FIG. 26, paths 831 to 835 denote communication paths on the communication medium 830. In addition, the communication system 800 can perform multiple-to-one communication as shown by the paths 831 and 832 as well as multiple-to-multiple communication by using the spread spectrum technique.

The second technique is a technique which causes a transmitter and a receiver to mutually decide on a frequency bandwidth and applies a frequency division technique for dividing the frequency bandwidth into a plurality of bands. In this case, the transmitter (or the receiver) performs allocation of a frequency band in accordance with particular rules of frequency allocation, or detects an idle frequency band at the time of start of communication and performs allocation of a frequency band on the basis of the detection result.

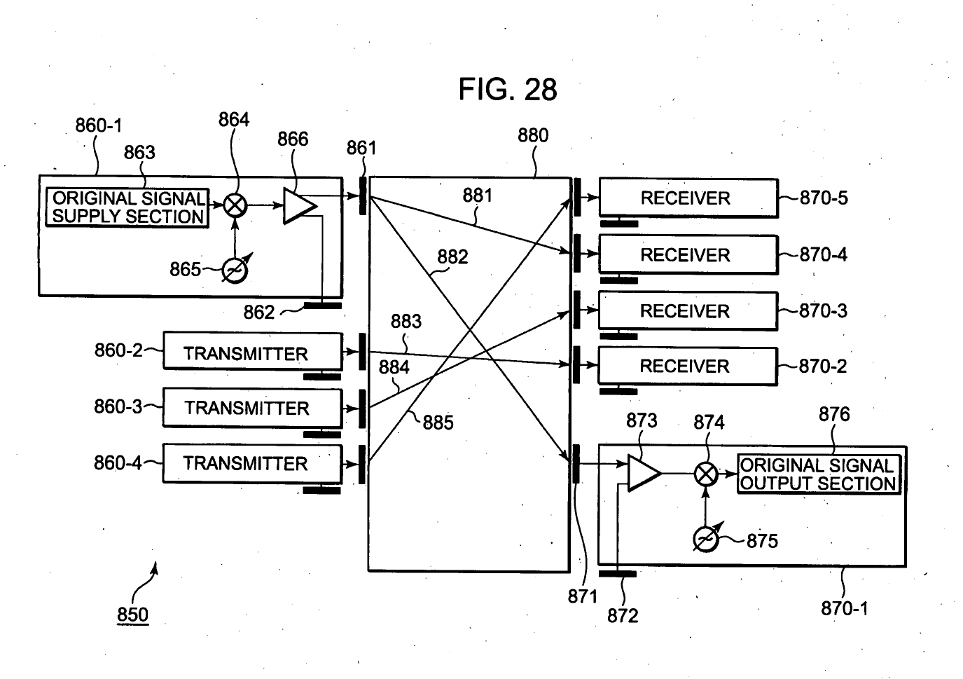

FIG. 28 is a diagram showing another construction example of the communication system which underlies the present invention. In a communication system 850 shown in FIG. 28, four transmitters 860-1 to 860-4 and five receivers 870-1 to 870-5 perform multiplex communications via a communication medium 880 by using a frequency division technique.

The transmitter 860-1 corresponds to the transmitter 110 shown in FIG. 1 and has a transmission signal electrode 861 and a transmission reference electrode 862, and further has, as a construction corresponding to the transmitter section 113, an original signal supply section 863, a multiplier 864, a frequency variable type oscillation source 865, and an amplifier 866.

An oscillation signal having a particular frequency component generated by the frequency variable type oscillation source 865 is multiplied by an original signal supplied from the original signal supply section 863, in the multiplier 864, and is outputted from the amplifier 866 after having been amplified in the same (it is assumed that filtering is appropriately performed). One of the outputs of the amplifier 866 is connected to the transmission signal electrode 861, while the other is connected to the transmission reference electrode 862.

Each of the transmitters 860-2 to 860-4 is similar in construction to the transmitter 860-1, and since the description of the transmitter 860-1 is applicable, the repetition of the same description will be omitted.

The receiver 870-1 corresponds to the receiver 120 shown in FIG. 1, and has a reception signal electrode 871 and a reception reference electrode 872 and further has, as a construction corresponding to the receiver section 123, an amplifier 873, a multiplier 874, a frequency variable type oscillation source 875 and an original signal output section 876.

After the receiver 870-1 has first restored an electrical signal on the basis of the method according to the present invention, the receiver 870-1 restores the original signal (a signal supplied from the original signal supply section 863) by the signal processing opposite to that of the transmitter 860-1.

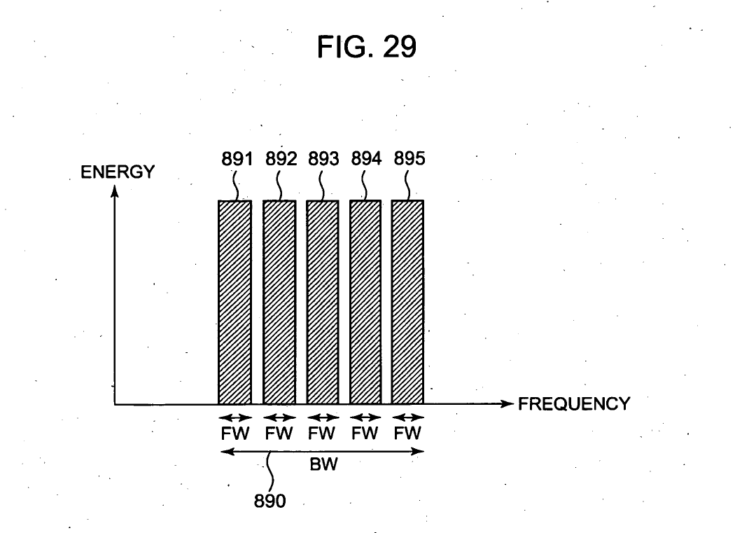

FIG. 29 shows an example of a frequency spectrum due to such technique. The horizontal axis represents frequency, while the vertical axis represents energy. For convenience of explanation, FIG. 29 shows an example in which an entire frequency bandwidth (BW) 890 is divided into five bandwidths (FW) 891 to 895. The divided frequency bandwidths are respectively used for communications on different communication paths. Namely, the transmitters 860-1 to 860-4 (the receivers 870-1 to 870-5) of the communication system 800 can perform a plurality of communications at the same time via the single communication medium 880 as shown in FIG. 28 while suppressing mutual interference by using the different frequency bands on the respective communication paths. In FIG. 28, paths 881 to 885 represent the respective communication paths on the communication medium 880. In addition, the communication system 850 can perform multiple-to-one communication as shown by the paths 881 and 882 as well as multiple-to-multiple communication by using the frequency division technique.

The communication system 850 (the transmitters 860-1 to 860-4 or the receivers 870-1 to 870-5) has been described above as being divided into the five bandwidths 891 to 895, but the number of division may be arbitrary and the sizes of the respective bandwidths may be made different from one another.

The third technique is a technique which applies a time division technique which causes a transmitter and receiver to mutually divide communication time therebetween. In this case, the transmitter (or the receiver) performs division of communication time in accordance with particular rules of time division, or detects an idle time zone at the time of start of communication and performs division of communication time on the basis of the detection result.

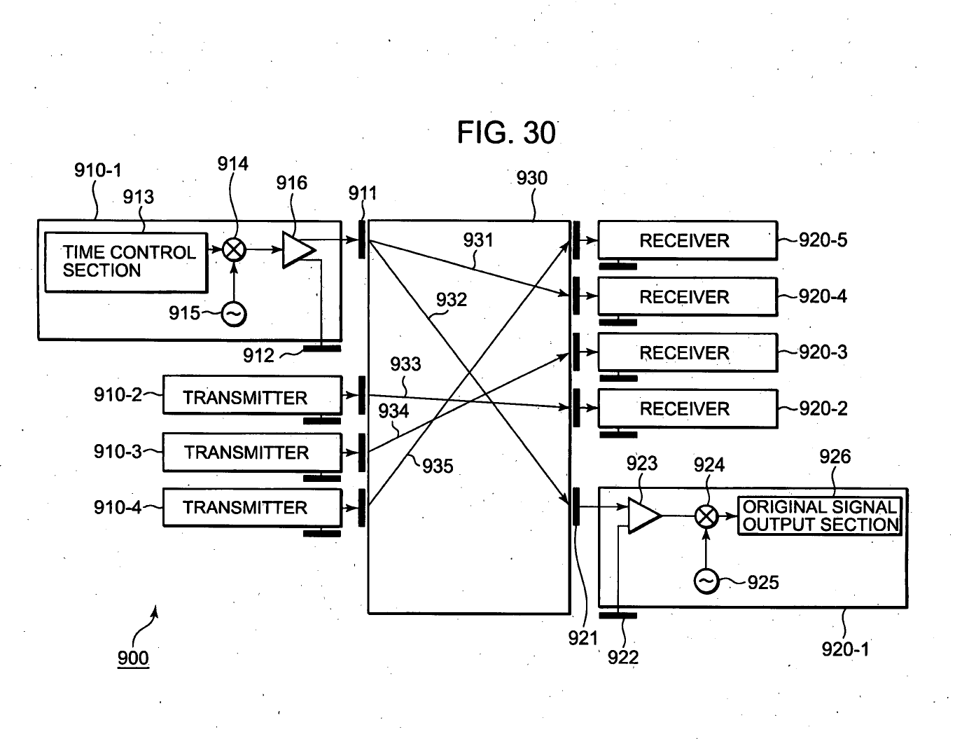

FIG. 30 is a diagram showing another construction example of the communication system which underlies the present invention. In a communication system 900 shown in FIG. 30, four transmitters 910-1 to 910-4 and five receivers 920-1 to 920-5 perform multiplex communications via a communication medium 930 by using a time division technique.

The transmitter 910-1 corresponds to the transmitter 110 shown in FIG. 1 and has a transmission signal electrode 911 and a transmission reference electrode 912, and further has, as a construction corresponding to the transmitter section 113, a time control section 913, a multiplier 914, an oscillation source 915, and an amplifier 916.

An original signal is outputted by the time control section 913 at a predetermined time. The multiplier 914 multiplies the original signal by an oscillation signal supplied from the oscillation source 915, and the multiplication result is outputted from the amplifier 916 after having been amplified by the same (it is assumed that filtering is appropriately performed). One of the outputs of the amplifier 916 is connected to the transmission signal electrode 911, while the other is connected to the transmission reference electrode 912.

Each of the transmitters 910-2 to 910-4 is similar in construction to the transmitter 910-1, and since the description of the transmitter 910-1 is applicable, the repetition of the same description will be omitted.

The receiver 920-1 corresponds to the receiver 120 shown in FIG. 1, and has a reception signal electrode 921 and a reception reference electrode 922 and further has, as a construction corresponding to the receiver section 123, an amplifier 923, a multiplier 924, an oscillation source 925 and an original signal output section 926.

After the receiver 920-1 has first restored an electrical signal on the basis of the method according to the present invention, the receiver 920-1 restores the original signal (a signal supplied from the time control section 913) by the signal processing opposite to that of the transmitter 920-1.

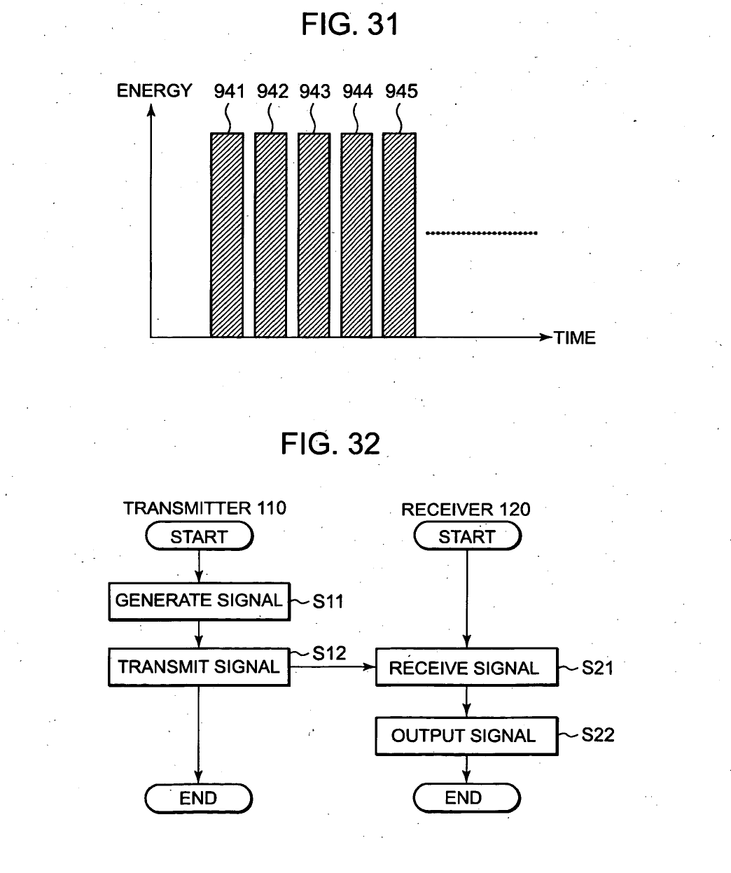

FIG. 31 shows an example of a frequency spectrum due to such technique, plotted along the time axis. The horizontal axis represents time, while the vertical axis represents energy. For convenience of explanation, FIG. 31 shows five time zones 941 to 945, but actually, time continues after the time zone 945 in a similar manner. The divided time zones are respectively used for communications on different communication paths. Namely, the transmitters 910-1 to 910-4 (the receivers 920-1 to 920-5) of the communication system 900 can perform a plurality of communications at the same time via the single communication medium 900 as shown in FIG. 30 while suppressing mutual interference by performing communications on the respective communication paths during different time zones. In FIG. 30, paths 931 to 935 represent the respective communication paths on the communication medium 930. In addition, the communication system 900 can perform multiple-to-one communication as shown by the paths 931 and 932 as well as multiple-to-multiple communication by using the time division technique.

In addition, the communication system 900 (the transmitter 910 or the receiver 920) may also be constructed so as to make the time widths of the respective time zones different from one another.

Furthermore, in addition to the above-mentioned methods, at least two of the first to third communication techniques may also be combined.

It is particularly important in particular applications that a transmitter and a receiver can perform a plurality of other devices at the same time. For example, on the assumption that this construction is applied to transportation tickets, it is possible to use the construction in useful applications in which when a user who possesses both a device A having information on a commutation ticket and a device B having an electronic money function passes through an automatic ticket gate, if, for example, a section through which the user has passed contains a section not covered by the commutation ticket, a deficiency is subtracted from the electronic money of the device B by the automatic ticket gate communicating with the device A and the device B at the same time by using any of the above-mentioned techniques.

The flow of communication processing executed during the communication between the transmitter and the receiver will be described below on the basis of the flowchart shown in FIG. 32 with illustrative reference to the case of communication between the transmitter 110 and the receiver 120 of the communication system 100 shown in FIG. 1.

In step S11, the transmitter section 113 of the transmitter 110 generates a signal to be transmitted, in step S11, and in step S12, the transmitter 110 transmits the generated signal to the communication medium 130 via the transmission signal electrode 111. When the signal is transmitted, the transmitter section 113 of the transmitter 110 completes communication processing. The signal transmitted from the transmitter 110 is supplied to the receiver 120 via the communication medium 130. In step S21, the receiver section 123 of the receiver 120 receives the signal via the reception-signal electrode 121, and in step S22 outputs the received signal. The receiver section 123 which has outputted the received signal completes communication processing.

As mentioned above, the transmitter 110 and the receiver 120 do not need a closed circuit using reference electrodes and can easily perform stable communication processing without being influenced by environments, merely by performing transmission and reception via the signal electrodes. In addition, since the structure of communication processing is simplified, the communication system 100 can use various communication techniques such as modulation, encoding, encryption and multiplexing at the same time.

In the description of each of the communication systems, the transmitter and the receiver have been described as being constructed as separated devices, but the present invention is not limited to this construction and a communication system may be constructed by using a transmitter/receiver having the functions of both the transmitter and the receiver.

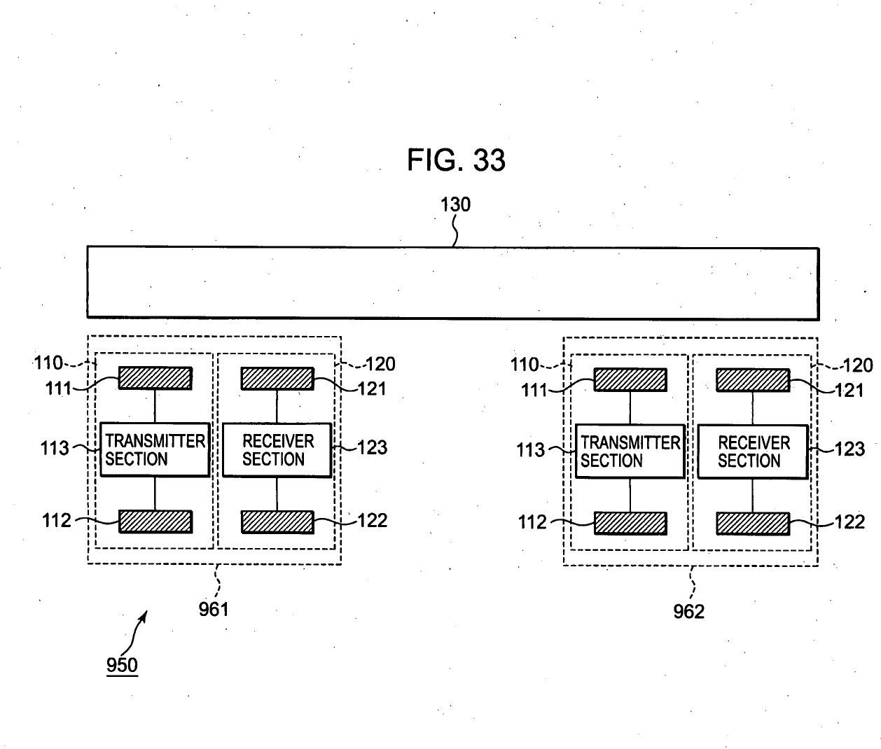

FIG. 33 is a diagram showing another construction example of the communication system which underlies the present invention.

In FIG. 33, a communication system 950 has a transmitter/receiver 961, a transmitter/receiver 962, and the communication medium 130. The communication system 950 is a system which the transmitter/receiver 961 and the transmitter/receiver 962 perform bi-directional transmission and reception of signals via the communication medium 130.

The transmitter/receiver 961 has a transmitter section 110 having a construction similar to the transmitter 110 shown in FIG. 1, and a receiver section 120 having a construction similar to the receiver 120 shown in FIG. 1. Namely, the transmitter/receiver 961 has the transmission signal electrode 111, the transmission reference electrode 112, the transmitter section 113, the reception signal electrode 121, the reception reference electrode 122 and the receiver section 123.

Namely, the transmitter/receiver 961 transmits a signal via the communication medium 130 by using the transmitter section 110, and receives a signal supplied via the communication medium 130, by using the receiver section 120. As describe above, the communication system according to an example of the present invention, is able to perform multiplex communications. The transmitter/receiver 961 may be constructed so that the communication by the transmitter section 110 and the communication by the receiver section 120 are performed simultaneously (at the duplicated times).

Since the transmitter/receiver 962 has a construction similar to the transmitter/receiver 961 and operates in a similar manner, the description of the transmitter/receiver 962 will be omitted. The transmitter/receiver 961 and the transmitter/receiver 962 perform bi-directional communications via the communication medium 130 by the same method.

In this manner, the communication system 950 (the transmitter/receiver 961 and the transmitter/receiver 962) can easily realize bi-directional communications not restricted by use environments.

Similar to the transmission apparatus and reception apparatus described with reference to FIG. 23, the transmission signal electrode and reception signal electrode of the transmission/reception apparatus 961 and transmission/reception apparatus 962 may be electrically connected to the communication medium (provided as the contact 741 of 742). In the above description, although the transmission signal electrode 111, transmission reference electrode 112, reception signal electrode 121 and reception reference electrode 122 are structured separately, the embodiment is not limited to this structure. For example, the transmission signal electrode 111 and reception signal electrode 121 may be structured as one electrode, and the transmission reference electrode 112 and reception reference electrode 122 may be structured as one electrode (the transmission section 113 and reception section 123 share the signal electrode or reference electrode)

In the above description, in each apparatus (transmission apparatus, reception apparatus and communication apparatus) of the communication system of the present invention, although the reference potential of each apparatus is connected to the reference electrode, the embodiment is not limited to this structure. For example, a differential circuit operating with two signals having different phases may be used. In this case, one signal of the differential circuit is connected to the signal electrode to transmit the signal to the communication medium, and the other signal of the differential circuit is connected to the reference electrode. Also, in this manner, information can be transmitted.

Next, a communication system adopting the present invention will be described. FIG. 34 is a diagram showing an example of the structure of a communication system according to an embodiment adopting the present invention.

A communication system 1000 shown in FIG. 34 is a communication system for performing communications via a human body, and is not necessary to configure the closed circuit by using the reference electrode. This communication system can execute a stable communication process easily without being influenced by environments, only by transmission/reception of a signal via the signal electrode.

The communication system 1000 shown in FIG. 34 has a reader/writer 1001 and user devices (hereinafter called UD) 1002 to 1004. The reader/writer 1001 communicates with UDs 1002 to 1004 via a communication medium made of a conductor or a dielectric such as a human body.

The reader/writer 1001 has a communication section 1011 for executing processes regarding communications, a reference electrode 1012 and a signal electrode 1013 for transmission/reception of a signal and a service provision section 1014 for executing processes regarding services to be provided to users having UDs. This communication system 1000 is a communication system for performing communications by a method similar to that of the communication system 100 shown in FIG. 1. The communication section 1011 corresponds, for example, to the transmission section 113 and reception section 123, the reference electrode 1012 corresponds, for example, to the transmission reference electrode 112 and reception reference electrode 122, and the signal electrode 1013 corresponds, for example, to the transmission signal electrode 111 and reception signal electrode 121. Namely, an electrostatic capacitance formed between the signal electrode 1013 and communication medium is larger than that formed between the reference electrode 1012 and communication medium.

In FIG. 34, UD 1002 is owned by a user 1021, UD 1003 is owned by a user 1022, and UD 1004 is owned by a user 1023. UDs 1002 to 1004 are devices for communicating with the reader/writer 1001 by a method similar to that of the communication system 100 shown in FIG. 1.

A communications section 1011 of a reader/writer 1001 performs communications with UDs 1002 through 1004 via the bodies of users 1021 through 1023 that are positioned above a signal electrode 1013 that is provided on the floor. The UDs 1002 through 1004 each have unique identification information, and the communications section 1011 identifies the communications partner (a partner to and from which signals are transmitted and received) through the identification information thereof. In FIG. 34, the identification information of the UD 1002 is “ID1,” the identification information of the UD 1003 is “ID2,” and the identification information of the UD 1004 is “ID3.” The content of the identification information may be of any format so long as the value is unique to each device, and the bit count is also arbitrary.

A service providing section 1014 controls the communications section 1011, and provides a predetermined service, such as ride fare transactions, merchandise purchases, personal verification and so forth, to the users 1021 through 1023 above the signal electrode 1013 by having the communications section 1011 perform communications with the UDs 1002 through 1004.

In FIG. 34, although the system is configured by a single reader/writer and three UDs, the numbers of these devices are arbitrary. The numbers and sizes of the reference electrodes 1012 and signal electrodes 1013 are also arbitrary. In the communication system, one user may have a plurality of UDs or a plurality of users may share a single UD. However, for example, if the relation between the numbers and positions of UDs and users violates rules of the services provided by the service provision section 1014, the services may not be provided.

As described above, the reader/writer 1001 independently performs communications and provides services with and to each of the UDs 1002 through 1004 using their identification information, but in order to do so, it is first necessary to identify UDs that exist within a range where services can be provided. Therefore, in order to perform communications with UDs, the communications section 1011 of the reader/writer 1001 must first search for UDs (acquire the identification information of UDs) that are currently in a state in which communications are possible. Then, the communications section 1011 of the reader/writer 1001 performs a verification process for the acquired identification information, identifies the UD that is to be the subject of an application process that provides the service, and performs the application process with respect to the identified UD using the service providing section 1014. If the application process is successful, the communications process is terminated, and if the application process fails, processes such as the acquisition of identification information and the like are repeated with respect to some other UD.

Next, specific configurations of each device will be described.

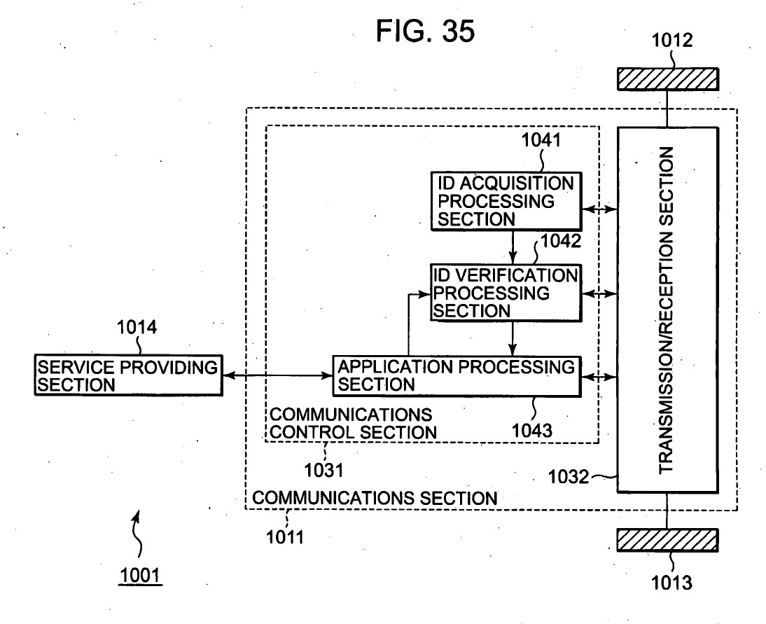

FIG. 35 is a block diagram illustrating an internal configuration example of the reader/writer 1001 in FIG. 34.

In FIG. 35, the communications section 1011 of the reader/writer 1001 includes a communications control section 1031 that performs a communications control process, and a transmission/reception section 1032 which is connected to a reference electrode 1012 and the signal electrode 1013 and which transmits and receives signals via the signal electrode 1013. The communications control section 1031 controls the transmission and reception of signals by the transmission/reception section 1032, and makes it perform communications with the UDs 1002 through 1004.

The communications control section 1031 includes an ID acquisition processing section 1041, an ID verification processing section 1042, and an application processing section 1043. The ID acquisition processing section 1041 performs a process related to the acquisition of the identification information (ID) of a communicable UD. The ID verification processing section 1042 performs a verification process of the ID acquired by the ID acquisition processing section 1041, and identifies the UD that is to be a communications partner. The application processing section 1043 performs, with respect to the UD corresponding to the ID that the ID verification processing section 1042 verified, a communications process related to a service that the service providing section 1014 provides, instructs processes, handles data and so forth.

FIG. 36 is a block diagram illustrating an internal configuration example of the UD 1002 in FIG. 34.

In FIG. 36, the UD 1002 includes a communications section 1051 that performs a process related to communications, a reference electrode 1052 and a signal electrode 1053 for transmitting and receiving signals, and a service processing section 1054 that performs a process related to the service provided by the reader/writer 1001.

The communications section 1051 corresponds to, for example, the transmission section 113 and the reception section 123 in FIG. 1, the reference electrode 1052 corresponds to, for example, the transmission reference electrode 112 and the reception reference electrode 122 in FIG. 1, and the signal electrode 1053 corresponds to, for example, the transmission signal electrode 111 and the reception signal electrode 121 in FIG. 1. In other words, the capacitance formed between the signal electrode 1053 and a communications medium is greater in relation to the capacitance formed between the reference electrode 1052 and the communications medium.

The communications section 1051 includes a communications control section 1061 that performs a communications control process, a transmission/reception section 1062 that is connected to the reference electrode 1052 and the signal electrode 1053 and which transmits and receives signals via the signal electrode 1053, and a timer 1063 that provides time information to each section of the communications control section 1061. Based on the time information supplied from the timer 1063, the communications control section 1061 controls the transmission and reception of signals by the transmission/reception section 1062, and communications with the reader/writer 1001 is thereby performed.

The communications control section 1061 includes an ID request response section 1071, an ID verification response section 1072, an application processing response section 1073, a studying section 1074, and a priority information retaining section 1075.

The ID request response section 1071 controls the communications process with respect to an ID request, which is request information that requests an ID and is supplied from the reader/writer 1001. The ID verification response section 1072 controls the communications process related to a verification process for the ID of a UD that is to be the subject of service provision. The application processing response section 1073 controls a process related to communications of a response process of the service processing section 1054 with respect to the process related to the provision of service from the reader/writer 1001.

In other words, the application processing response section 1073 performs a process corresponding to the process by the application processing section 1043 in FIG. 35. The studying section 1074 studies whether or not to prioritize communications with the UD 1002 based on the success/failure tendencies of application processing by the application processing response section 1073. In other words, based on the application processing results, the studying section 1074 sets the priority of communications with the UD 1002 during predetermined time periods, and generates time-sorted priority information, which will be described later. The studying section 1074 supplies this time-sorted priority information to the priority information retaining section 1075. The priority information retaining section 1075 includes a recording medium such as, for example, RAM (Random Access Memory), flash memory, a hard disk or the like, and retains information that indicates the priority of communications with the UD 1002, in other words, information that controls the method of assigning various time slots for outputting an ID (which corresponds to time-sorted priority information 1075A in the case of FIG. 35). Based on a request from an output TS control section 1082, which will be described later, the priority information retaining section 1075 supplies the priority information (which corresponds to the time-sorted priority information 1075A in the case of FIG. 35) to the output TS control section 1082.

The ID request response section 1071 includes an ID request acquisition section 1081, the output TS control section 1082, and an ID reply supplying section 1083.

Via the transmission/reception section 1062, the ID request acquisition section 1081 acquires an ID request that is transmitted from the reader/writer 1001, and supplies it to the output TS control section 1082. The output TS control section 1082 specifies (controls) the time slot (TS) during which the ID is to be outputted. In so doing, the output TS control section 1082 acquires the time-sorted priority information 1075A that is retained by the priority information retaining section 1075, and refers to it. Once the time slot (TS) during which the ID is to be outputted is specified, the output TS control section 1082 supplies that information to the ID reply supplying section 1083. During the time slot specified by the output TS control section 1082, the ID reply supplying section 1083 controls the transmission/reception section 1062, and transmits the ID of the UD 1002 to the reader/writer 1001 as an ID response.

In other words, the time-sorted priority information 1075A is the study result of the studying section 1074 having studied the time period in which the service that the UD 1002 supports is provided. For example, the UD 1002 may be a device that is used as a commuter pass for trains, and may be frequently used in the morning and evening on weekdays. In other words, when the UD 1002 performs communications with the reader/writer 1001 during the morning/evening time periods on weekdays, there is a high probability that that reader/writer 1001 is a reader/writer that is provided at an automatic ticket gate at a train station (and that the user 1021 of the UD 1002 has passed through an automatic ticket gate). In other words, there is a high probability that the UD 1002 successfully performs an application process during the morning/evening time periods on weekdays.

By identifying the time periods during which the application process is successfully performed, the studying section 1074 of the UD 1002 studies the fact that the application process tends to be performed successfully during the morning/evening time periods on weekdays, and creates the time-sorted priority information 1075A in such a manner that the priority during those time periods is raised.

Based on this time-sorted priority information 1075A, the output TS control section 1082 configures itself in such a manner that the ID is transmitted in an earlier time slot only during the morning/evening time periods on weekdays, and that the ID is transmitted in a later time slot during any other time slot.

Thus, the UD 1002 will supply the ID to the reader/writer 1001 before other UDs only during the morning/evening time periods on weekdays and have the application process performed. On the other hand, the UD 1002 will let other UDs have priority during other time periods.

In other words, by having the studying section 1074 study the success/failure of the application process and generate the time-sorted priority information 1075A, and having the output TS control section 1082 control the timing for outputting the ID based on the time-sorted priority information 1075A, the UD 1002 is able to learn usage trends during each time period (what services at what time are likely to be used) by the user 1021, and is able to control the priority of ID output based on those trends. Therefore, even in cases where a plurality of UDs exist, the UD that has a high probability of successfully performing the application process (the UD that is likely to support the service provided by the reader/writer 1001), depending on the time period, is able to have priority in supplying its ID to the reader/writer 1001.

The likelihood of application process failures can thus be suppressed, as a result of which the UD 1002 (a communications system 1000) is able to enhance the efficiency of communications processing and suppress a decrease in speed.

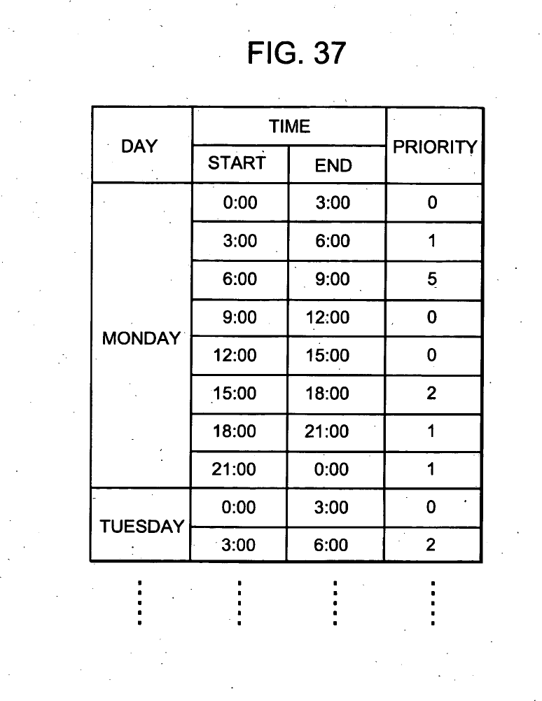

FIG. 37 is a schematic diagram indicating a configuration example of the time-sorted priority information 1075A.

As shown in FIG. 37, the time-sorted priority information 1075A is information that indicates the priority of ID transmission for that UD during each predetermined time period. For example, in the case shown in FIG. 37, a week, from Monday to Sunday, is divided into fifty-six time periods of three hours each, and for each time period there is assigned a priority. Here, priority is information that indicates whether or not to assign the ID transmission for that UD to an earlier time slot or a later time slot.

Values for this priority are arbitrary, and may be an integer, as shown in FIG. 37, or they may be fractions, decimals, or percentages (ratios). In addition, this priority may be any kind of parameter, and may, for example, indicate higher priority (earlier time slot) the greater the value of priority, or indicate higher priority (earlier time slot) the smaller the value of priority. In addition, the value of priority may indicate the number of the time slot to which ID transmission is to be assigned, or the value of priority may be the probability (weighting) with which ID transmission is assigned to each time slot.

For example, assuming the number of time slots is four, and the random value generated is two bits (in other words, a value of “0” to “3”), a device whose value of priority is small (a device which has lower priority) has its upper bit fixed at “1,” and a device whose value of priority is high has its upper bit fixed at “0.” Thus, devices whose priority is low will only generate a random number of 2 or 3, while devices whose priority is high will only generate a random number of 0 or 1. In other words, devices with higher priority are assigned to earlier time slots. By being arranged in such a manner, the communications system 1000 (or each of its devices) is able to bias the random numbers that are generated in accordance with priority.

In addition, for example, in order for the output TS control section 1082 to output a value between “0” and “3” as a random number value, a value between “0” and “1” may first be obtained randomly, the values that are to be outputted as the random number value (values “0” to “3”) may be assigned to the obtained value, and a weighting process in that assignment process may be performed by the output TS control section 1082 in accordance with the priority.

More specifically, in a state where no weighting is performed, the output TS control section 1082 assigns a value of “0” to the random number value to be outputted when the value that is randomly obtained is between “0” and “0.25,” assigns a value of “1” to the random number value to be outputted when the value that is randomly obtained is between “0.25” and “0.5,” assigns a value of “2” to the random number value to be outputted when the value that is randomly obtained is between “0.5” and “0.75,” and assigns a value of “3” to the random number value to be outputted when the value that is randomly obtained is between “0.75” and “1.”

Then, if the priority is high, for example, the output TS control section 1082 performs weighting based on that priority, assigns a value of “0” to the random number value to be outputted when the value that is randomly obtained is between “0” and “0.5,” assigns a value of “1” to the random number value to be outputted when the value that is randomly obtained is between “0.5” and “0.75,” assigns a value of “2” to the random number value to be outputted when the value that is randomly obtained is between “0.75” and “0.9,” and assigns a value of “3” to the random number value to be outputted when the value that is randomly obtained is between “0.9” and “1.”

By being arranged in such a manner, the communications system 1000 (or each of its devices) is able to alter (control) the likelihood of occurrence of each value of the random number value.

It is noted that the time periods indicated in FIG. 37 are merely examples, and time periods are not limited thereto. For example, priority may be assigned for each hour, and the entire scale may be a month instead of just a week (the priority information may be on a monthly cycle), and each time period does not have to be uniform in length, and instead may be such that some time periods are longer or shorter than others.

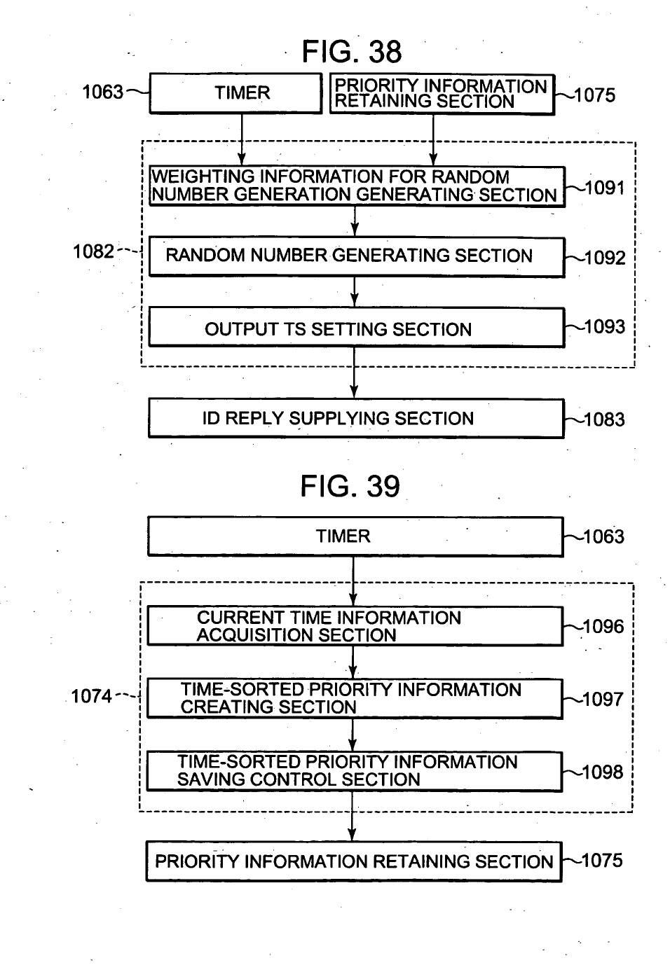

FIG. 38 is a block diagram indicating a detailed configuration example of the output TS control section 1082 in FIG. 36.

In FIG. 38, the output TS control section 1082 includes a weighting information for random number generation generating section 1091, a random number generating section 1092, and an output TS setting section 1093.

Based on the time information supplied by the timer 1063 and the time-sorted priority information 1075A supplied by the priority information retaining section 1075, the weighting information for random number generation generating section 1091 identifies the priority at the current time, and generates weighting information for random number generation (information that weights the probability with which each value is generated as the random number) based on that priority. Using the weighting information for random number generation that is generated by the weighting information for random number generation generating section 1091, the random number generating section 1092 generates a random number in accordance with that weighting. The output TS setting section 1093 assigns an ID output process to the time slot that corresponds to the random value that is generated by the random number generating section 1092. When the ID output process is assigned to that time slot, the output TS setting section 1093 supplies that setting to the ID reply supplying section 1083.

FIG. 39 is a block diagram indicating a detailed configuration example of the studying section 1074 in FIG. 36.

In FIG. 39, the studying section 1074 includes a current time information acquisition section 1096, a time-sorted priority information creating section 1097, and a time-sorted priority information saving control section 1098.

The current time information acquisition section 1096 acquires current time information from the timer 1063, and supplies it to the time-sorted priority information creating section 1097. Based on the current time information supplied from the current time information acquisition section 1096, the time-sorted priority information creating section 1097 learns the time period corresponding to the current time, sets, based on a processing result (success or failure) of the application processing response section 1073, the priority of ID outputting for that time period, and creates the time-sorted priority information 1075A. Once the time-sorted priority information 1075A is created, the time-sorted priority information creating section 1097 supplies it to the time-sorted priority information saving control section 1098. The time-sorted priority information saving control section 1098 supplies to the priority information retaining section 1075 the time-sorted priority information 1075A that is supplied and has it retained.

It is noted that the UD 1003 and the UD 1004 have configurations similar to that of the UD 1002 and perform similar processes. In other words, the configuration of the UD 1002 shown in FIGS. 36 through 39 as well as the descriptions given with reference to those drawings are applicable to both the UD 1003 and the UD 1004. Therefore, descriptions of the UD 1003 and the UD 1004 will be omitted.

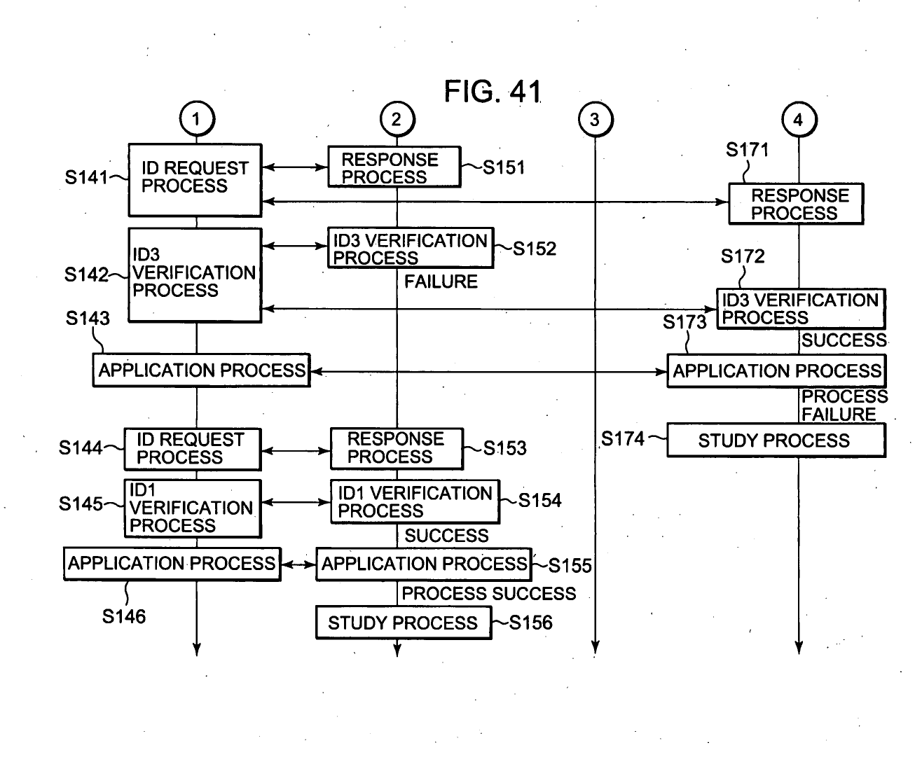

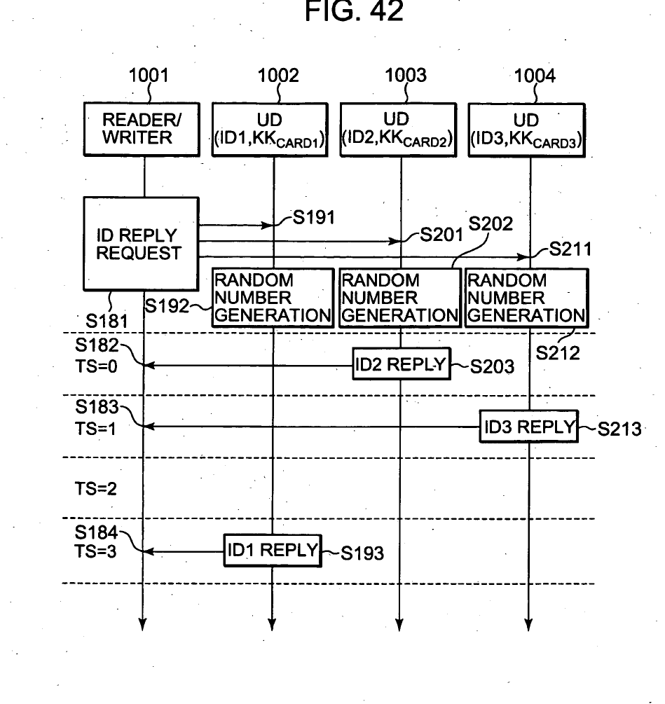

Next, the flow of processing up to the point where service is provided by the reader/writer 1001 to the user that owns the UDs 1002 through 1004 will be described with reference to the timing charts in FIG. 40 and FIG. 41.

First, in step S101 in FIG. 40, the reader/writer 1001 begins an ID request process, and UDs 1002 through 1004 perform a response process with respect to that ID request process in steps S111, S121, and S131, respectively. Details of the response process will be described later with reference to FIG. 42. It is assumed that through this process the reader/writer 1001 acquires ID2 of the UD 1003 first.

Having acquired the ID2, the reader/writer 1001 then performs, in step S102, an ID2 verification process for identifying the UD that corresponds to the ID2. As a process that corresponds to the ID2 verification process by the reader/writer 1001, the UDs 1002 through 1004 perform, in steps S112, S122, S132, respectively, an ID2 verification process. The UD 1002 and the UD 1004, which do not correspond to the ID2, fail in verifying the ID2, and only the UD 1003 succeeds.

Therefore, in step S103, the reader/writer 1001 executes an application process with respect to this UD 1003 (ID2). The UD 1003 also performs an application process in step S123 in correspondence with the process by the reader/writer 1001, however, since the UD 1003 does not support the service provided by the reader/writer 1001, this application process (step S123) fails. In step S124, the UD 1003 performs a study process, studies the fact that it failed in the application process during this time period (that it does not support the service provided during this time period), creates the time-sorted priority information 1075A and saves it.

Since the application process failed, the reader/writer 1001 moves the process along to step S141 in FIG. 41, and performs an ID request process similar to step S101. The UD 1002 and the UD 1004 perform, in step S151 and step S171, respectively, a response process corresponding to this ID request process. It is noted that the UD 1003, because it failed in the application process, is so configured to, for example, ignore requests from the reader/writer 1001 for a predetermined length of time so that it would not respond to this ID request process. Based on this configuration, the UD 1003 does not respond to the ID request process of step S141.

As a specific example, it is first assumed that an arrangement is made where basically all UDs, with some exceptions, react (reply with an ID) to an ID reply request command (ID request process), and only the UDs that have not succeeded in verifying respond to commands subsequent to the ID reply request command. And here, as an exception, UDs whose application process is terminated (successfully or in failure) will stop reacting to the ID reply request, and will stop reacting to all subsequent commands. In this case, UDs that have become non-reactive to the ID reply request will, after a predetermined time or by a predetermined method, reset this configuration after, for example, detecting the fact that it has exited the accessible range of the reader/writer, and its configuration is changed so that it is now able to react to the ID reply request once again.

The process above is merely an example, and the process that addresses the ID reply request may be performed using some other processing method. Through such a process, it is assumed that the reader/writer 1001 acquires ID3 of the UD 1004 first.

Having acquired the ID3, the reader/writer 1001 then again performs, in step S142, an ID3 verification process for identifying the UD that corresponds to the ID3. As a process that corresponds to the ID3 verification process by the reader/writer 1001, the UD 1002 and the UD 1004 perform, in steps S152 and S172, respectively, an ID3 verification process. The UD 1002, which does not correspond to the ID3, fails in verifying the ID3, and only the UD 1004 succeeds.

Therefore, in step S143, the reader/writer 1001 executes the application process with respect to this UD 1004 (ID3). The UD 1004 also performs an application process in step S173 in correspondence with the process by the reader/writer 1001, however, since the UD 1004 does not support the service provided by the reader/writer 1001, this application process (step S173) fails. In step S174, the UD 1004 performs a study process, studies the fact that it failed in the application process during this time period (that it does not support the service provided during this time period), creates the time-sorted priority information 1075A and saves it.

Since the application process failed, the reader/writer 1001 moves the process along to step S144, and performs an ID request process similar to step S101. The UD 1002 performs, in step S153, a response process corresponding to this ID request process. It is noted that the UD 1004, because it failed in the application process, is so configured to, for example, ignore requests from the reader/writer 1001 for a predetermined length of time so that it would not respond to this ID request process. Therefore, based on this configuration, the UD 1004, as with the UD 1003, does not respond to the ID request process of step S144. Through this process, the reader/writer 1002 acquires ID1 of the UD 1002.

Having acquired the ID1, the reader/writer 1001 then again performs, in step S145, an ID1 verification process for identifying the UD that corresponds to the ID1. As a process that corresponds to the ID1 verification process by the reader/writer 1001, the UD 1002 performs, in step S154, an ID1 verification process. The UD 1002, which does correspond to the ID1, succeeds in this verification process.

Therefore, in step S146, the reader/writer 1001 executes the application process with respect to this UD 1002 (ID1). The UD 1002 also performs an application process in step S155 in correspondence with the process by the reader/writer 1001. Since the UD 1002 does support the service provided by the reader/writer 1001, this application process (step S1-55) succeeds. In step S156, the UD 1002 performs a study process, studies the fact that it succeeded in the application process during this time period (that it does support the service provided during this time period), creates the time-sorted priority information 1075A and saves it.

The devices in FIG. 34 (the reader/writer 1001 and the UDs 1002 through 1004) perform the communications process above in relation to the provision of service. By processing in this manner, for example, each UD is able to (to some extent) have some control over the issue of which ID should be given priority in being acquired by the reader/writer 1001 (which ID should be acquired first by the reader/writer 1001) in the ID request process by the reader/writer 1001 in step S101 in FIG. 40, step S141 in FIG. 41 or step S144 in FIG. 41. In other words, each UD is able to have the ID of the UD that is likely to succeed in the application process be acquired with priority by the reader/writer 1001.

Next, with reference to the timing chart in FIG. 42, the ID request process by the reader/writer 1001, and the response process corresponding thereto by the UDs 1002 through 1004 will be described in detail.

Once the reader/writer 1001 performs, in step S181, an ID reply request process and requests IDs from UDs 1002 through 1004, the UDs 1002 through 1004 acquire that request in steps S191, S201 and S211, respectively.

Once the ID reply request is acquired, the UDs 1002 through 1004 generate a random number in steps S192, S202 and S212, respectively, and perform, in steps S193, S203 and S213, an ID1 reply process, an ID2 reply process and an ID3 reply process, respectively, in accordance with that random number value. For example, in the case shown in FIG. 42, of the four time slots (TS=0 through 3), the UD 1003 performs the ID2 reply process in step S203 in the first time slot (TS=0) and transmits the ID2 to the reader/writer 1001. The UD 1004 performs the ID3 reply process in step S213 in the second time slot (TS=1) and transmits the ID3 to the reader/writer 1001. Then, the UD 1002 performs the ID1 reply process in step S193 in the last time slot (TS=3) and transmits the ID1 to the reader/writer 1001.

In other words, in the case shown in FIG. 42, the ID2 is given priority in being acquired by the reader/writer 1001.

It is noted that in the example shown in FIG. 42, for purposes of convenience, a case where, though unlikely under normal circumstances, no signal collision takes place for the ID replies by the UDs (the time slots in which ID replies were performed are mutually different) is described; If two or more ID replies were made in one time slot, an accurate ID will not be received since the reader/writer 1001 will receive those ID replies in a state of interference (signal collision of the ID replies will take place). In other words, since the IDs of the UDs are mutually different, bits of different values will interfere and mix, and the reader/writer 1001 will be unable to identify whether it received a “0” or a “1,” thereby rendering the received ID unidentifiable.

For example, if an ID whose value is “00000000” and an ID whose value is “FFFFFFFF” are transmitted in the same time slot, the reader/writer 1001 will judge that is has received an ID whose value is “AAAAAAAA” and perform verification by generating a key based on that value, but since the ID is wrong, the key is also wrong, and a verification error will occur. Thus, if a signal collision takes place for the ID replies, the reader/writer 1001 is unable to receive the ID properly, thereby possibly causing a verification error. It is noted that although in the description above the reader/writer 1001 misjudges the value of the received ID as “AAAAAAAA,” this value is merely an example, and the reader/writer 1001 may misjudge it as being, for example, “55555555,” all zero, all F, or some other value. Should the value the reader/writer 1001 misjudges happen to coincide with the accurate value of the ID by accident, a verification error will not occur, and the reader/writer 1001 is able to perform subsequent processes normally.

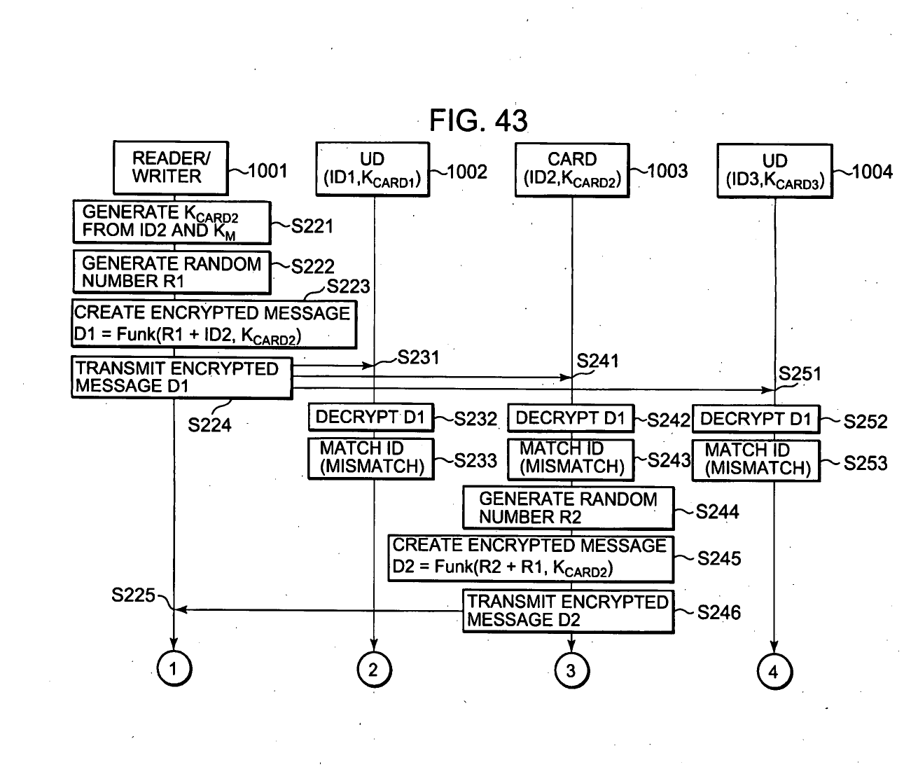

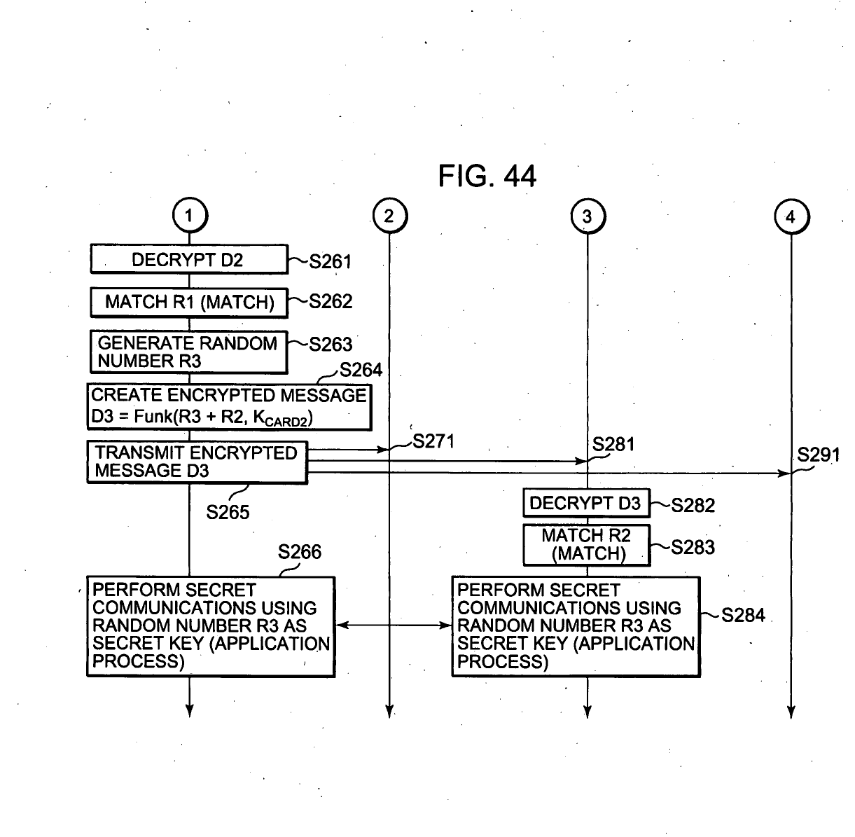

Next, details of the ID verification process by the reader/writer 1001 and the UDs 1002 through 1004 will be described with reference to the timing charts in FIG. 43 and FIG. 44. It is noted that the example shown in FIG. 43 and FIG. 44 is an example of the verification process for the ID2 corresponding to steps S102, S112, S122 and S132 in FIG. 40. The verification processes for the other IDs are similar.

However, in the description below, it is assumed that all reader/writers (including the reader/writer 1001) supporting this communications system 1000 have a secret key (master key) Kₘ that is a shared encryption key, and that the UDs 1002 through 1004 have mutually different secret keys K_{Card1}, K_{Card2} and K_{Card3}, respectively. The secret key K_{Card1} is obtained by encrypting the ID1 using the secret key Kₘ through a predetermined method (for example, DES (Data Encryption Standard) and the like). Similarly, the secret key K_{Card2} is obtained by encrypting the ID2 using the secret key Kₘ, and the secret key K_{Card3} is obtained by encrypting the ID3 using the secret key Kₘ.

As the ID2 verification process begins, the reader/writer 1001 first generates, in step S221, the K_{Card2} using the acquired ID2 and the secret key Kₘ it already has. In step S222, the reader/writer 1001 generates a random number R1 of a predetermined bit count.

Next, in step S223, the reader/writer 1001 creates an encrypted message D1 (D1=Funk(R1+ID2, K_{Card2})). Funk(R1+ID2, K_{Card2}) is information in which a random number R1 is encrypted with the secret key K_{Card2} to obtain R1′, the exclusive OR of R1′ and ID2 is encrypted with the secret key K_{Card2} to obtain ID2′, and ID2′ and R1′ are concatenated (for example, it is information in which R1′ is taken to be the upper bit and ID2′ the lower bit). In step S224, the reader/writer 1001 transmits the generated encrypted message D1 to the UDs 1002 through 1004. The UDs 1002 through 1004 receive the encrypted message D1 in steps S231, S241 and S251, respectively.

When the encrypted message D1 is acquired, the UDs 1002 through 1004 decrypt, in steps S232, S242 and S252, respectively, the encrypted message D1 using their respective secret keys K_{Card1}, K_{Card2} and K_{Card3}. Then, with respect to this decryption process, the UDs 1002 through 1004 perform, in steps S233, S243 and S253, respectively, an ID matching process of matching the obtained ID (the ID2 supplied by the reader/writer 1001) and against their own IDs.

In the example in FIG. 43, since the reader/writer 1001 transmits the ID2 as the encrypted message D1 using the secret key K_{Card2} of the UD 1003, the only UD for which the obtained ID and its own ID will match is the UD 1003. When the IDs do match, the UD 1003 moves the process along to step S244, generates a random number R2 of a predetermined bit count, and in step S245, creates an encrypted message D2 (D2=Funk(R2+R1, K_{Card2})) using that random number R2, and transmits that encrypted message D2 to the reader/writer 1001 in step S246.

In step S225, the reader/writer 1001 acquires that encrypted message D2.

When the encrypted message D2 is acquired, the reader/writer 1001 decrypts the encrypted message D2 using the secret key K_{Card2} in step S261 in FIG. 44, and matches it against the acquired random number R1. As in the example in FIG. 44, if the acquired random number R1 matches the random number R1 that is generated in step S222 in FIG. 43, the reader/writer 1001 generates, in step S263 in FIG. 44, a random number R3 of a predetermined bit count, creates an encrypted message D3 (D3=Funk(R3+R2, K_{Card2})) using that random number R3 in step S264, and transmits that encrypted message D3 to the UDs 1002 through 1004 in step S265.

The UDs 1002 through 1004 acquire that encrypted message D3 in steps S271, S281 and S291, respectively.

When the encrypted message D3 is acquired, the reader/writer 1003 decrypts the encrypted message D3 using the secret key K_{Card2} in step S282. It is noted that since the IDs do not match for the UDs 1002 and 1004 in steps S233 and S253 in FIG. 43, the UDs 1002 and 1004 stop their ID verification processes, and perform no further processing. Therefore, the UDs 1002 and 1004, despite acquiring the encrypted message D3, do not perform a decryption process therefor.

In step S283, the UD 1003 performs a matching process for the random number R2 (R2 matching) that is acquired through the decryption process in step S282. If it is judged that the random number R2 acquired through the decryption process matches with the random number R2 that is generated in step S244 in FIG. 43, the UD 1003 performs, in step S284, secret communications with the random number R3 as the secret key, and performs the application process. In correspondence with this process, the reader/writer 1001 performs, in step S266, secret communications with the random number R3 as the secret key, and performs the application process.

The ID verification process is performed in the manner described above.

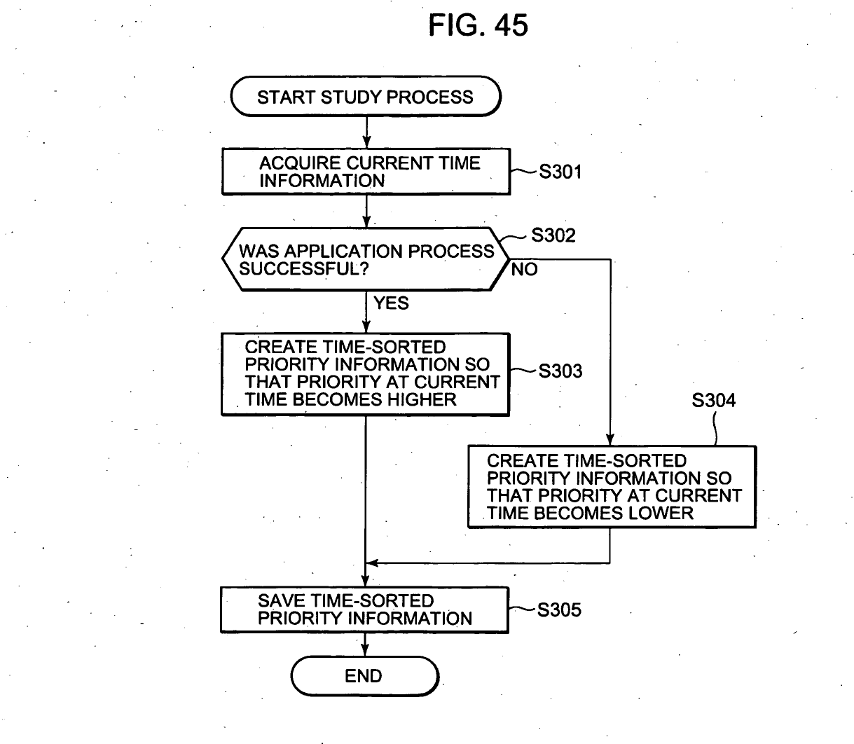

Next, an example of a study process, executed by the studying section 1074 of the UD 1002, for the result of the application process of the application processing response section 1073 will be described with reference to the flow chart in FIG. 45.

When the study process is started, the current time information acquisition section 1096 of the studying section 1074 acquires current time information in step S301 and supplies it to the time-sorted priority information creating section 1097. In step S302, the time-sorted priority information creating section 1097 determines whether or not the application process by the application processing response section 1073 was successful or not. If it is judged that the application process was successful, the time-sorted priority information creating section 1097 moves the process along to step S303, creates the time-sorted priority information 1075A in such a manner that the priority at the current time becomes higher, supplies it to the time-sorted priority information saving control section 1098 and moves the process along to step S305.

In addition, in step S302, if it is judged that the application process by the application processing response section 1073 was unsuccessful, the time-sorted priority information creating section 1097 moves the process along to step S304, creates the time-sorted priority information 1075A in such a manner that the priority at the current time becomes lower, supplies it to the time-sorted priority information saving control section 1098 and moves the process along to step S305.

In step S305, the time-sorted priority information saving control section 1098 supplies that time-sorted priority information 1075A to the priority information retaining section 1075, has it saved, and terminates the study process.

Thus, since the time-sorted priority information 1075A is created by studying the application process results for each time period, the ID request response section 1071 is able to perform the response process for ID requests using that time-sorted priority information 1075A, thereby making it possible to suppress the number of application process failures.

An example of the ID request response process executed by the ID request response section 1071 will be described with reference to the flow chart in FIG. 46.

When the ID request response process is started, the ID request acquisition section 1081 begins to accept ID requests in step S321, and judges whether or not an ID request is acquired in step S322. If it is judged that an ID request is acquired, the ID request acquisition section 1081 moves the process along to step S323. In step S323, the output TS control section 1082 executes an output TS control process. Details of the output TS control process will be described later. Once the output TS control process is terminated, the ID reply supplying section 1083 supplies an ID reply during a time slot that is set by the output TS control section 1082, and terminates the ID request response process.

In addition, in step S322, if it is judged that no ID request is acquired, the ID request acquisition section 1081 terminates the ID request response process.

Next, details of an example of the output TS control process executed in step S323 in FIG. 46 will be described with reference to the flow chart in FIG. 47.

In step S341 in FIG. 47, the weighting information for random number generation generating section 1091 generates weighting information for random number generation based on the time-sorted priority information 1075A acquired from the priority information retaining section 1075 and the current time acquired from the timer 1063, and supplies it to the random number generating section 1092. In step S342, the random number generating section 1092 generates a random number using that weighting information for random number generation and supplies it to the output TS setting section 1093. In step S343 and based on the generated random number value, the output TS setting section 1093 generates a time slot for outputting an ID reply, supplies it to the ID reply supplying section 1083, terminates the output TS control process, returns the process to step S323 in FIG. 46, and has the processes subsequent thereto executed.

Thus, since the UDs 1002 through 1004 (the communications system 1000) control the assignment of time slots for performing the ID supplying process based on the probability of success for the application process, it is possible to make communications processing more efficient and suppress a decrease in speed due to application process failures and the like.

It is noted that in the communications system 1000, for example, a unique ID may be assigned to each reader/writer 1001, and the reader/writer 1001 may transmit its own ID in requesting an ID from the UDs 1002 through 1004, thereby making it possible for the UDs 1002 through 1004 to decide whether or not to respond based on that ID.

However, in such a case, since there would be an enormous number of reader/writers 1001, there is a possibility that a shortage in IDs to be assigned to the reader/writers 1001 will occur if the bit count of the ID is small. In addition, if the bit count is increased to prevent an ID shortage, the load of communications processing may increase significantly.

As described above, by having the studying section 1074 generate the time-sorted priority information 1075A through the study process and having the output TS control section 1082 perform the assignment of ID replies using that time-sorted priority information 1075A, the UDs 1002 through 1004 (the communications system 1000) are able to make various processes more efficient without increasing the load of communications processing, and suppress a decrease in speed due to application process failures and the like.

It is noted that the priority described above does not have to be time period oriented, and instead may be sorted by the model of the reader/writer 1001.

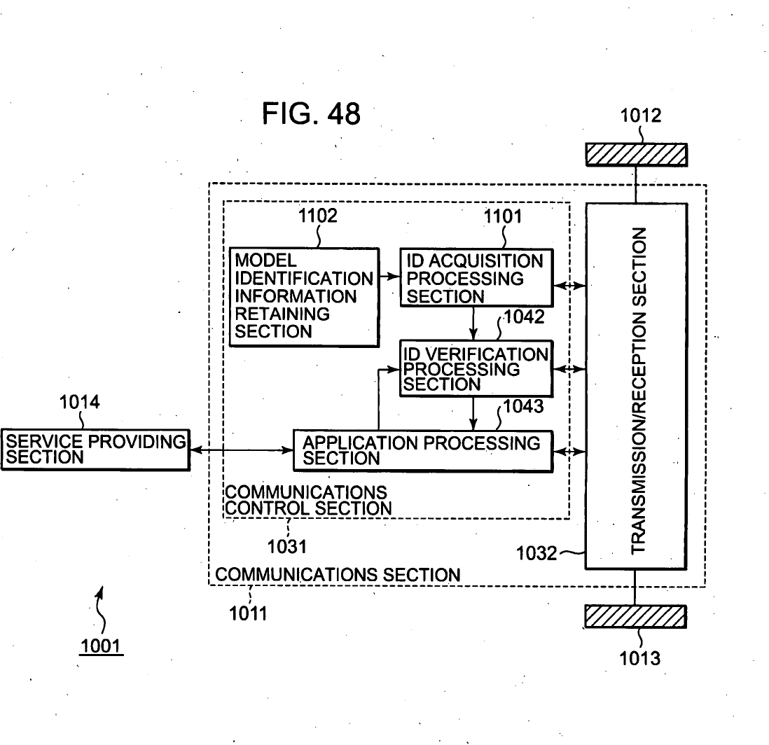

FIG. 48 is a block diagram indicating a configuration example of the reader/writer 1001 in such a case.

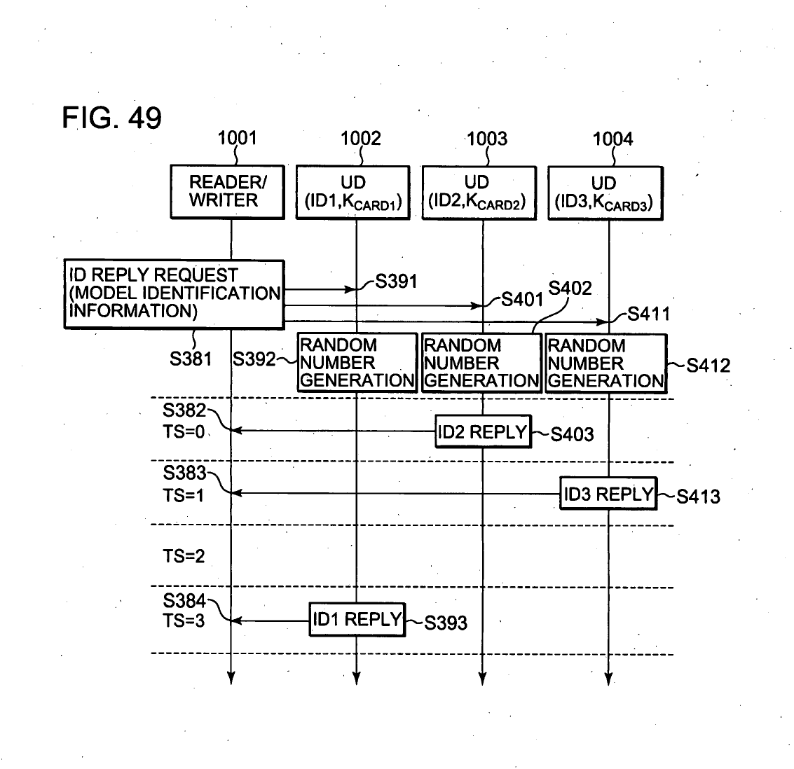

In FIG. 48, the communications control section 1031 of the reader/writer 1001 includes, instead of the ID acquisition processing section 1041 in FIG. 35, an ID acquisition processing section 1101 and a model identification information retaining section 1102. For example, in the ID request process by the reader/writer 1001, or in the response process with respect thereto by the UDs 1002 through 1004, both of which are indicated in the time chart in FIG. 49, the ID acquisition processing section 1101, as indicated in step S381, transmits, along with an ID request, model identification information that is supplied from the model identification information retaining section 1102 to the UDs 1002 through 1004.

The model identification information retaining section 1102, for example, retains in advance, for example, identification information of a predetermined bit count that indicates the model of the reader/writer 1001 and supplies it to the ID acquisition processing section 1101 based on a request. The model identification information may be, for example, information that indicates the kind of service the reader/writer 1001 provides, and is configured with a smaller bit count than the above-mentioned identification information unique to each reader/writer. Therefore, the load caused by the transmission of this model identification information is small, and does not significantly affect the communications processing time.

It is noted that although, as shown in the timing chart in FIG. 49, the UDs 1002 through 1004 acquire, in steps S391, S401 and S411, respectively, the model identification information along with the ID reply request, since that model identification information is not used in the ID request process or the response process therefor, other processes, such as random number generation, ID reply and so forth, may be executed in a manner similar to the timing chart in FIG. 42.

FIG. 50 is a block diagram indicating an internal configuration example of the UD 1002 in the case above.

As shown in FIG. 50, the communications control section 1061 of the UD 1002 includes a studying section 1111 and an output TS control section 1112.

In this case, the studying section 1111 of the UD 1002 (as well as the UD 1003 and the UD 1004) acquires the model identification information acquired by the ID request acquisition section 1081, generates model-sorted priority information 1075B, and has it retained by the priority information retaining section 1075.

The output TS control section 1112 acquires the model-sorted priority information 1075B retained by the priority information retaining section 1075, and based thereon, sets a time slot for performing an ID reply.

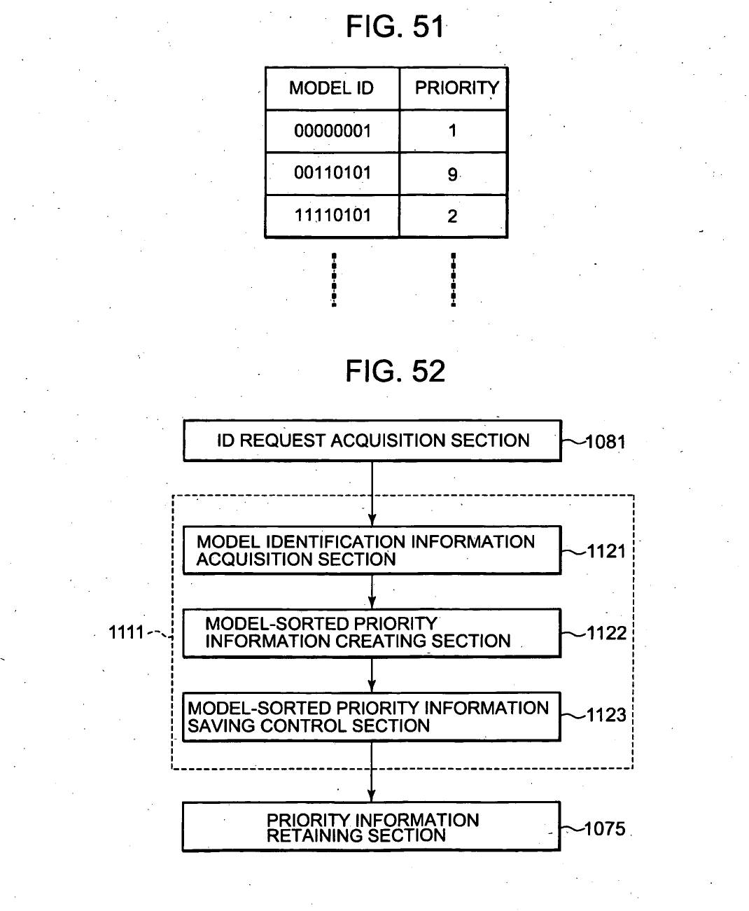

FIG. 51 is a diagram indicating a configuration example of this model-sorted priority information 1075B. As shown in FIG. 51, the model identification information (model ID) and priority are associated with each other.

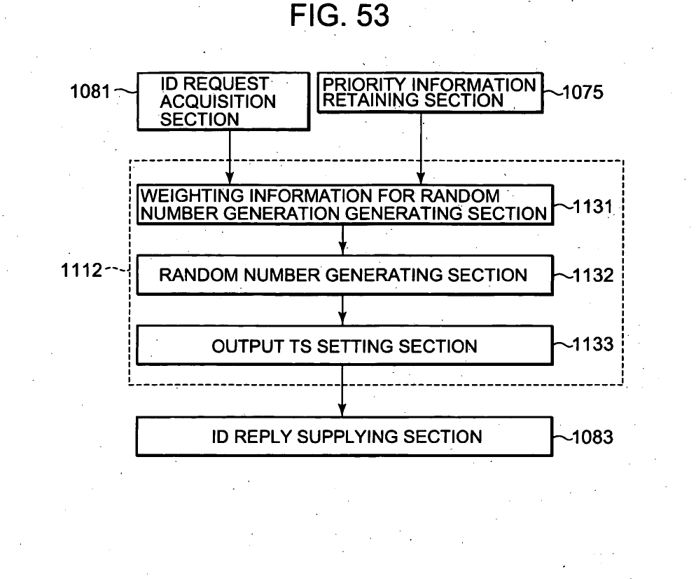

FIG. 52 is a block diagram indicating a detailed configuration example of the studying section 1111 in FIG. 50 in such a case.

In FIG. 52, the studying section 1111 includes a model identification information acquisition section 1121, a model-sorted priority information creating section 1122, and a model-sorted priority information saving control section 1123.

The model identification information acquisition section 1121 acquires the model identification information from the ID request acquisition section 1081 and supplies it to the model-sorted priority information creating section 1122. The model-sorted priority information creating section 1122 creates the model-sorted priority information 1075B based on the model identification information, and supplies it to the model-sorted priority information saving control section 1123. The model-sorted priority information saving control section 1123 supplies the supplied model-sorted priority information 1075B to the priority information retaining section 1075 and has it retained.

FIG. 53 is a block diagram indicating a detailed configuration example of the output TS control section 1112 in FIG. 50. In FIG. 53, the output TS control section 1112 includes a weighting information for random number generation generating section 1131, a random number generating section 1132 and an output TS setting section 1133. The weighting information for random number generation generating section 1131 generates weighting information for random number generation based on the model identification information acquired from the ID request acquisition section 1081 and the model-sorted priority information 1075B supplied by the priority information retaining section 1075, and supplies it to the random number generating section 1132. The random number generating section 1132 generates a random number, and supplies it to the output TS setting section 1133. The output TS setting section 1133 assigns an ID reply process to the time slot corresponding to the acquired random number, and supplies that information to the ID reply supplying section 1083.

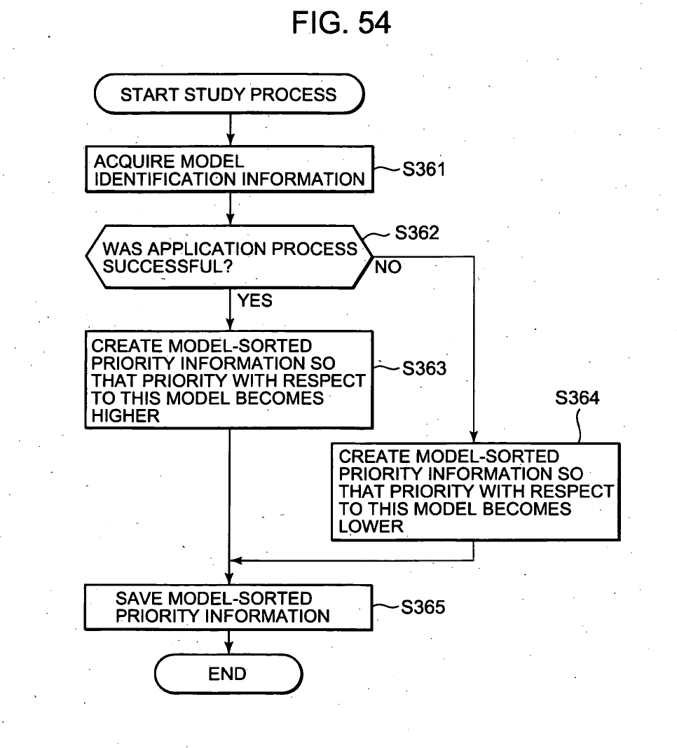

Next, an example of the study process for the case above will be described with reference to the flow chart in FIG. 54.

When the study process is started, the model identification information acquisition section 1121 of the studying section 1111 acquires the model identification information from the ID request acquisition section 1081 and supplies it to the model-sorted priority information creating section 1122 in step S361. In step S362, the model-sorted priority information creating section 1122 judges whether or not the application process by the application processing response section 1073 was successful or not. If it is judged that the application process was successful, the model-sorted priority information creating section 1122 moves the process along to step S363, creates the model-sorted priority information 1075B in such a manner that the priority of transmitting an ID to this model becomes higher, supplies it to the model-sorted priority information saving control section 1123 and moves the process along to step S365.

In addition, in step S362, if it is judged that the application process by the application processing response section 1073 was not successful, the model-sorted priority information creating section 1122 moves the process along to step S364, creates the model-sorted priority information 1075B in such a manner that the priority of transmitting an ID to this model becomes lower, supplies it to the model-sorted priority information saving control section 1123 and moves the process along to step S365.

In step S365, the model-sorted priority information saving control section 1123 supplies that model-sorted priority information 1075B to the priority information retaining section 1075, has it saved, and terminates the study process.

Thus, since the model-sorted priority information 1075B is created by studying the application process results for each model of the reader/writer 1001, the ID request response section 1071 is able to perform the response process for ID requests using that model-sorted priority information 1075B, thereby making it possible to suppress the number of application process failures.

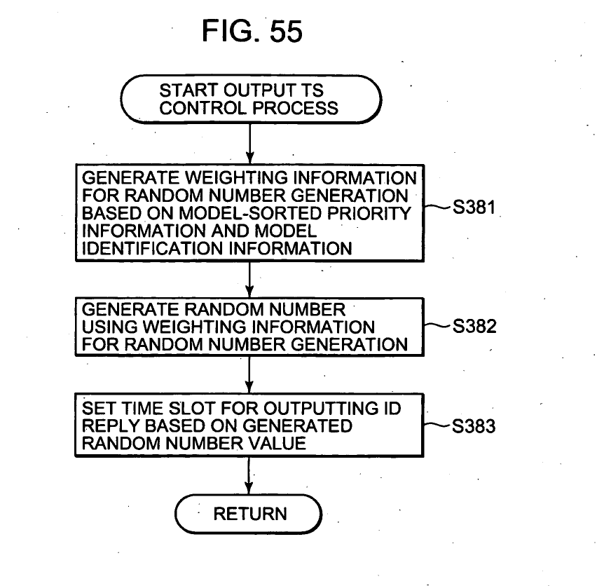

In this case, too, the ID request response process executed by the ID request response section 1071 is executed in a manner similar to the case described with reference to the flow chart in FIG. 46. Next, an example of the details of the output TS control process executed in step S323 in FIG. 46 in the case above will be described with reference to the flow chart in FIG. 55.

In step S381 in FIG. 55, the weighting information for random number generation generating section 1131 creates weighting information for random number generation based on the model-sorted priority information 1075B acquired from the priority information retaining section 1075 and the model identification information acquired from the ID request acquisition section 1081, and supplies it to the random number generating section 1132. In step S382, the random number generating section 1132 generates a random number using that weighting information for random number generation, and supplies it to the output TS setting section 1133. In step S383, the output TS setting section 1133 generates a time slot for outputting an ID reply based on the generated random number value, supplies it to the ID reply supplying section 1083, terminates the output TS control process, returns the process to step S323 in FIG. 46, and has the processes subsequent thereto executed.

Thus, since the UDs 1002 through 1004 (the communications system 1000) control the assignment of time slots for performing the ID supplying process based on the probability of success for the application process, it is possible to make communications processing more efficient and suppress a decrease in speed due to application process failures and the like.

Thus, the reader/writer 1001 is made to retain the model identification information of a volume that is just enough for identifying the reader/writer by its model, and is made to supply that model identification information to the UD when requesting an ID. Then, through the study process by the studying section 1111 of the UD, each success/failure of the application process is studied for each model identification information, and the model-sorted priority information 1075B is generated as a study result thereof. Then, the output TS control section 1112 of the UD controls which time slots ID replies are to be assigned to using that model-sorted priority information 1075B. Through such an arrangement, the reader/writer 1001 and the UDs 1002 through 1004 (the communications system 1000) are able to make each process more efficient without increasing the load of communications processing, and suppress a decrease in speed due to application failures and the like.

It is noted that the classification of the reader/writer 1001 does not have to be by model as described above, and may instead be by function, service provided, year of manufacture, manufacturer, service provider, plant of manufacture; installed locale, place of installation, and the like, or by any other method. Further, a plurality of classifications may be combined.

In addition, the UD may, for example, reference both the time-sorted priority information 1075A and the model-sorted priority information 1075B described above, and determine the time slot to which the ID reply should be assigned. In other words, the UD may determine the time slot to which the ID reply is to be assigned using priority information that is based on a plurality of kinds of conditions.

It is noted that the application of the present invention described above with reference to FIGS. 34 through 55 is by no means limited to the communications system 1000 in FIG. 34.

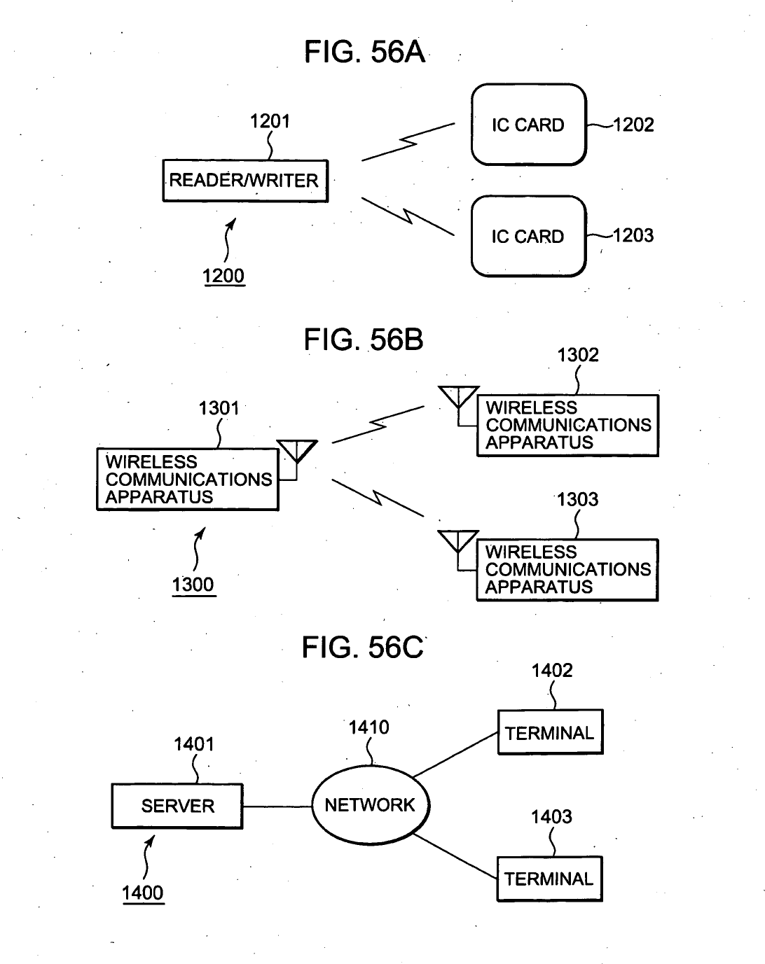

For example, as shown in FIG. 56A, the present invention may be applied to a contactless IC card system including a reader/writer and an IC card. In the case shown in FIG. 56A, a contactless IC card system 1200 includes a reader/writer 1201 that writes and reads information to and from a contactless IC card, and contactless IC cards 1202 and 1203. By applying the present invention, the contactless IC card system 1200 (each device) is controlled so that of the IC cards 1202 and 1203 that are brought closer to the reader/writer 1201 at the same time, the ID of the IC card that is more likely to support the service provided by the reader/writer 1201 is notified to the reader/writer 1201 with priority over the other. Thus, the contactless IC card system 1200 (the reader/writer 1201, and the IC cards 1202 and 1203) is able to suppress a decrease in the speed of communications processing.

In addition, as shown in FIG. 56B, for example, the present invention may be applied to a wireless communications system for wireless communications apparatuses. In the case shown in FIG. 56B, a wireless communications system 1300 includes three wireless communications apparatuses (wireless communications apparatuses 1301 through 1303). By applying the present invention, if, for example, the wireless communications apparatus 1301 provides a service to another wireless communications apparatus, the wireless communications system 1300 (each device) may exercise control in such a manner that of the communicable wireless communications apparatuses 1302 and 1303, the ID of the wireless communications apparatus that is more likely to support the service provided by the wireless communications apparatus 1301 is notified to the wireless communications apparatus 1301 with priority over the other in response to a search process by the wireless communications apparatus 1301 for other wireless communications apparatuses. Thus, the wireless communications system 1300 (the wireless communications apparatuses 1301 through 1303) is able to suppress a decrease in the speed of communications processing.

Further, as shown in FIG. 56C, for example, the present invention may be applied to a network system that is connected by wire. In the case shown in FIG. 56C, a network system 1400 includes a server 1401, a terminal 1402 and a terminal 1403, all of which may be personal computers, as well as a network 1410, such as the Internet. The terminals 1402 and 1403 are connected to the server 1401 via the network 1410. By applying the present invention, the network system 1400 (each device) may exercise control in such a manner that of the communicable terminals 1402 and 1403, the ID of the terminal that is more likely to support the service provided by the server 1401 is notified to the server 1401 with priority over the other in response to a search process by the server 1401 for terminals. Thus, the network system 1400 (the server 1401 and the terminals 1402 and 1403) is able to suppress a decrease in the speed of communications processing.

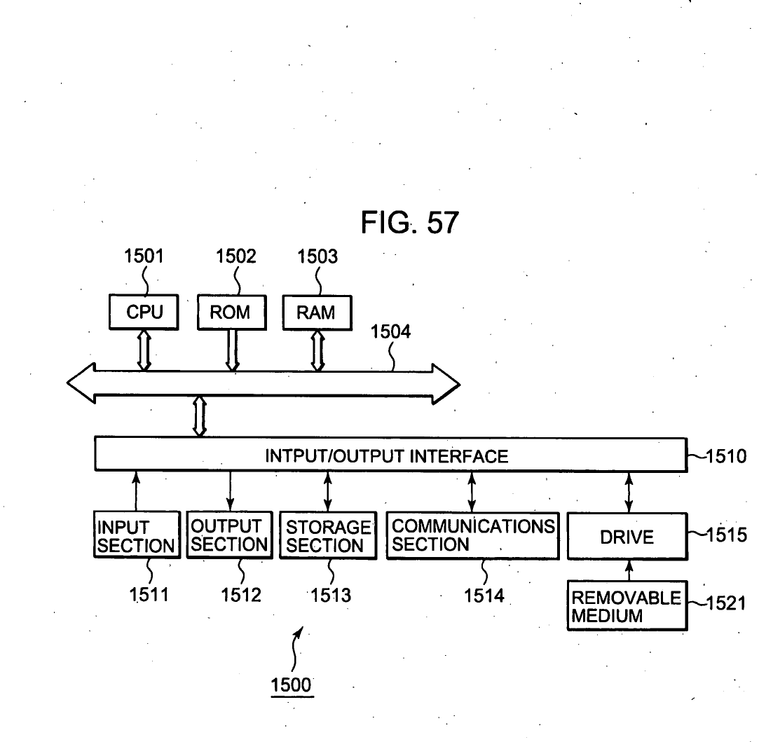

The series of processes described above may be executed through hardware, but they may also be executed through software. In such cases, for example, the apparatuses described above may each be configured as personal computers like the one shown in FIG. 57.

In FIG. 57, a CPU (Central Processing Unit) 1501 of a personal computer 1500 executes various processes in accordance with programs stored in a ROM (Read Only-Memory) 1502 or with programs loaded to a RAM (Random Access Memory) 1503. In addition, data needed by the CPU 1501 in the execution of the various processes are stored in the RAM 1503 as required.

The CPU 1501, the ROM 1502 and the RAM 1503 are interconnected through a bus 1504. An input/output interface 1510 is also connected to this bus 1504.

An input section 1511 including a keyboard, a mouse and the like, an output section 1512 including a display, such as a CRT (Cathode Ray Tube), an LCD (Liquid Crystal Display) and the like, and a speaker and the like, a storage section 1513 including a hard disk and the like, and a communications section 1514 including a modem and the like are also connected to the input/output interface 1510. The communications section 1514 performs communications processing via a network including the Internet.

As required, a drive 1515 is also connected to the input/output interface 1510, and a removable medium 1521, such as a magnetic disk, an optical disk, a magneto-optical disk, a semiconductor memory or the like, is loaded into the drive 1515 when appropriate, and computer programs read therefrom are installed in the storage section 1513 as required.

If the series of processes described above are to be executed through software, programs constituting that software are installed via a network or a recording medium.

This recording medium may include, as shown in FIG. 57, not only the removable medium 1521, which is distributed to users separately from the apparatus itself in order to distribute programs and which includes a magnetic disk (including a flexible disk), an optical disk (including a CD-ROM (Compact Disk-Read Only Memory), a DVD (Digital Versatile Disk)), a magneto-optical disk (including an MD (Mini-Disk (registered trademark)), a semiconductor memory or the like on which programs are recorded, but also the ROM 1502, a hard disk that is included in the storage section 1513 and the like which are distributed to users in a state where they are already incorporated into the apparatus itself.

It is noted that in the present specification, the steps that describe the program recorded on a recording medium include not only processes that are performed chronologically in the order in which they are mentioned, but also processes that are executed in parallel or individually and not necessarily in a chronological fashion.

In addition, in the present specification, a system refers to an apparatus as a whole that includes a plurality of devices (apparatuses). It is noted that elements that are described as single apparatuses in the description above may be divided and be included as a plurality of apparatuses. On the other hand, elements that are described as a plurality of apparatuses in the description above may be integrated into a single apparatus. In addition, elements other than the ones described above may be added to the configuration of each apparatus. Further, so long as the configuration and operation are essentially the same for the system as a whole, a part of the configuration of a given apparatus may be included in the configuration of another apparatus.

The present invention contains subject mater related to Japanese Patent Application No. JP2005-178426 filed in the Japanese Patent Office on Jun. 17, 2005, the entire contents of which being incorporated herein by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A communications system having a communications apparatus that performs communications with another communications apparatus via a communications medium; said communications apparatus comprising:
identification information request response means that performs a response process of transmitting identification information of said communications apparatus to said other communications apparatus in response to a request, which is transmitted from said other communications apparatus, for said identification information;
application processing means that performs communications with said other communications apparatus to which said identification information is transmitted through said identification information request response means, and that performs a process related to a predetermined application; and
studying means that studies, with respect to a predetermined condition, success/failure tendencies of said process related to said application performed by said application processing means;
wherein said identification information request response means controls, based on a study result by said studying means, output of said identification information in response to said request.

2. A communications apparatus that performs communications with another communications apparatus via a communications medium, said apparatus comprising:
identification information request response means that performs a response process of transmitting identification information of said communications apparatus to said other communications apparatus in response to a request, which is transmitted from said other communications apparatus, for said identification information;
application processing means that performs communications with said other communications apparatus to which said identification information is transmitted through said identification information request response means, and that performs a process related to a predetermined application; and
studying means that studies, with respect to a predetermined condition, success/failure tendencies of said process related to said application performed by said application processing means;
wherein said identification information request response means controls, based on a study result by said studying means, output of said identification information in response to said request.

3. The communications apparatus according to claim 2, wherein said identification information request response means comprises:
request acquisition means that acquires said request that is transmitted from said other communications apparatus;
identification information supplying means that supplies said identification information to said other communications apparatus as a response to said request acquired by said request acquisition means;
output control means that controls, based on said study result, the timing in which said identification information is supplied by said identification information supplying means.

4. The communications apparatus according to claim 3;
wherein said studying means studies success/failure tendencies of said process related to said application during predetermined time periods, and creates, as said study result, time-sorted priority information that indicates the priority, which addresses said tendencies, of said identification information for said other communications apparatus for each of said time periods, and
wherein said output control means controls the timing in which said identification information is supplied based on said time-sorted priority information that is created as said study result by said studying means.

5. The communications apparatus according to claim 4, wherein said output control means exercises control in such a manner that during a time period in which said priority is high, the timing in which said identification information is supplied is made earlier, and during a time period in which said priority is low, the timing in which said identification information is supplied is made later.

6. The communications apparatus according to claim 3;
wherein said studying means studies success/failure tendencies of said process related to said application for each model of said other communications apparatus, and creates, as said study result, model-sorted priority information that indicates the priority, which addresses said tendencies, of said identification information for said other communications apparatus for each model of said other communications apparatus, and
wherein said output control means controls the timing in which said identification information is supplied based on said model-sorted priority information that is created as said study result by said studying means.

7. The communications apparatus according to claim 6, wherein said output control means exercises control in such a manner that if said other communications apparatus is a model for which said priority is high, the timing in which said identification information is supplied is made earlier, and if said other communications apparatus is a model for which said priority is low, the timing in which said identification information is supplied is made later.

8. The communications apparatus according to claim 3, further comprising retaining means that temporarily retains said study result of said studying means;
wherein said output control means controls the timing in which said identification information is supplied based on said study result retained by said retaining means.

9. A communications method of a communications apparatus that performs communications with another communications apparatus via a communications medium, said method comprising:
an application processing step of performing communications with said other communications apparatus, and of performing a process related to a predetermined application;
a studying step of studying, with respect to a predetermined condition, success/failure tendencies of said process related to said application performed in said application processing step; and
an identification information request response step of performing, based on a study result obtained in said studying step, a response process of transmitting identification information of said communications apparatus to said other communications apparatus in response to a request, which is transmitted from said other communications apparatus, for said identification information.

10. A program for making a computer perform a process of performing communications with another communications apparatus via a communications medium, said program comprising:
an application processing step of performing communications with said other communications apparatus, and of performing a process related to a predetermined application;
a studying step of studying, with respect to a predetermined condition, success/failure tendencies of said process related to said application performed in said application processing step; and
an identification information request response step of performing, based on a study result obtained in said studying step, a response process of transmitting identification information of said communications apparatus to said other communications apparatus in response to a request, which is transmitted from said other communications apparatus, for said identification information.
